(19) United States
(12) Patent Application Publication
(10) Pub. No.: US 2013/0062932 A1
(43) Pub. Date: Mar. 14, 2013

(54) BRAKE CONTROL APPARATUS

(71) Applicant: Hideaki YAGASHIRA, Sagamihara-shi (JP)

(72) Inventor: Hideaki YAGASHIRA, Sagamihara-shi (JP)

(73) Assignee: HITACHI AUTOMOTIVE SYSTEMS, LTD

(21) Appl. No.: 13/591,754

(22) Filed: Aug. 22, 2012

(30) Foreign Application Priority Data
Sep. 12, 2011 (JP) 2011-197854

(51) Int. Cl. B60T 13/58

(52) U.S. Cl. 303/3

(57) ABSTRACT

A brake control apparatus for a vehicle provided with a regenerative braking device, the brake control apparatus includes: a first brake circuit connecting a master cylinder configured to generate a brake hydraulic pressure by a brake operation of a driver, and a wheel cylinder to which the brake hydraulic pressure is applied; a booster configured to increase a pressure of a brake fluid within the master cylinder, and to transmit the pressurized brake fluid to the wheel cylinder through a second brake circuit connected with the first brake circuit; a third brake circuit bifurcated from the first brake circuit, and connected with the booster; a reservoir provided on the third brake circuit; and a recirculating device configured to recirculate the brake fluid stored in the reservoir, to the first brake circuit's side.

### BACKGROUND OF THE INVENTION

This invention relates to a brake control apparatus.

Japanese Patent Application Publication No. 2002-67907 discloses a conventional brake control apparatus for a vehicle provided with a regenerative braking device, which is configured to generate a frictional braking force so as to compensate for deficiency of a regenerative braking force with respect to a driver's requested (desired) braking force, that is, to perform a regenerative coordinated control. This brake control apparatus performs a hydraulic pressure control for generating the frictional braking force. This brake control apparatus includes a first brake circuit connecting a master cylinder and a wheel cylinder, a booster configured to increase the pressure of the brake fluid (hydraulic fluid) within the master cylinder, and to transmit the pressurized brake fluid to the wheel cylinder through a second brake circuit connected with the first brake circuit, a third brake circuit bifurcated from the first brake circuit, and connected with the booster, and a reservoir configured to store the brake fluid from the wheel cylinder. The brake control apparatus is configured to increase or decrease the wheel cylinder pressure.

### SUMMARY OF THE INVENTION

However, in the conventional brake control apparatus, it is, therefore, difficult to arbitrarily control the wheel cylinder pressure while providing an appropriate brake operation feeling with respect to the brake operation of the driver.

It is an object of the present invention to provide a brake control apparatus which is devised to solve the above-described problems, and to improve an operation feeling of the brake.

According to one aspect of the present invention, a brake control apparatus for a vehicle provided with a regenerative braking device, the brake control apparatus comprises: a first brake circuit connecting a master cylinder configured to generate a brake hydraulic pressure by a brake operation of a driver, and a wheel cylinder to which the brake hydraulic pressure is applied; a booster configured to increase a pressure of a brake fluid within the master cylinder, and to transmit the pressurized brake fluid to the wheel cylinder through a second brake circuit connected with the first brake circuit; a third brake circuit bifurcated from the first brake circuit, and connected with the booster; a reservoir provided on the third brake circuit; and a recirculating device configured to recirculate the brake fluid stored in the reservoir, to the first brake circuit's side.

According to another aspect of the invention, a brake control apparatus for a vehicle provided with a regenerative braking device, the brake control apparatus comprises: a first brake circuit connecting a master cylinder configured to generate a brake hydraulic pressure by a brake operation of a driver, and a wheel cylinder to which the brake hydraulic pressure is applied; a first pump configured to suck a brake fluid within the master cylinder, to discharge the sucked brake fluid through a second brake circuit connected with the first brake circuit to the first brake circuit, and thereby to increase the hydraulic pressure within the wheel cylinder; a third brake circuit bifurcated from the first brake circuit, and connected with a suction side of the first pump; a reservoir provided on the third brake circuit; a recirculating circuit bifurcated from a portion of the third brake circuit between a suction side of the first pump and the reservoir, and connected to a portion of the third brake circuit between the reservoir and a portion on a downstream side of the bifurcating point between the third brake circuit and the first brake circuit; and a second pump provided on the recirculating circuit, and configured to suck a brake fluid stored in the reservoir, and to recirculate the sucked brake fluid to the first brake circuit's side.

According to still another aspect of the invention, a brake control apparatus for a vehicle provided with a regenerative braking device, the brake control apparatus comprises: a brake operation state sensing section configured to sense a brake operation state of a driver; a first brake circuit connecting a master cylinder configured to generate a brake hydraulic pressure by a brake operation of a driver, and a wheel cylinder to which the brake hydraulic pressure is applied; a first pump configured to suck a brake fluid within the master cylinder, to discharge the sucked brake fluid through a second brake circuit connected with the first brake circuit to the first brake circuit, and thereby to increase the hydraulic pressure within the wheel cylinder; a third brake circuit bifurcated from the first brake circuit, and connected with a suction side of the first pump; a reservoir provided on the third brake circuit; a recirculating circuit bifurcated from a portion of the third brake circuit between a suction side of the first pump and the reservoir, and connected to a portion of the third brake circuit between the reservoir and a portion on a downstream side of the bifurcating point between the third brake circuit and the first brake circuit; and a second pump provided on the recirculating circuit, and configured to suck a brake fluid stored in the reservoir, and to recirculate the sucked brake fluid to the first brake circuit's side; a first motor arranged to drive the first pump; a second motor arranged to drive the second pump; a gate-out valve provided on the first brake circuit between the connection point between the first brake circuit and the second brake circuit, and the bifurcating point between the first brake circuit and the third brake circuit; an in valve provided on the first brake circuit between the wheel cylinder and the first pump; an out valve provided on a fourth brake circuit connecting the wheel cylinder and the reservoir; and a hydraulic pressure control section configured to control the pumps and the valves in accordance with the sensed brake operation state and the actuation state of the regenerative braking device, the pumps, the valves and the brake circuits being provided in a first system constituted by a first predetermined wheel set, and a second system constituted by a second predetermined wheel set, the first motor and the second motor being shared by the corresponding pumps provided in the first system and the second system.

### BRIEF DESCRIPTION OF THE DRAWINGS

FIG. 1 is a view showing a system configuration of a vehicle to which a brake control apparatus according to a first embodiment of the present invention is applied.

FIG. 2 is a view showing a circuit configuration of a hydraulic pressure control unit according to the first embodiment of the present invention.

FIG. 3 is time chart showing an example of operations of actuators for generation of a pedal depression force in the brake control apparatus according to the first embodiment.

FIG. 4 is a view showing a flow of a brake fluid at the depression of the pedal at a normal brake in the first embodiment.

FIG. 5 is a view showing actuation states of the actuators at the depression of the pedal at a normal brake in the first embodiment.

FIG. 6 is a view showing the flow of the brake fluid at the holding of the pedal stroke at the normal brake in the first embodiment.

FIG. 7 is a view showing actuation states of the actuators at the holding of the pedal stroke at the normal brake in the first embodiment.

FIG. 8 is a view showing the flow of the brake fluid at a pedal depression return at the normal brake in the first embodiment.

FIG. 9 is a view showing actuation states of the actuators at the pedal depression return at the normal brake in the first embodiment.

FIG. 10 is a view showing the flow of the brake fluid at a timing just before an end of the pedal depression return stroke at the normal brake in the first embodiment.

FIG. 11 is a view showing actuation states of the actuators at a timing just before the end of the pedal depression return stroke at the normal brake in the first embodiment.

FIG. 12 is a view showing a flow of the brake fluid at a wheel cylinder pressure increase at the depression of the pedal at a regenerative coordinated control in the first embodiment.

FIG. 13 is a view showing actuation states of the actuators at the wheel cylinder pressure increase at the depression of the pedal at the regenerative coordinated control in the first embodiment.

FIG. 14 is a view showing a flow of the brake fluid at a wheel cylinder pressure holding at the depression of the pedal at the regenerative coordinated control in the first embodiment.

FIG. 15 is a view showing actuation states of the actuators at the wheel cylinder pressure holding at the depression of the pedal at the regenerative coordinative control in the first embodiment.

FIG. 16 is a view showing a flow of the brake fluid at a wheel cylinder pressure decrease (when a pressure decrease gradient is small) at the depression of the pedal at the regenerative coordinated control in the first embodiment.

FIG. 17 is a view showing actuation states of the actuators at the wheel cylinder pressure decrease (when the pressure decrease gradient is small) at the depression of the pedal at the regenerative coordinated control in the first embodiment.

FIG. 18 is a view showing a flow of the brake fluid at the wheel cylinder pressure decrease (when the pressure decrease gradient is large) at the depression of the pedal at the regenerative coordinated control in the first embodiment.

FIG. 19 is a view showing actuation states of the actuators at the wheel cylinder pressure decrease (when the pressure decrease gradient is large) at the depression of the pedal at the regenerative coordinated control in the first embodiment.

FIG. 20 is a view showing a flow of the brake fluid at the wheel cylinder pressure increase at the holding of the pedal stroke at the regenerative coordinated control in the first embodiment.

FIG. 21 is a view showing actuation states of the actuators at the wheel cylinder pressure increase at the holding of the pedal stroke at the regenerative coordinated control in the first embodiment.

FIG. 22 is a view showing a flow of the brake fluid at the wheel cylinder pressure holding at the holding of the pedal stroke at the regenerative coordinated control in the first embodiment.

FIG. 23 is showing actuation states of the actuators at the wheel cylinder pressure holding at the holding of the pedal stroke at the regenerative coordinated control in the first embodiment.

FIG. 24 is a view showing a flow of the brake fluid at the wheel cylinder pressure decrease (when the pressure decrease gradient is small) at the holding of the pedal stroke at the regenerative coordinated control in the first embodiment.

FIG. 25 is a view showing actuation states of the actuators at the wheel cylinder pressure decrease (when the pressure decrease gradient is small) at the holding of the pedal stroke at the regenerative coordinated control in the first embodiment.

FIG. 26 is a view showing a flow of the brake fluid at the wheel cylinder pressure decrease (when the pressure decrease gradient is large) at the holding of the pedal stroke at the regenerative coordinated control in the first embodiment.

FIG. 27 is a view showing actuation states of the actuators at the wheel cylinder pressure decrease (when the pressure decrease gradient is large) at the holding of the pedal stroke at the regenerative coordinated control in the first embodiment.

FIG. 28 is a view showing a flow of the brake fluid at the wheel cylinder pressure increase at the pedal depression return at the regenerative coordinate control in the first embodiment.

FIG. 29 is a view showing actuation states of the actuators at the wheel cylinder pressure increase at the pedal depression return at the regenerative coordinate control in the first embodiment.

FIG. 30 is a view showing a flow of the brake fluid at the wheel cylinder pressure holding at the pedal depression return at the regenerative coordinate control in the first embodiment.

FIG. 31 is a view showing actuation states of the actuators at the wheel cylinder pressure holding at the pedal depression return at the regenerative coordinate control in the first embodiment.

FIG. 32 is a view showing a flow of the brake fluid at the wheel cylinder pressure decrease (when the pressure decrease gradient is small) at the pedal depression return at the regenerative coordinate control in the first embodiment.

FIG. 33 is a view showing actuation states of the actuators at the wheel cylinder pressure decrease (when the pressure decrease gradient is small) at the pedal depression return at the regenerative coordinate control in the first embodiment.

FIG. 34 is a view showing a flow of the brake fluid at the wheel cylinder pressure decrease (when the pressure decrease gradient is large) at the pedal depression return at the regenerative coordinate control in the first embodiment.

FIG. 35 is showing actuation states of the actuators at the wheel cylinder pressure decrease (when the pressure decrease gradient is large) at the pedal depression return stroke at the regenerative coordinate control in the first embodiment.

FIG. 36 is a time chart showing an example of actuations of the actuators at the normal brake in the first embodiment.

FIG. 37 is a time chart showing an example of actuations of the actuators in a case where a regenerative braking force is generated in an initial stage of the brake and a frictional braking force is not generated in the first embodiment.

FIG. 38 is a time chart showing an example of actuations of the actuators in a case where the frictional braking force is generated after the regenerative braking force is generated in the initial stage of the brake in the first embodiment.

FIG. 39 is a time chart showing an example of actuations of the actuators when the decrease gradient of the frictional braking force is large in a case where the frictional braking force is generated after the regenerative braking force is generated in the initial stage of the brake in the first embodiment.

FIG. 40 is a time chart showing an example of actuations of the actuators in a case where the frictional braking force is generated at a relatively early timing after the regenerative braking force is generated in the initial stage of the brake in the first embodiment.

FIG. 41 is a time chart showing an example of actuations of the actuators when the decrease gradient of the frictional braking force is large in a case where the frictional braking force is generated at a relatively early timing after the regenerative braking force is generated in the initial stage of the brake in the first embodiment.

FIG. 42 is a time chart showing an example of actuations of the actuators in a case where the regenerative braking force is generated after the frictional braking force is generated in the initial stage of the brake in the first embodiment.

FIG. 43 is a time chart showing an example of actuations of the actuators when the decrease gradient of the frictional braking force is large in a case where the regenerative braking force is generated at a relatively early timing after the frictional braking force is generated in the initial stage of the brake in the first embodiment.

FIG. 44 is a view showing a circuit configuration of a hydraulic pressure control unit according to a second embodiment of the present invention.

FIG. 45 is a view showing a circuit configuration of a hydraulic pressure control unit according to a third embodiment of the present invention.

### DETAILED DESCRIPTION OF THE INVENTION

Hereinafter, brake control apparatuses according to embodiments of the present invention will be illustrated with reference to the drawings. The brake control apparatuses according to the embodiments of the present invention are examined so as to satisfy much needs. The brake control apparatuses according to the present invention satisfies needs of the improvement of a pedal feeling at the regenerative coordinated (cooperative) control, for example, needs of the improvement of the response of the control, and so on.

### First Embodiment

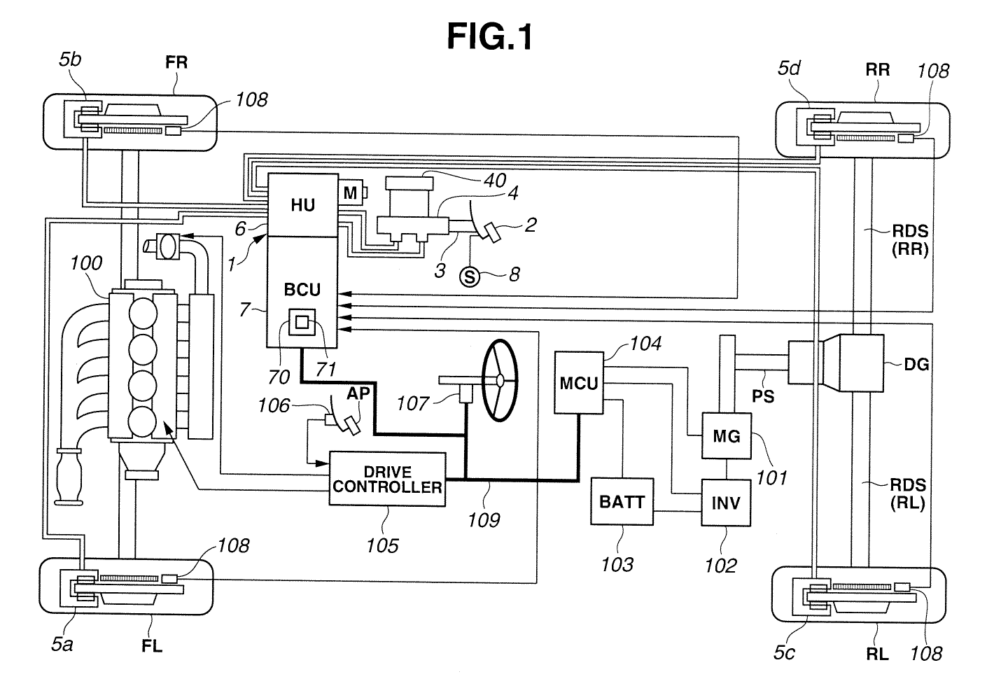

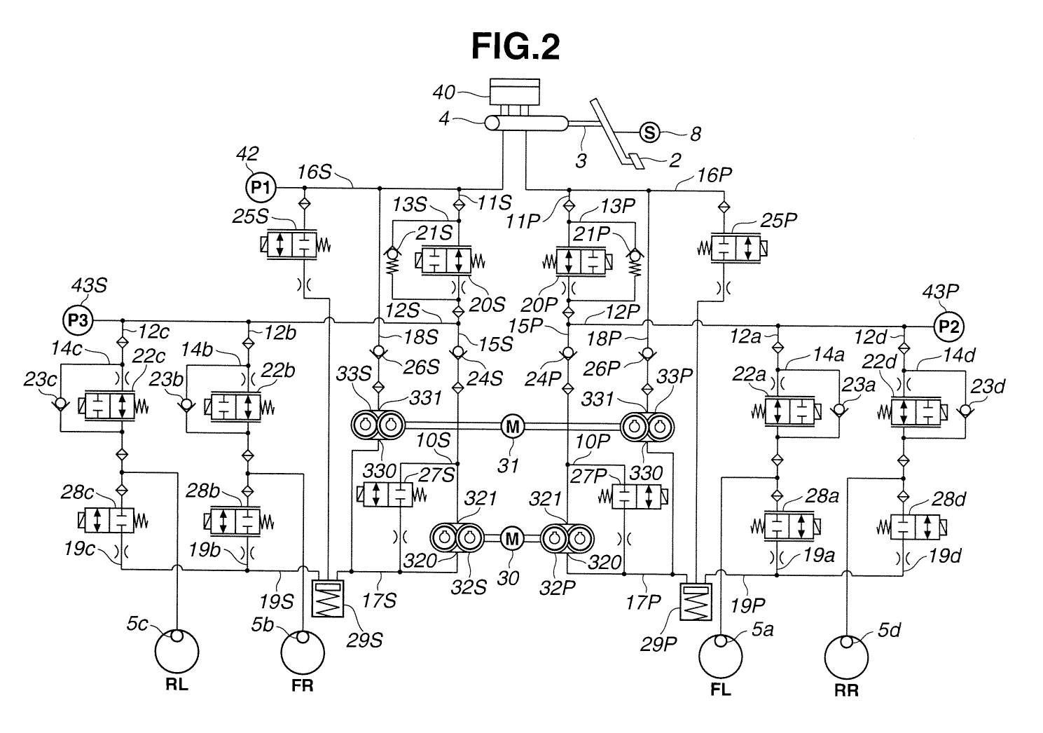

FIG. 1 is a view showing a system configuration of a driving system and a braking system of a vehicle to which a brake control apparatus 1 according to a first embodiment of the present invention is applied. FIG. 2 is a view showing a circuit configuration of the brake control apparatus 1 according to the first embodiment of the present invention. The vehicle is a hybrid vehicle including front wheels FL and FR driven by an internal combustion engine (engine 100), and rear wheels RL and RR driven by an electric motor (motor generator 101). Wheels FL, FR, RL, and RR are provided, respectively, with wheel speed sensing sections (wheel speed sensors) 108 arranged to sense respective rotational speeds (wheel speeds). Electronic control units (a control unit 7, a motor control unit 104, and a drive controller 105) are connected with each other by signal wires (CAN communication lines 109) capable of exchanging information with each other. A driving system of the vehicle includes engine 100, motor generator 101, an inverter 102, a battery 103, motor control unit 104, and drive controller 105. Engine 100 is a gasoline engine or a diesel engine. An output shaft of engine 100 is connected through an automatic transmission (not shown) to drive shafts of front wheels FL and FR. Opening degrees of throttle valves and so on of engine 100 are controlled based on a control command from drive controller 105 which is the electronic control unit. Drive controller 105 receives a signal from an accelerator operation amount sensing section (accelerator opening sensor) 106 provided to an accelerator pedal AP.

Motor generator 101 is a synchronous motor generator including a rotor in which permanent magnets are embedded, and a stator around which coils are wound. An output shaft of the rotor is connected through a propeller shaft PS and a differential gear DG to drive shafts RDS of rear wheels RL and RR. Motor generator 101 is controlled by three-phase alternating current generated by inverter 102 based on the control command from motor control unit 104 which is the electronic control unit. Motor generator 101 can operate as an electric motor arranged to drivingly rotate by receiving a supply of electric power from battery 103 (hereinafter, this state is referred to as a power running). Moreover, motor generator 101 can operate as a generator arranged to generate an electromotive force at both ends of each stator coil to charge battery 103 when the rotor is rotated by external force (hereinafter, this operation state is referred to as a regeneration). Inverter 102 converts the DC (direct-current) power of battery 103 to the AC (alternating-current) power based on a driving command from motor control unit 104, and supplies this AC power to motor generator 101 so that motor generator 101 performs the power running. On the other hand, inverter 102 converts the AC power generated in motor generator 101 to the DC power to charge battery 103 so that motor generator 101 performs the regeneration. The steering system of the vehicle includes a steering shaft connecting the steering wheel and steered wheels, and a steering state sensing section (steering angle sensor 107 and so on) provided to the steering shaft.

A braking system of the vehicle includes brake control apparatus 1, brake pedal 2, a master cylinder 4, and wheel cylinders 5. Brake pedal 2 is connected through an input rod 3 to master cylinder 4. Brake pedal 2 is provided with a brake pedal stroke sensor 8 (brake operation state sensing section) arranged to sense a stroke amount (hereinafter, referred to as a pedal stroke S) of brake pedal 2, as a brake operation state of the driver. Master cylinder 4 is a hydraulic pressure generating device arranged to generate the brake hydraulic pressure (master cylinder pressure P1) by the brake operation of the driver. Master cylinder 4 is provided integrally with a reservoir tank 40 which is a fluid source storing the hydraulic fluid (the brake fluid). Master cylinder 4 receives the supply of the brake fluid from reservoir tank 40. Master cylinder 4 is a tandem type connected to a hydraulic pressure control unit 6 through brake piping system of independent two systems (primary P-system, and secondary S-system). Wheel cylinders 5 are provided to wheels FL, FR, RL, and RR. Each of wheel cylinders 5 is arranged to generate the frictional braking force by the brake hydraulic pressure (wheel cylinder pressure P2).

Brake control apparatus 1 includes hydraulic pressure control unit 6 arranged to control the brake fluid pressures of wheels FL, FR, RL, and RR, and a brake control unit 7 which is an electronic control unit configured to control hydraulic pressure control unit 6. Brake control apparatus 1 is a mechanical integration (an integral device including a mechanical device and an electronic device) by integrating (combining) hydraulic pressure control unit 6 and brake control unit 7. Besides, hydraulic pressure control unit 6 and brake control unit 7 may be formed as different units. Hydraulic pressure control unit (hydraulic pressure brake device) 6 is an actuator disposed between master cylinder 4 and wheel cylinders 5 through brake pipes. Hydraulic pressure control unit 6 includes hydraulic pressure equipments which are arranged to generate control hydraulic pressures supplied to wheel cylinders 5, and which includes a pump (for example, a rotary type pump) that is a hydraulic pressure generating source, a plurality of control valves and so on, and a housing receiving these hydraulic pressure equipments. Hydraulic pressure control unit 6 is arranged to increase, decrease, or hold the hydraulic pressures of wheel cylinder 5a of left front wheel FL, wheel cylinder 5b of right front wheel FR, wheel cylinder 5c of left rear wheel RL, and wheel cylinder 5d of right rear wheel RR, based on frictional brake force command from brake control unit 7 (hydraulic pressure control section 70).

Motor control unit 104 is configured to output a drive command to inverter 102 based on a driving force command from drive controller 105, and to output a regenerative command to inverter 102 based on a regenerative braking force command from brake control unit 7. Motor control unit 104 is configured to transmit the situation of the output control of the driving force or the regenerative braking force by motor generator 101, and a generable maximum regenerative braking force which can be generated at this time, through communication line 109 to brake control unit 7, and drive controller 105. In this case, “the generable maximum regenerative braking force” is calculated, for example, from a battery SOC estimated from a voltage across terminals of battery 103, and a current value of battery 103, and a vehicle body speed (vehicle speed) calculated (estimated) from vehicle wheel speed sensors 108. Moreover, at the turning (cornering), the generable maximum regenerative braking force is calculated in consideration of a steering characteristic of the vehicle. That is, it is necessary to prevent overcharge for the battery protection in a full charge state in which battery SOC is an upper limit value or a value near the upper limit value. Moreover, when the vehicle speed is decreased by the braking, the generable maximum regenerative braking force by motor generator 101 is decreased. Moreover, when the regenerative braking is performed at the high speed running, inverter 102 becomes the high load state. Accordingly, the maximum regenerative braking force is limited at the high speed running. In addition, in the vehicle according to the first embodiment, the regenerative braking force is applied to rear wheels RL and RR. Accordingly, when the regenerative braking force is excessive relative to the frictional braking force at the turning, that is, when the braking force of rear wheels RL and RR is excessively larger than the braking force of front wheels FL and FR, the steering characteristic of the vehicle is notably in the oversteering tendency (the steering characteristic of the vehicle becomes an excess oversteer state). With this, the turning (cornering) behavior is disturbed. Accordingly, when the oversteering tendency becomes stronger, it is required to limit the maximum regenerative braking force so that the distribution (allocation) of the braking force between the front and rear wheels at the turning approach (is closer to) an ideal distribution according to specifications of the vehicle (for example, front:rear=6:4). Motor generator 101, inverter 102, battery 103, and motor control unit 104 constitute a regenerative braking device arranged to generate the regenerative braking to the wheels (left and right rear wheels RL and RR).

Drive controller 105 receives an accelerator opening from accelerator opening sensor 106, the vehicle speed (the vehicle body speed) calculated by wheel speed sensors 108, battery SOC and so on, directly or through communication lines 109. Drive controller 105 performs an operation control of engine 100, an operation control of the automatic transmission (not shown), and an operation control of motor generator 101 by the driving force command to motor control unit 104, based on the information from each sensor.

Brake control unit 7 receives master cylinder pressure P1 from a master cylinder pressure sensor (master cylinder state sensing section) 42, pedal stroke S from brake pedal stroke sensor (brake operation state sensing section) 8, a handle steering angle θ from steering angle sensor 107, wheel speeds Va, Vb, Vc, and Vd from wheel speed sensors 108, wheel cylinder pressures P2 from wheel cylinder pressure sensors (wheel cylinder state sensing sections) 43, battery SOC and so on, directly or through communication lines 109. Brake control unit 7 calculates a driver's required (request) braking force based on pedal stroke S from brake pedal stroke sensor 8, and the informations from the other sensors. Drive controller 105 distributes (splits) the calculated driver's required braking force into the regenerative braking force and the frictional braking force. Drive controller 105 performs the operation control of the hydraulic pressure control unit 6 by the frictional braking force command to brake control unit 7, and the operation control of motor generator 101 by the regenerative braking force command to motor control unit 104. In the first embodiment, in the regenerative coordinated control, the regenerative braking force is used in preference to the frictional braking force. When the regenerating braking force can cover the driver's required braking force, the braking force by the hydraulic pressure is not used. The range by the regenerative braking force is enlarged to the maximum (maximum regenerative braking force) without using the hydraulic braking force). With this, in a drive pattern in which the acceleration and the deceleration are repeated, the energy recovery efficiency becomes high, and the energy recovery by the regenerative braking is attained even at low vehicle speed. When the regenerative braking force is limited during the regenerative braking in accordance with the decrease and the increase of the vehicle speed and so on, brake control unit 7 is configured to decrease the regenerative braking force, and to increase the frictional braking force by the decreased amount of the regenerative braking force, and thereby to secure the necessary braking force (the driver's required braking force). Hereinafter, the operation to decrease the regenerative braking force and to increase the frictional braking force is referred to as a switching from the regenerating braking force to the frictional braking force. Conversely, the operation to decrease the frictional braking force and to increase the regenerative braking force is referred to as the switching from the frictional braking force to the regenerative braking force.

Brake control unit 7 is configured to increase, decrease, or hold wheel cylinder pressure P2 based on the signals from the sensors, and thereby to perform an automatic brake control to automatically increase or decrease wheel cylinder pressures P2 based on the braking force required by the various vehicle control, such as the anti-lock brake control (hereinafter, referred to as ABS control). The ABS control is a control to repeat the pressure decrease, the pressure holding, and the pressure increase of wheel cylinder pressure P2 so as to generate the maximum braking force to the wheels while preventing the lock of the wheels when it is sensed that the wheels become the lock tendency at the brake operation of the driver. The automatic braking control includes a vehicle stability assist control (vehicle behavior stabilization control) to improve the stability assist of the vehicle by controlling wheel cylinder pressure P2 of a predetermined controlled object when it is sensed that the oversteering tendency or the understeering tendency becomes stronger at the turning of the vehicle, a brake assist control (BAS) to generate, in wheel cylinder 5, a pressure higher than an actual pressure generated in master cylinder 4 at the brake operation of the driver, an EBD control to move distribution of the braking forces between the front and rear wheels, closer to an ideal braking force distribution, by gradually increasing the pressures of front wheels FL and FR, and a control to automatically generate the braking force in accordance with the relations with a preceding vehicle by auto cruise control.

[Brake Circuit Structure] Hydraulic pressure control unit 6 according to the first embodiment includes two piping structures including a P system (first piping system) including a first predetermined wheel group of the vehicle, and an S system (second piping system) including a second predetermined wheel group of the vehicle. In the first embodiment, an X-piping system is employed. The P system is connected with a wheel cylinder 5a of left front wheel FL and a wheel cylinder 5d of right rear wheel RR. The S system is connected with a wheel cylinder 5b of right front wheel FR and a wheel cylinder 5c of left rear wheel RL. Hereinafter, a symbol “P” attached to an end of the symbol of the member in FIG. 2 represents the P system, and a symbol “S” attached to an end of the symbol of the member in FIG. 2 represents the S system. Symbols “a”, “b”, “c”, and “d” indicate members corresponding to the left front wheel, the right front wheel, the left rear wheel, and the right rear wheel. In the below explanations, the additions of the symbols P and S, and a, b, c, and d are omitted when not distinguishing between the P system and the S system, and when not distinguishing among the wheels. First and second pumps 32 and 33, the valves, and the brake circuits of hydraulic pressure control unit 6 are provided, respectively, to the P system and the S system. First pump 32 and second pump 33 are configured to be independently driven. First pumps 32P and 32S are, for example, single gear pumps arranged to be driven by a common first motor 30, to pressurize the brake fluid sucked from a suction portion 320, and to discharge this pressurized fluid to a discharge portion 321. Second pumps 33P and 33S are, for example, single gear pumps arranged to be driven by a common second motor 31, to pressurize the brake fluid sucked from a suction portion 330, and to discharge this pressurized fluid to a discharge portion 331.

Hydraulic pressure control unit 6 employs a closed hydraulic pressure circuit. The closed hydraulic pressure circuit is a hydraulic circuit to return the brake fluid supplied to wheel cylinder 5, through master cylinder 4 to reservoir tank 40. Master cylinder 4 and wheel cylinder 5 are connected by a pipe 11 and a pipe 12. Pipe 12P is bifurcated into a pipe 12a and a pipe 12d. Pipe 12a is connected to wheel cylinder 5a. Pipe 12d is connected to wheel cylinder 5d. Pipe 12S is bifurcated into a pipe 12b and a pipe 12c. Pipe 12b is connected to wheel cylinder 5b. Pipe 12c is connected to wheel cylinder 5c. Pipes 11 and 12 constitute a first brake circuit. A wheel cylinder pressure sensor 43P is provided on pipe 12P. A wheel cylinder pressure sensor 43S is provided on pipe 12S. A gate-out valve 20 which is a normally-open proportional solenoid valve is provided on pipe 11. A pipe 13 is provided on pipe 11 parallel to gate-out valve 20. A relief valve 21 is provided on pipe 13. Relief valve 21 is a one-way valve arranged to prohibit a flow of the brake fluid from wheel cylinder 5 to master cylinder 4, and to allow a flow of the brake fluid in an opposite direction from master cylinder 4 to wheel cylinder 5. A set pressure Pr of relief valve 21 (a pressure difference between the upstream and downstream sides of the relief valve 21 to open relief valve 21, that is, a valve opening pressure) is a value (corresponding value) corresponding to the hydraulic pressure of the brake hydraulic pressure corresponding to the maximum deceleration degree generated by the regenerative braking device, that is, a limit value of the maximum regenerative braking force (an upper limit value of the maximum regenerative braking force determined by characteristics and abilities of motor generator 101 and inverter 102).

Solenoid-in valves (inflow valves) 22 which are normally-open proportional solenoid valves, and which correspond to wheel cylinders 5 are provided, respectively, on pipes 12. A pipe 14 is provided on pipe 12 in parallel to solenoid in valve 22. A check valve 23 is provided on pipe 14. Check valve 23 is arranged to allow a flow of the brake fluid in a direction from wheel cylinder 5 to master cylinder 4, and to prohibit a flow of the brake fluid in an opposite direction from master cylinder 4 to wheel cylinder 5. A pipe 15 connects a connection point between pipe 11 and pipe 12, and discharge portion 321 of first pump 32. Pipe 15 constitutes a second brake circuit connected to the first brake circuit. A discharge valve 24 of first pump 32 is provided on pipe 15. Discharge valve 24 is arranged to allow a flow of the brake fluid in a direction from discharge portion 321 to pipe 11 and pipe 12, and to prohibit a flow of the brake fluid in an opposite direction from pipe 11 and pipe 12 to discharge portion 321. First pump 32 constitutes a booster arranged to increase (pressurize) the pressure of the brake fluid within master cylinder 4, and to supply this pressurized brake fluid through the second brake circuit to wheel cylinder 5. That is, first pump 32 is arranged to suck the brake fluid within master cylinder 4, to discharge this brake fluid through the second brake circuit to the first brake circuit, and thereby to increase the hydraulic pressure of wheel cylinder 5.

A pipe 16 and a pipe 17 connect a portion of pipe 11 on the master cylinder 4's side of gate-out valve 20, and suction portion 320 of first pump 32. Pipe 16 and pipe 17 constitute a third brake circuit. The third brake circuit is bifurcated from the first brake circuit, and connected to the suction side of first pump 32. Gate-out valve 20 is provided on the first brake circuit (pipe 11) between a connection point between the first brake circuit (pipe 11) and the second brake circuit (pipe 15), and a bifurcating point between the first brake circuit (pipe 11) and the third brake circuit (pipe 16). A gate-in valve 25 which is a normally-closed proportional solenoid valve is provided on pipe 16 connected to pipe 11. A reservoir 29 which is a reservoir tank within hydraulic pressure control unit 6 is provided at a connection point between pipe 16 and pipe 17. Master cylinder pressure sensor 42 is provided at a position on the master cylinder 4's side of gate-in valve 25S in pipe 16S of the S system. Master cylinder pressure sensor 42 is provided at a position on the master cylinder 42's side of gate-out valve 20S.

A pipe 18 connects pipe 17 connected to suction portion 320 of first pump 32, and a portion of pipe 16 on the master cylinder 4's side of gate-in valve 25. Pipe 18 constitutes a recirculating circuit. The recirculating circuit (pipe 18) is bifurcated from a portion (pipe 17) of the third brake circuit between reservoir 29 and the suction side of first pump 32, and connected to a portion (pipe 16) of the third brake circuit between reservoir 29 and a portion on a downstream side of the bifurcating point between the third brake circuit and the first brake circuit (pipe 11). Gate-in valve 25 is provided is provided between reservoir 29 and a connection point between the third brake circuit (pipe 16) and the recirculating circuit (pipe 18). Second pump 33 is provided on pipe 18. A discharge side of second pump 33 is connected to pipe 16. A discharge valve 26 of second pump 33 is provided on pipe 18. Discharge valve 26 is arranged to allow a flow of the brake fluid in a direction from discharge portion 331 to pipe 16, and to prohibit a flow of the brake fluid in an opposite direction from pipe 16 to discharge portion 331. Second pump 33 constitutes the recirculating device arranged to recirculate (return) the brake fluid stored in reservoir 29, to the first brake circuit's side (pipe 11's side). That is, second pump 33 is arranged to suck the brake fluid stored in reservoir 29, and to recirculate (return) the sucked brake fluid to the first brake circuit's side (pipe 11's side). A pipe 10 connects a portion of pipe 15 on the first pump 32 (discharge portion 321)'s side of discharge valve 24, and a portion of pipe 17 on the first pump 32 (suction portion 320)'s side of a connection portion between pipe 17 and pipe 18. Pipe 10 constitutes a connection passage connecting the discharge side and the suction side of first pump 32. A switching valve 27 which is a normally-closed ON/OFF solenoid valve is provided on pipe 10.

A pipe 19 connects suction portion 320 of first pump 32 and a portion of pipe 12 on the wheel cylinder 5's side of solenoid-in valve 22. This pipe 19 constitutes a fourth brake circuit. The fourth brake circuit connects wheel cylinder 5 and reservoir 29. A solenoid-out valve (outflow valve) 28 which is a normally-closed solenoid valve is provided on pipe 19. In solenoid out valves 28a, 28d, 28b, and 28c, valves 28a and 28b of front wheels FL and FR are the proportional solenoid valves, and valves 28c and 28d of rear wheels RL and RR are the ON/OFF valves.

Brake control unit 7 includes hydraulic pressure control section 70 configured to control the actuations of the valves (gate-in valve 25, gate-out valve 20, solenoid-in valve 22, solenoid-out valve 28, and switching valve 27), and the actuations of motors 30 and 31 in accordance with the sensed brake operation state (pedal stroke S), and the operation states (the actuation states) of the regenerative braking devices (motor generator 101, inverter 102, and battery 103). Hydraulic pressure control section 70 is configured to set a target value of wheel cylinder pressure P2 (target wheel cylinder pressure), based on the frictional braking force command from drive controller 105, and to set a target value of master cylinder pressure P1 (target master cylinder pressure), based on the sensed pedal stroke S. The target master cylinder pressure is set so as to satisfy a predetermined relation between the target master cylinder pressure and pedal stroke S. This predetermined relation is a relation characteristic (brake pedal characteristic) between the brake pedal depression force (master cylinder pressure P1) and pedal stroke S. This predetermined relation is previously determined. Hydraulic pressure control section 70 performs PWM controls of gate-in valve 25, gate-out valve 20, solenoid-in valve 22, solenoid-out valves 28a and 28b of front wheels FL and FR, and performs ON/OFF controls of solenoid-out valves 28c and 28d of rear wheels RL and RR, and switching valve 27.

Hydraulic pressure control section 70 calculates a command rotational speed (rotation command value) to continuously drive first motor 30, and actuates first motor 30 based on the command rotational speed while brake pedal stroke sensor 8 senses pedal stroke S. That is, hydraulic pressure control section 70 continues to drive and rotate first pump 32 while the driver operates brake pedal 2. In particular, hydraulic pressure control section 70 sets the command rotational speed of first motor 30 to a low predetermined value (basic rotational speed) by which the rotation is held, when wheel cylinder pressure P2 is held or decreased (at the holding or the decrease of wheel cylinder pressure P2). At the increase of wheel cylinder pressure P2, when wheel cylinder pressure P2 sensed by wheel cylinder pressure sensor 43 becomes smaller than the target wheel cylinder pressure, hydraulic pressure control section 70 increases the command rotational speed to be greater than the above-described predetermined value (basic rotational speed) in accordance with deviation between wheel cylinder pressure P2 and the target wheel cylinder pressure so that the sensed wheel cylinder pressure P2 corresponds to the target wheel cylinder pressure.

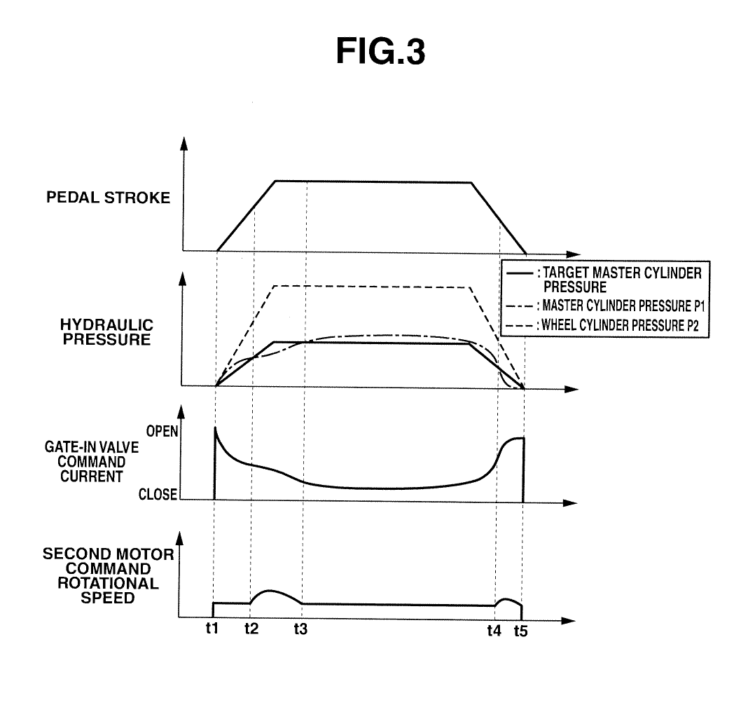

Moreover, hydraulic pressure control section 70 includes a depression force generating section 71 configured to generate (produce) the brake pedal depression force (pedal reaction force) by driving and rotating second pump 33. FIG. 3 is a time chart showing an example of operations of the actuators by pedal depression force generating section 71. Pedal depression force producing section 71 performs the hydraulic pressure control (time t1-t5 in FIG. 3) by controlling gate-in valve 25 during the brake operation of the driver, that is, while brake pedal stroke sensor 8 senses pedal stroke S. In particular, hydraulic pressure control section 70 is configured to output the command current to gate-in valve 25 so as to control the opening and closing operations (valve opening amount) of gate-in valve 25 so that master cylinder pressure P1 sensed by master cylinder pressure sensor 42 corresponds to the target master cylinder pressure, and to control the opening and closing operation (valve opening degree) of gate-in valve 25. In other words, gate-in valve 25 controls pedal stroke S and master cylinder pressure P1 so that a relationship between the sensed pedal stroke S and the sensed master cylinder pressure P1 always becomes a predetermined relationship (a predetermined brake pedal characteristic). In this case, gate-in valve 25 operates to supply the brake fluid to reservoir 29 (times t1-t2 and t3-t4 in FIG. 3) when the sensed master cylinder pressure P1 is greater than the target master cylinder pressure (the master cylinder pressure which satisfies the predetermined relationship with the sensed pedal stroke S (between the master cylinder pressure and the sensed pedal stroke S).

Pedal depression force generating section 71 basically always calculates the command rotational speed for continuously driving second motor 31 during the brake operation of the driver, and actuates second motor 31 based on the command rotational speed (times t1-t5 in FIG. 3). In particular, pedal depression force generating section 71 sets the command rotational speed of second motor 31 to a predetermined constant value (basic rotational speed). The above-described constant value (basic rotational speed) is set to a predetermined constant value by which the rotation can be held. For example, the above-described constant value is set to a rotational speed by which the brake fluid can be supplied to master cylinder 4 so as to decrease pedal stroke S when the driver returns the depression of the brake pedal by a predetermined speed at the regenerative coordinated control. When master cylinder pressure P1 sensed by master cylinder pressure sensor 42 becomes smaller than the target master cylinder pressure, pedal depression force generating section 71 increases the command rotational speed to be greater than the constant value (the basic rotational speed) in accordance with the deviation between master cylinder pressure P1 and the target master cylinder pressure so that the sensed master cylinder pressure corresponds to the target master cylinder pressure.

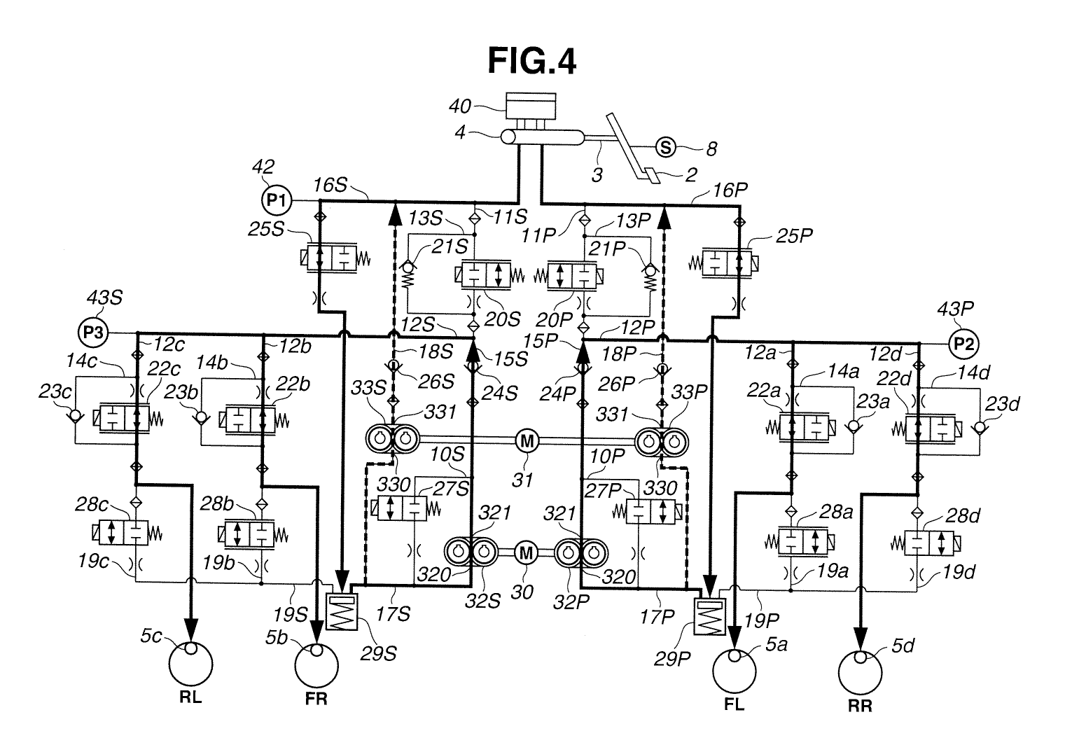

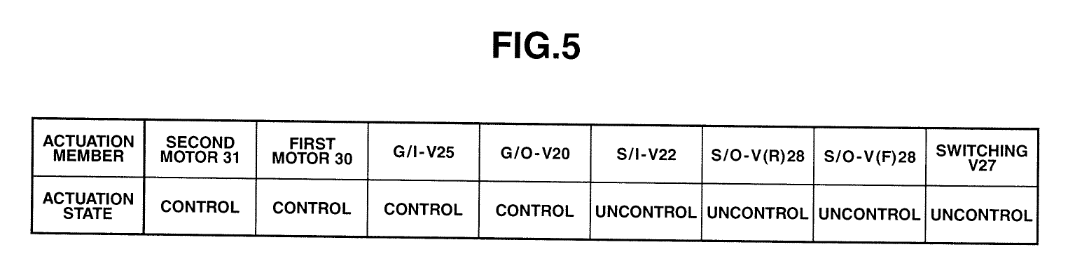

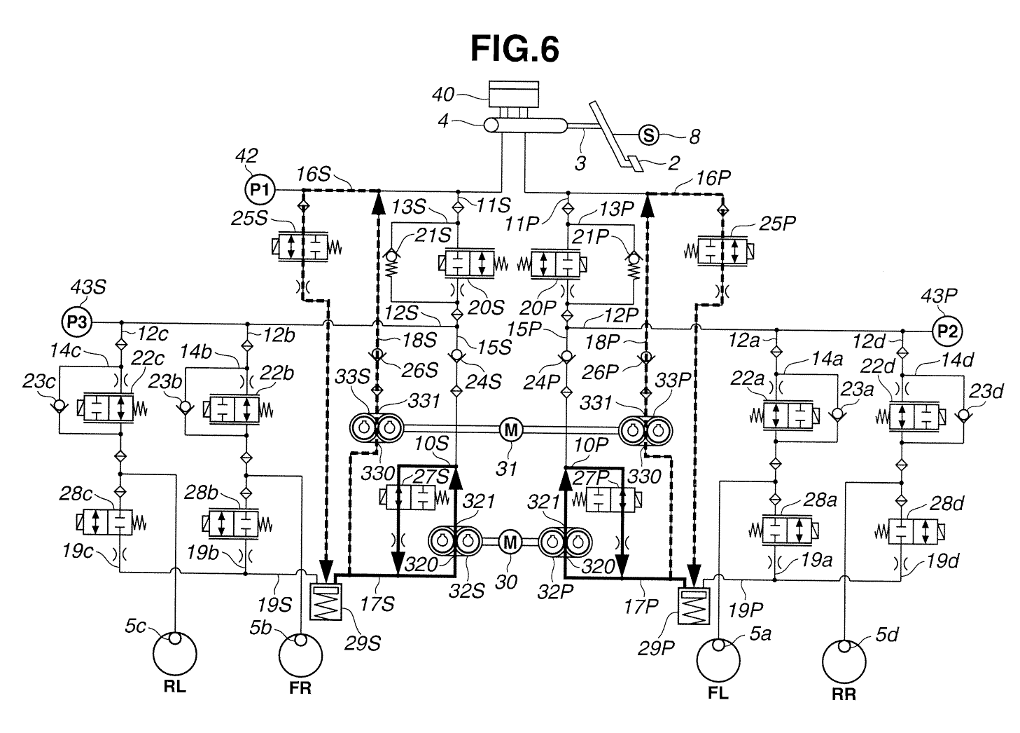

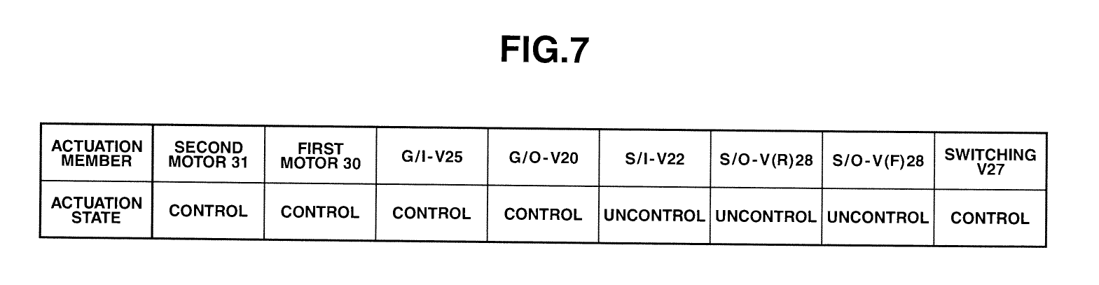

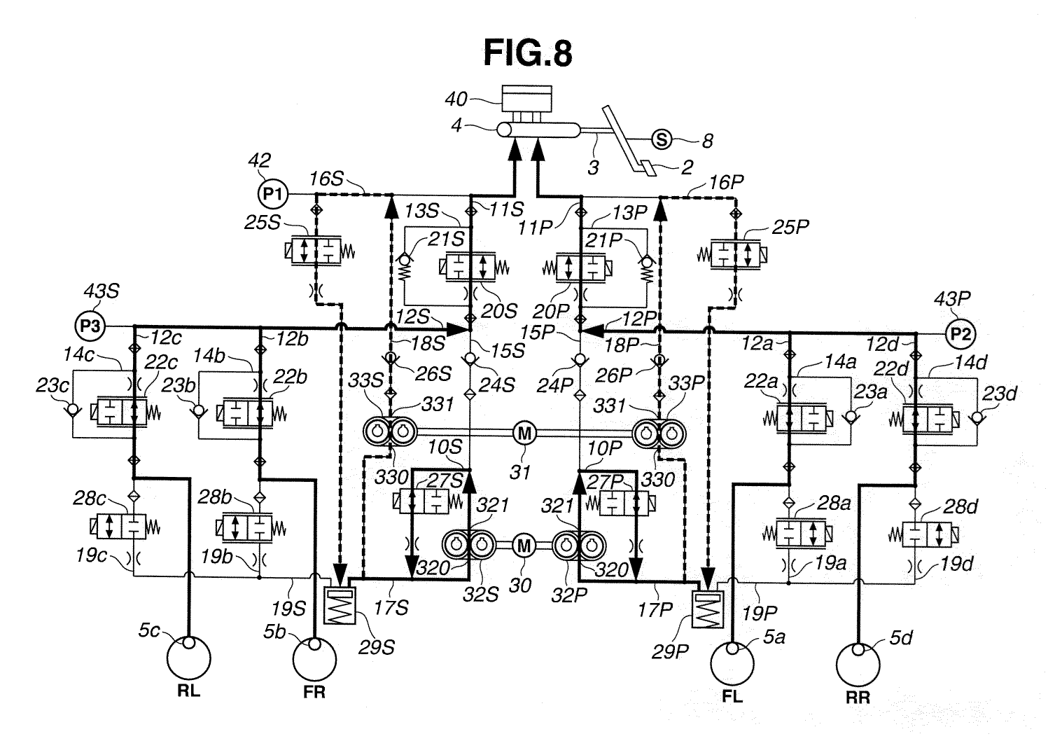

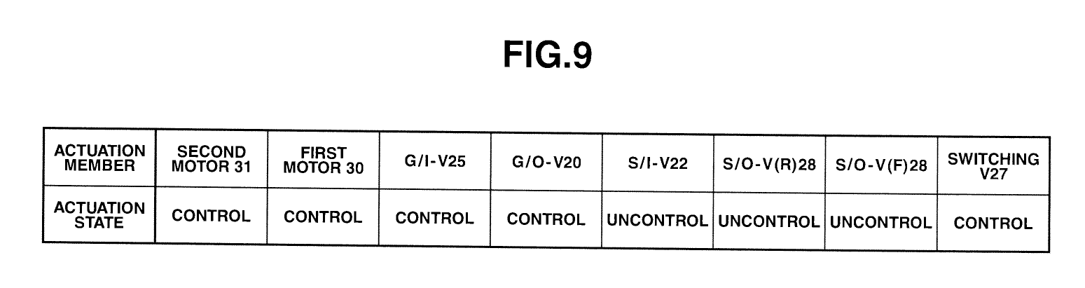

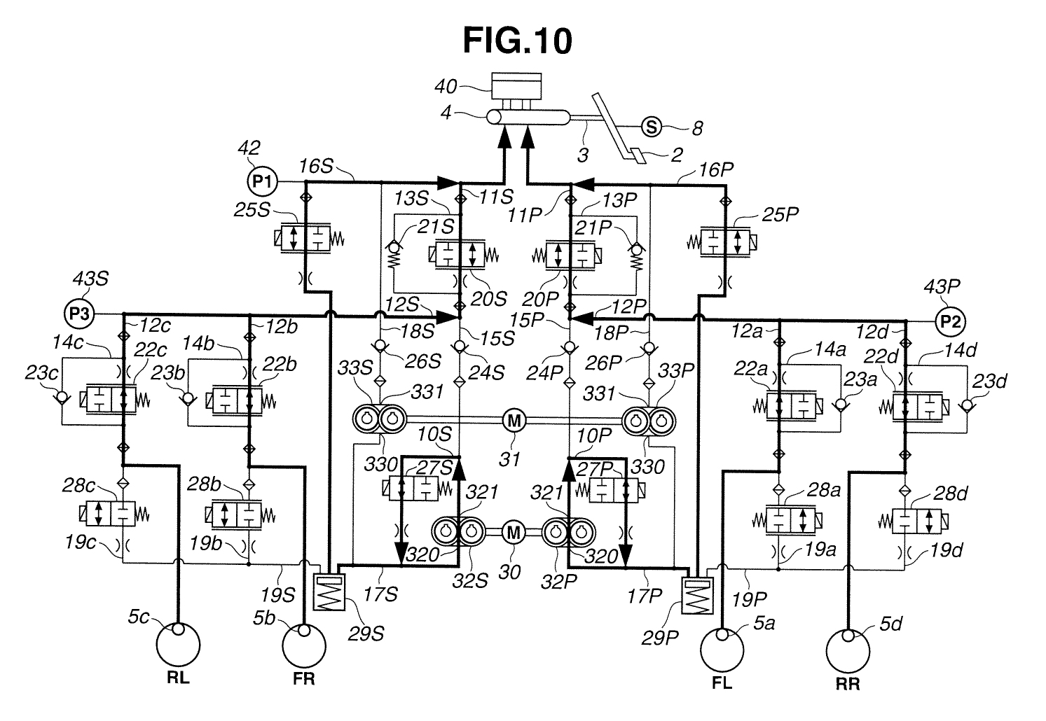

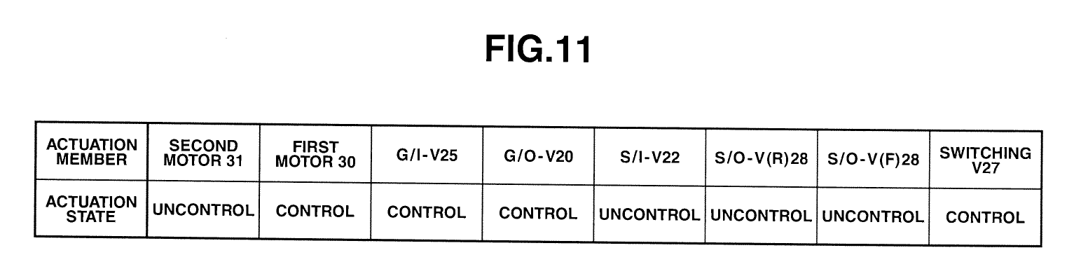

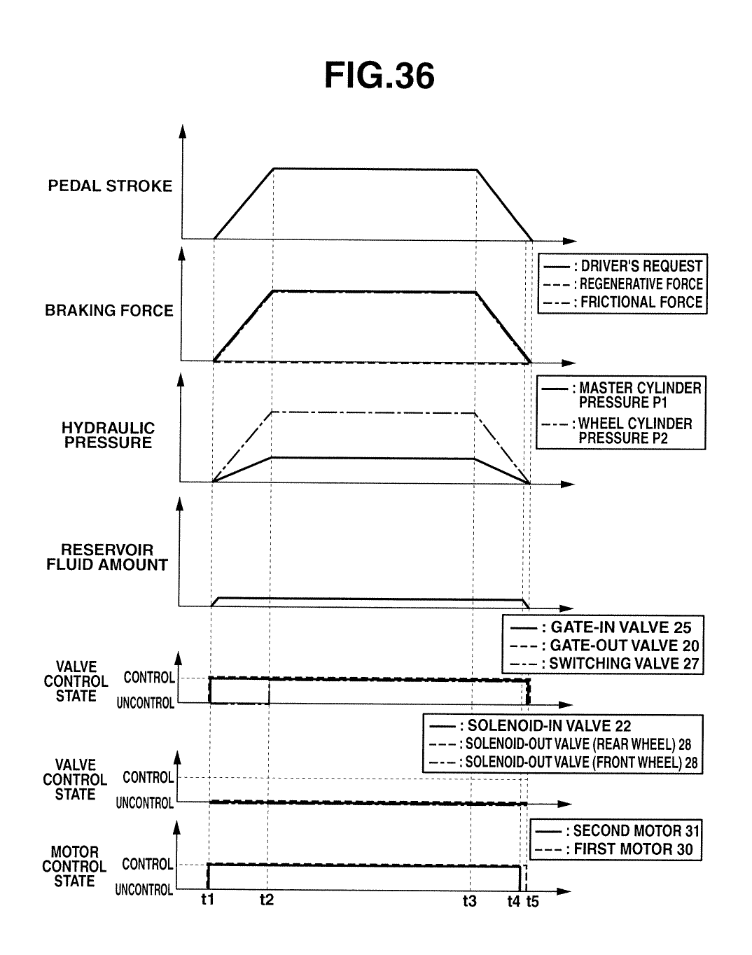

Hereinafter, operations of actuators (valves and pumps 32 and 33) of hydraulic pressure control unit 6 in various situations, and the variation of the braking force (the driver's required braking force, the regenerative braking force, and the frictional braking force) are illustrated by using the flow of the brake fluid in the hydraulic pressure circuit, and a time chart of the braking forces. The flows of the brake fluid are represented by bold lines and arrows in the hydraulic circuit. The hydraulic circuit performs the same operation in the P system and in the S system, except for a case in which the only wheel cylinder pressure P2 is increased, decreased, or held, like the intervention of the ABS control and so on.

[Normal Brake] FIG. 4, FIG. 6, FIG. 8, and FIG. 10 are hydraulic pressure circuit diagrams showing the flows of the brake fluid in the normal brake. FIG. 5, FIG. 7, FIG. 9, and FIG. 11 are tables showing actuation states of the actuators in the normal brake. FIG. 36 is a time chart in the normal brake. In this case, the normal brake represents that the frictional braking force is generated in accordance with the driver's brake operation in a state in which the intervention of the regenerative coordinated control by the regenerative braking device is not generated, and the automatic braking control such as the ABS and the vehicle behavior assist control is not performed. FIG. 36 is a time chart showing a case in which pedal stroke S is held after the depression of brake pedal 2, and then the depression of brake pedal 2 is returned. In the first embodiment, in the normal brake, solenoid-in valve 22 and solenoid-out valve 28 are not controlled (uncontrolled).

[Brake Pedal Depression in Normal Brake: Wheel Cylinder Pressure Increase] FIG. 4 shows a flow of the brake fluid at the depression of the pedal (at the increase of the driver's required braking force) in the normal brake. FIG. 5 shows actuation states of the actuators at the state of FIG. 4. An interval from time t1 to time t2 in FIG. 36 shows a time chart in the state of FIG. 4. Wheel cylinder pressure P2 is increased in accordance with the increase of the driver's required braking force since the regenerative braking force is not generated. The connection between master cylinder 4 and wheel cylinder 5 is shut off by controlling to close gate-out valve 20. Moreover, gate-in valve 25 is controlled to be closed. With this, the brake fluid flowing from master cylinder 4 through the first brake circuit (pipe 11) into wheel cylinder 5 is suppressed. Moreover, the brake fluid from master cylinder 4 is supplied through the third brake circuit (pipe 16) and gate-in valve 25 to reservoir 29, so that pedal stroke S is generated. Accordingly, the amount of the brake fluid within reservoir 29 is increased. Switching valve 27 is not controlled (uncontrolled) to be closed so as to close the connection passage. Consequently, the brake fluid which is sucked by first pump 32 from reservoir 29, and discharged by first pump 32 to the second brake circuit (pipe 15) is supplied (transmitted) mainly through the first brake circuit (pipe 12), and through solenoid-in valve 22 to wheel cylinder 5. Therefore, wheel cylinder pressure P2 is increased. The rotational speed of first motor 30 is increased in accordance with the speed of the increase of the wheel cylinder pressure P2. Moreover, second motor 31 (second pump 33) is driven and rotated. Second pump 33 sucks the brake fluid flowing into reservoir 29, from the third brake circuit (pipe 17), and discharges this brake fluid through the recirculating circuit (pipe 18) to a portion of the third brake circuit (pipe 16) on the upstream sides (that is, the master cylinder 4's side) of gate-in valve 25 and gate-out valve 20. Master cylinder pressure P1 is increased in accordance with the increase of pedal stroke S by controlling the valve opening degree of gate-in valve 25, and by controlling the rotational speed of second motor 31 (the discharge amount of second pump 33). A redundant amount of the discharged brake fluid unnecessary for the pressure increase of master cylinder P1 is recirculated through gate-in valve 25 and the third brake circuit (pipe 16) to reservoir 29.

[Brake Pedal Holding in Normal Brake: Wheel Cylinder Pressure Holding] FIG. 6 shows a flow of the brake fluid at the brake pedal holding (at the holding of the driver's required braking force) in the normal brake. FIG. 7 shows the actuation states in the state of FIG. 6. An interval from time t2 to time t3 of FIG. 36 shows a time chart in the state of FIG. 6. Wheel cylinder pressure P2 is held in accordance with the holding of the driver's required braking force since the regenerative braking force is not generated. The connection between master cylinder 4 and wheel cylinder 5 is shut off by controlling gate-out valve 20 to be closed. Moreover, gate-in valve 25 is controlled to be closed. First motor 30 is driven by the lower rotational speed (by the basic rotational speed) in preparation for the pressure increase by the depression of brake pedal 2. Switching valve 27 is controlled to be opened to connect (open) the connection passage. Accordingly, the brake fluid discharged by first pump 32 to the second brake circuit (pipe 15) is returned through the connection passage to the suction side of first pump 32, and is not supplied to wheel cylinder 5. With this, wheel cylinder pressure P2 is held. Furthermore, second motor 31 (second pump 33) is driven and rotated. The brake fluid which is sucked by second pump 33 from reservoir 29, and discharged by second pump 33 through the recirculating circuit to the master cylinder 4's side in the third brake circuit (pipe 16) is returned through gate-in valve 25 and the third brake circuit (pipe 16) to reservoir 29. The amount of the brake fluid within reservoir 29 is held to a substantially constant amount. Master cylinder pressure P1 is held in accordance with the holding of pedal stroke S by controlling the valve opening degree of gate-in valve 25, and by controlling the rotational speed of second motor 31 (the discharge amount of second pump 33).

[Pedal Depression Return in Normal Brake: Wheel Cylinder Pressure Decrease] FIG. 8 shows a flow of the brake fluid at the pedal depression return (at the decrease of the driver's required braking force) in the normal brake. FIG. 9 shows the actuation states of the actuators in the state of FIG. 8. An interval from time t3 to time t4 in FIG. 36 shows a time chart in the state of FIG. 8. Wheel cylinder pressure P2 is decreased in accordance with the driver's required braking force since the regenerative braking force is not generated. Gate-out valve 20 is controlled to be opened. The brake fluid from wheel cylinder 5 is returned through the first brake circuit (pipes 12 and 11) and gate-out valve 20 to master cylinder 4. With this, wheel cylinder pressure P2 is decreased. First motor 30 is driven, and switching valve 27 is controlled to be opened so as to connect (open) the connection passage. Accordingly, the brake fluid discharged by first pump 32 to the second brake circuit (pipe 15) is returned through the connection passage to the suction side of first pump 32, and is not supplied to wheel cylinder 5 or master cylinder 4. First motor 30 is driven by the lower rotational speed (by the basic rotational speed) in preparation for the pressure increase by the depression of brake pedal 2. Moreover, second motor 31 (second pump 33) is driven and rotated. The brake fluid which is sucked by second pump 33 from reservoir 29, and which is discharged by second pump 33 through the recirculating circuit to a portion of the third brake circuit (pipe 16) on the master cylinder 4's side is returned mainly through gate-in valve 25, through the third brake circuit (pipe 16) to reservoir 29. The amount of the brake fluid within reservoir 29 is held to a substantially constant amount. Master cylinder pressure P1 is decreased in accordance with the decrease of pedal stroke S by controlling the valve opening amount of gate-in valve 25, and by controlling the rotational speed of second motor 31 (the discharge amount of second pump 33).

FIG. 10 shows a flow of the brake fluid at a timing just before an end of the pedal compression return (at the decrease in an extremely small region of the driver's required braking force) at the normal brake. FIG. 11 shows the actuation states of the actuators in the state of FIG. 10. An interval from time t4 to time t5 in FIG. 36 shows a time chart in the state of FIG. 10. Wheel cylinder pressure P2 is decreased in the extremely small pressure region in accordance with the decrease in the extremely small region of the driver's required braking force since the regenerative braking force is not generated. Second motor 31 (second pump 33) is not controlled (uncontrolled), and is not driven and rotated, unlike the interval from time t3 to time t4 in FIG. 36 (FIG. 8 and FIG. 9). The brake fluid within reservoir 29 is returned through the third brake circuit (pipe 16) and gate-in valve 25 to master cylinder 4. Finally, the amount of the brake fluid becomes substantially zero. Master cylinder pressure P1 is decreased in accordance with the decrease of pedal stroke S by controlling the valve opening degree of gate-in valve 25. Besides, it is optional to continue to drive second motor 31, like the interval from time t3 to time t4.

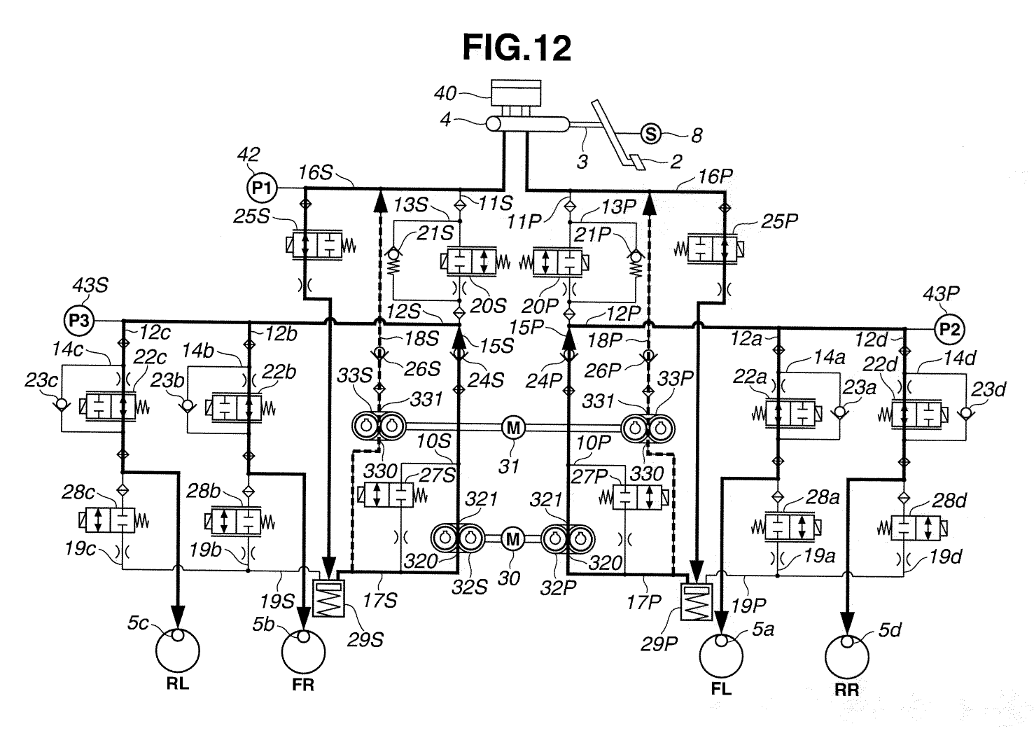

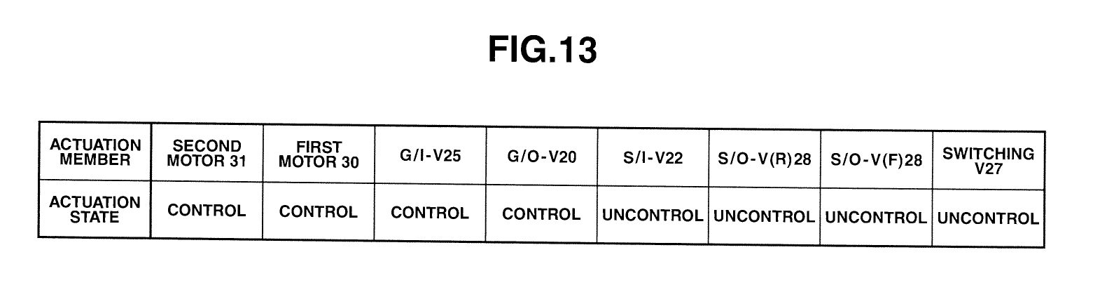

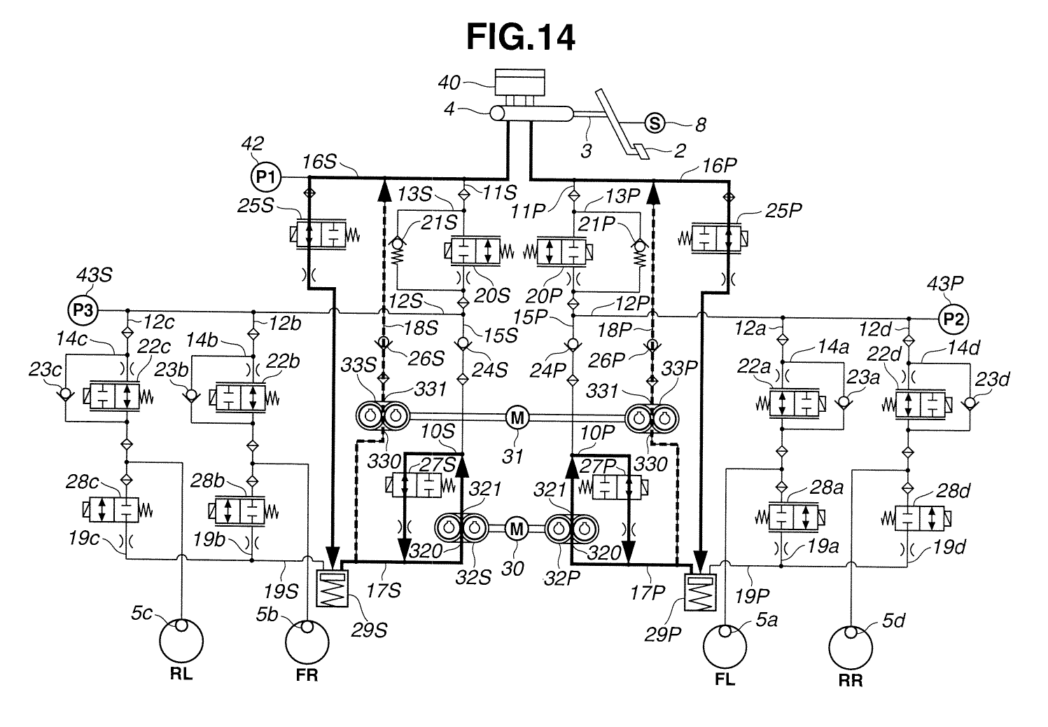

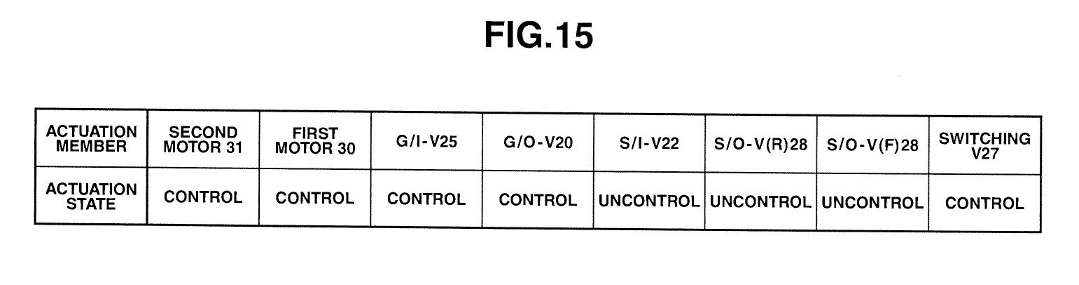

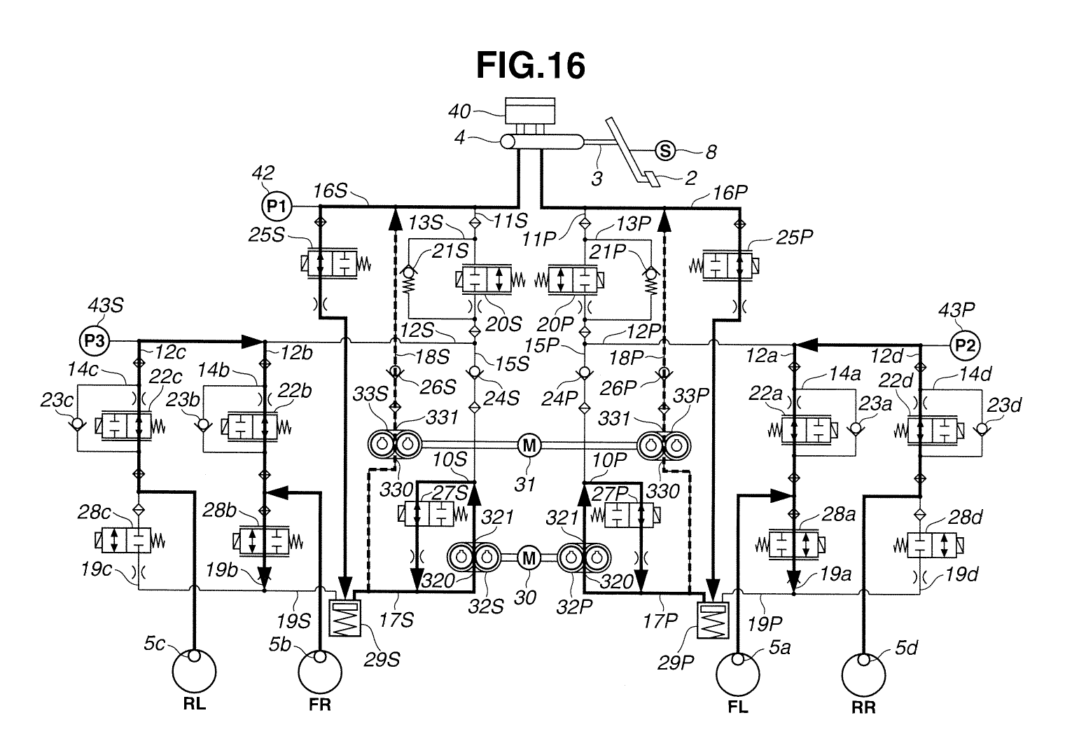

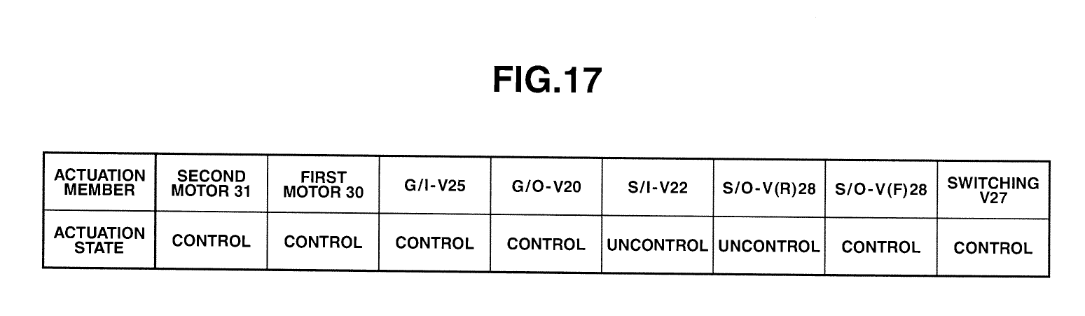

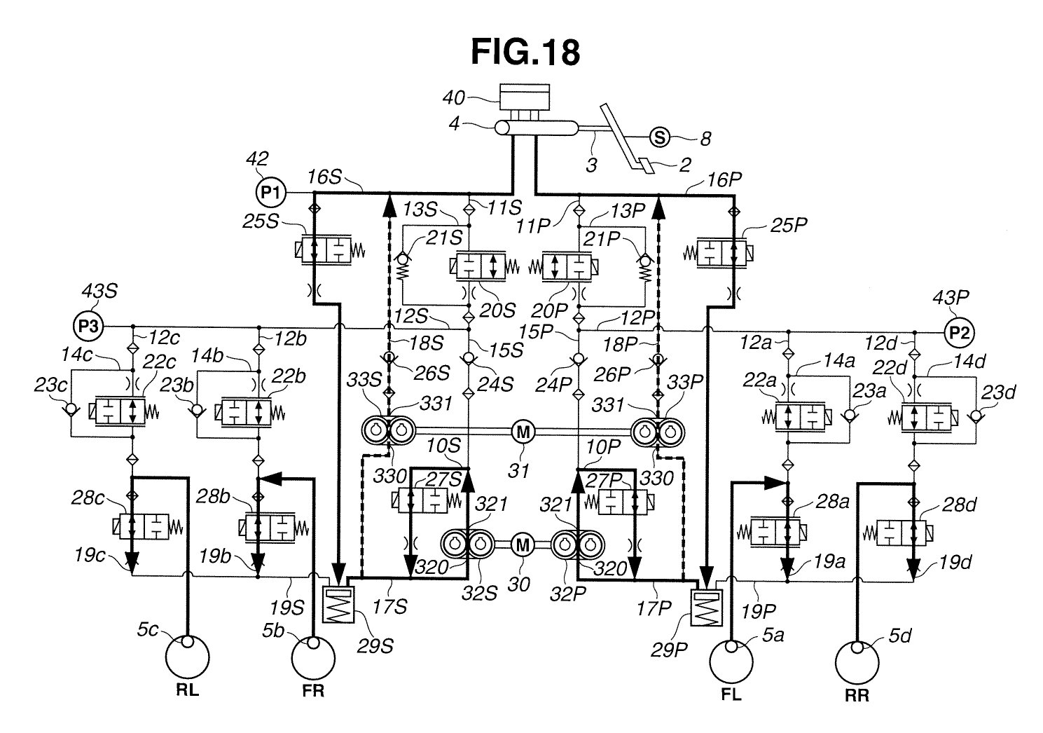

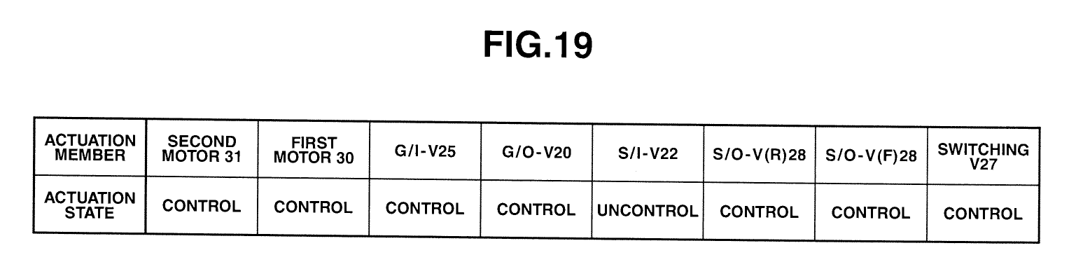

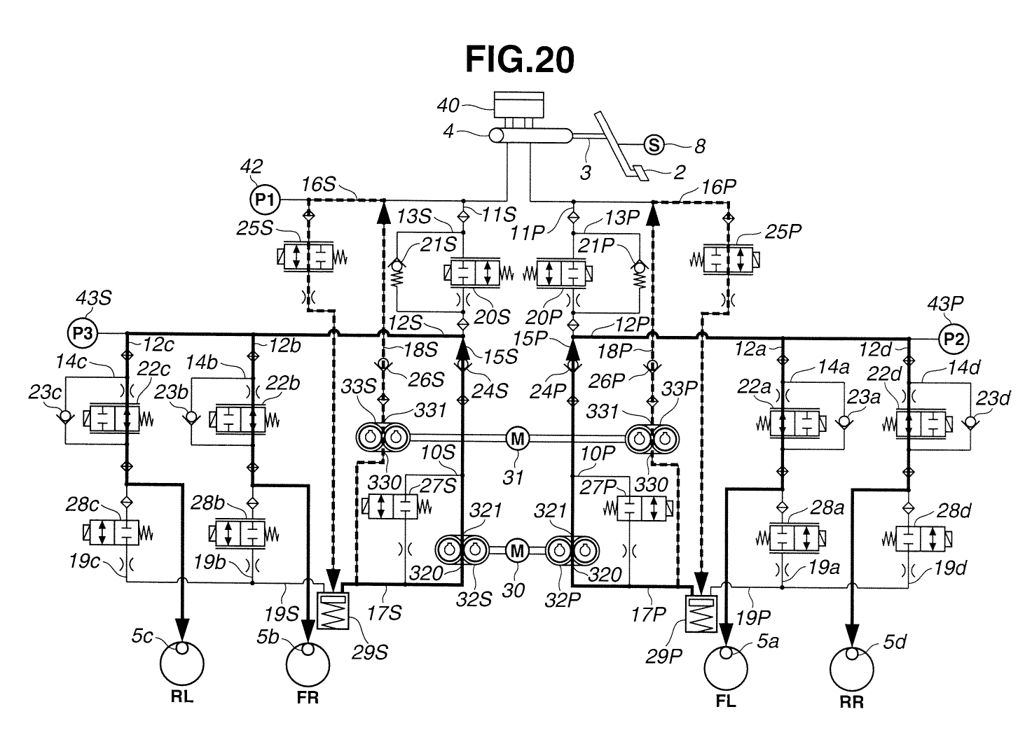

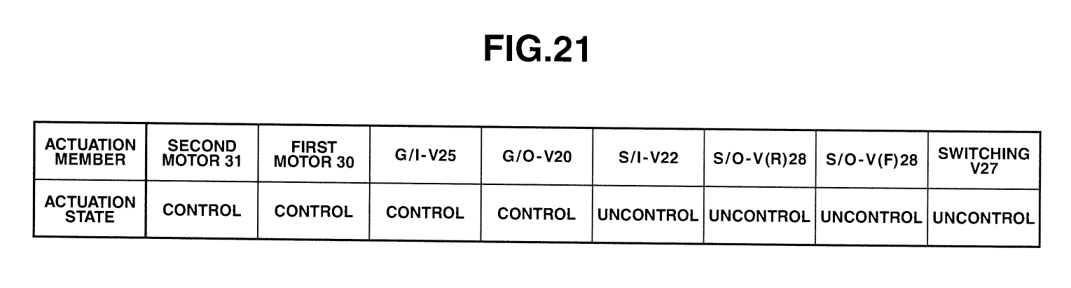

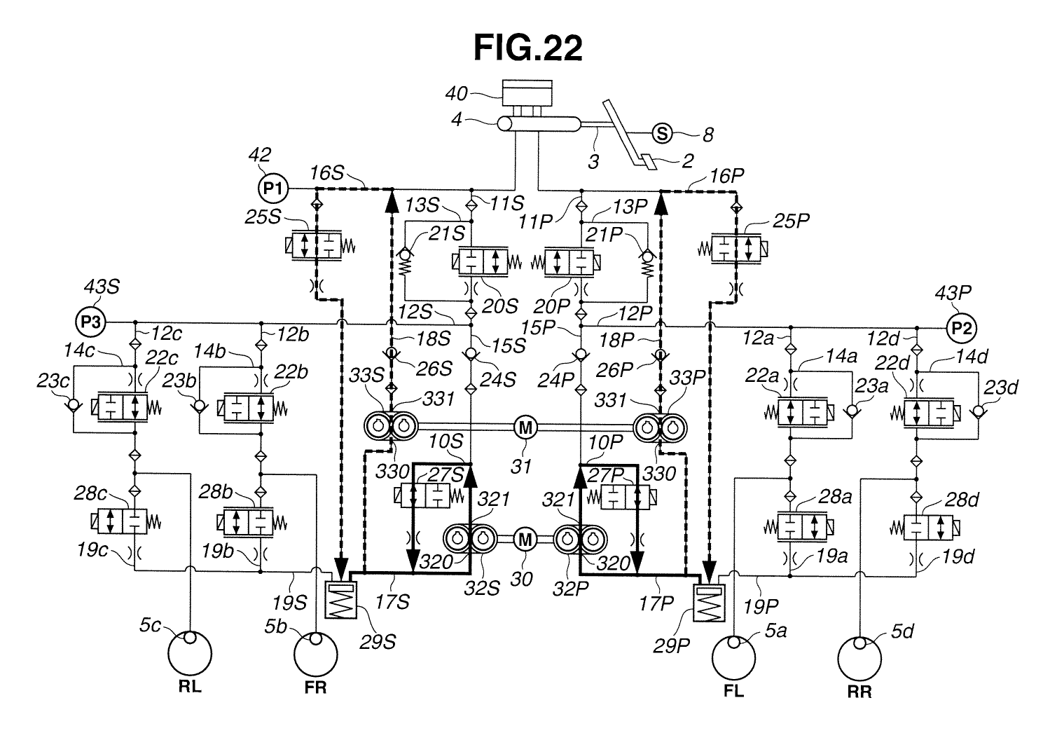

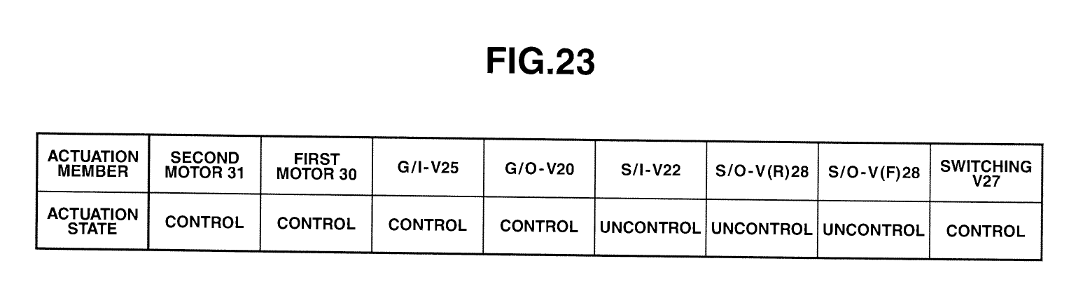

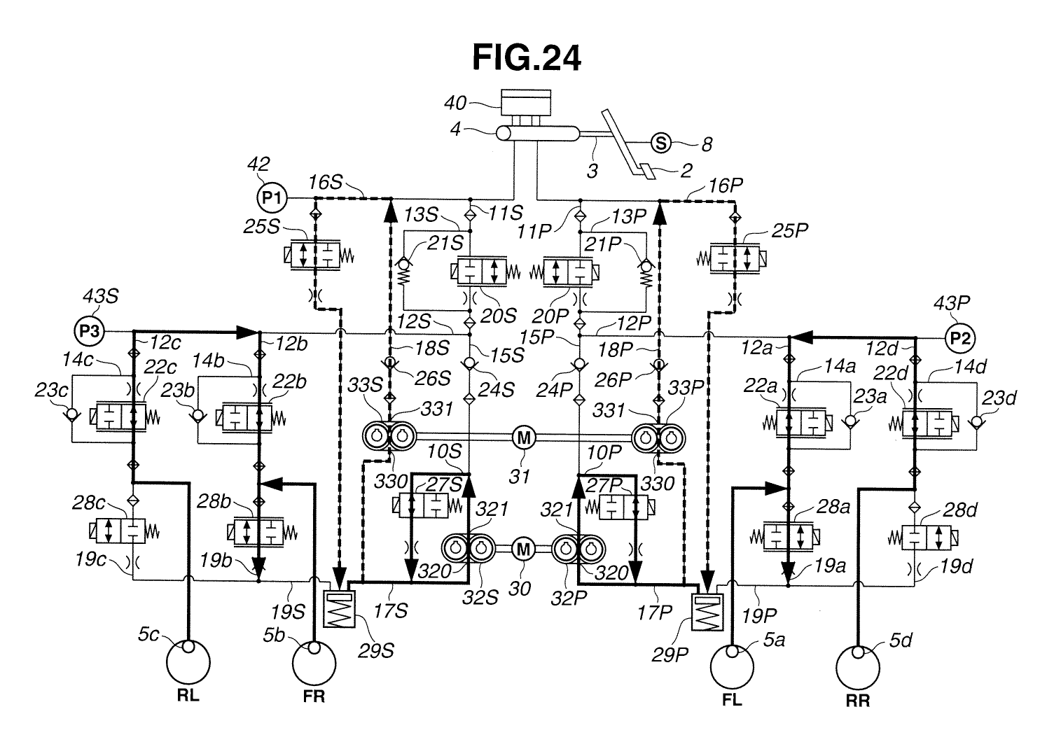

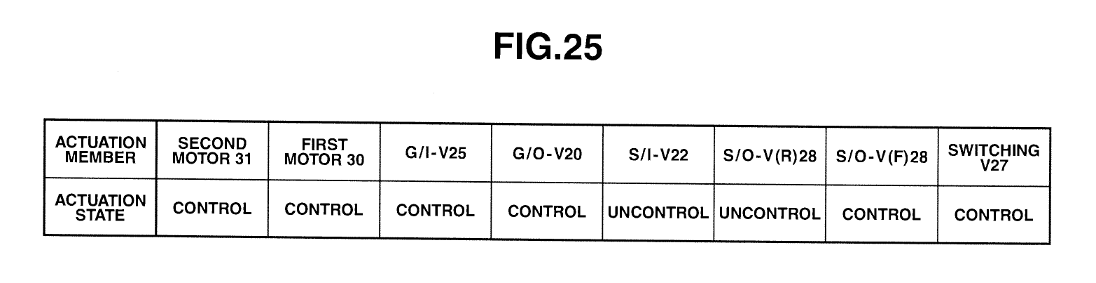

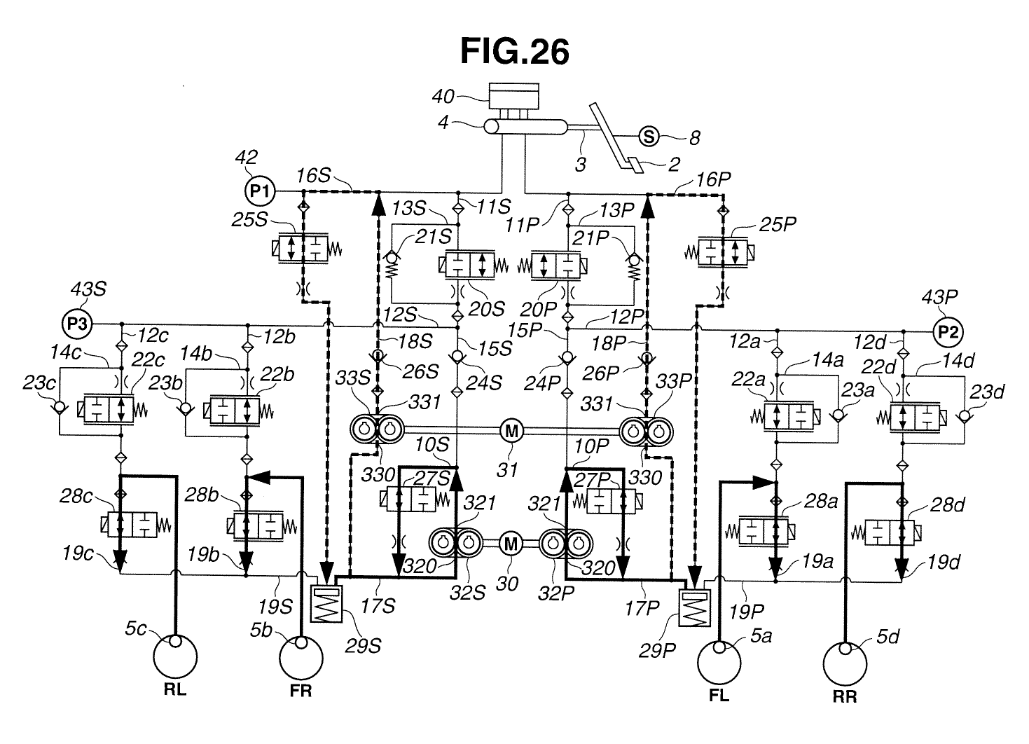

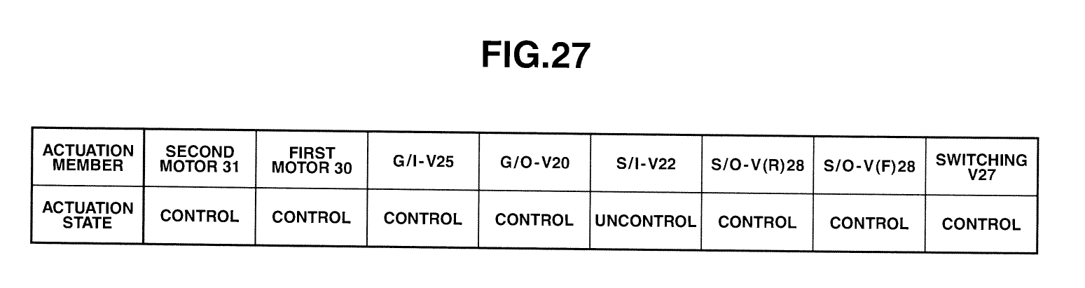

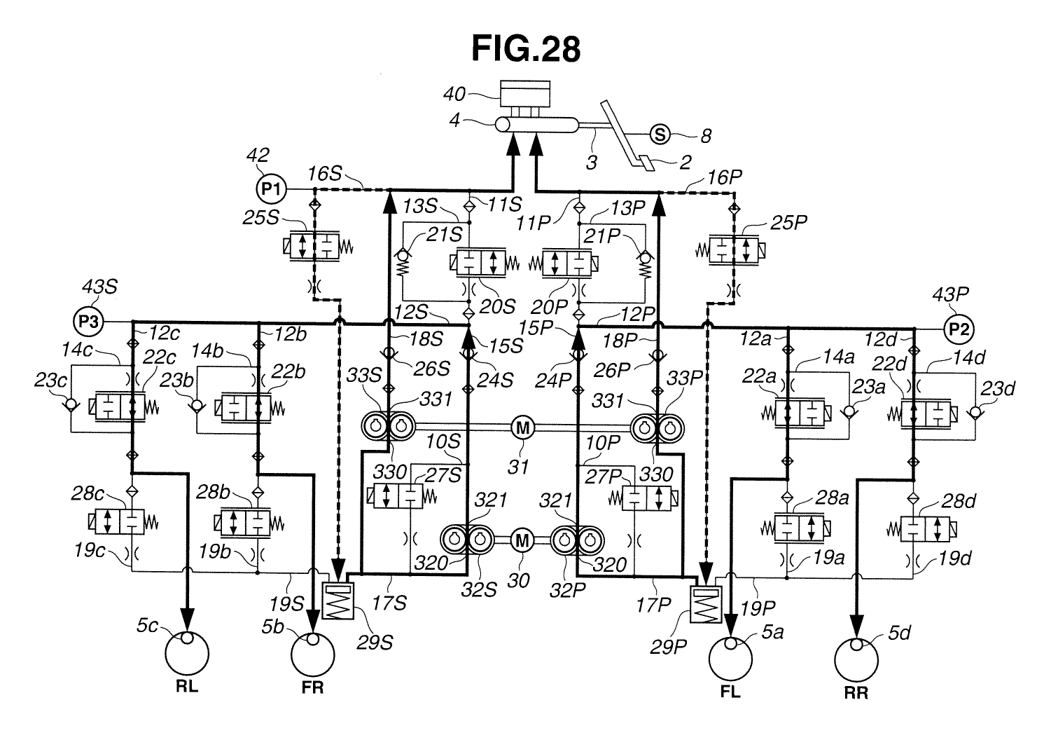

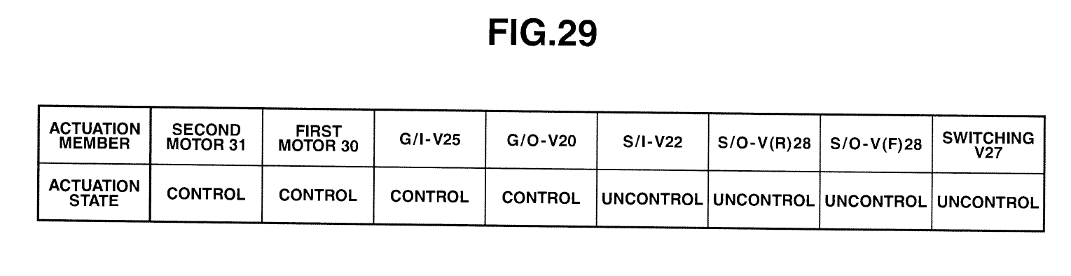

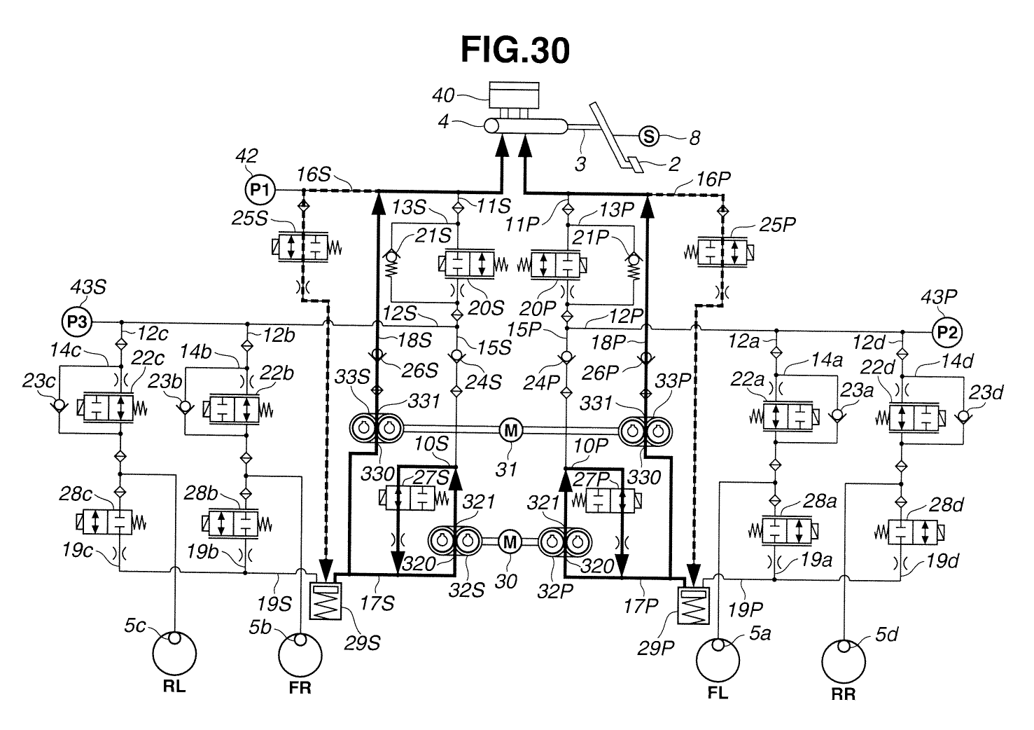

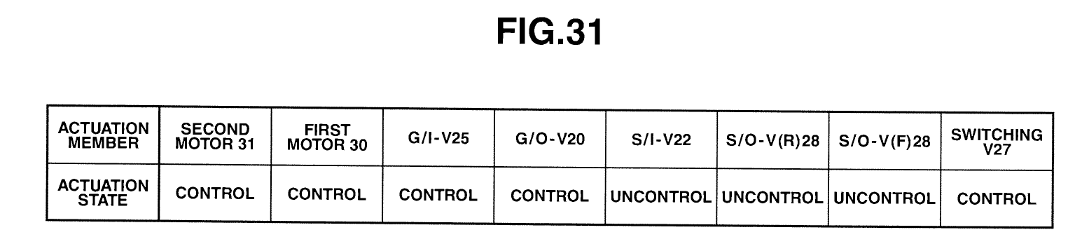

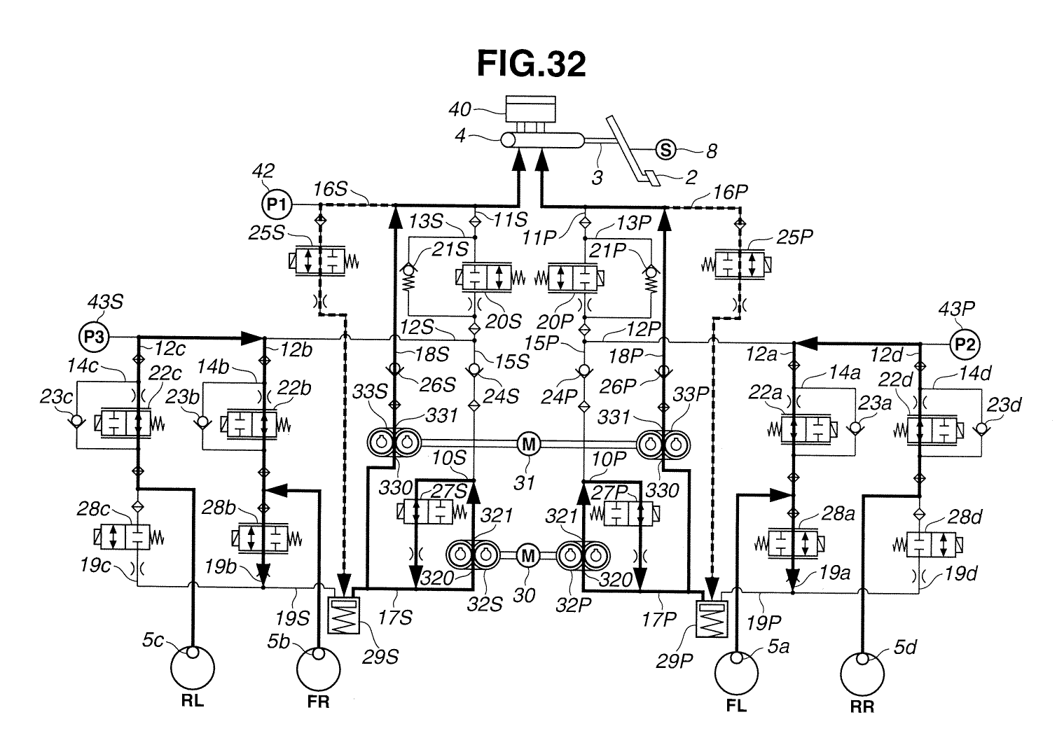

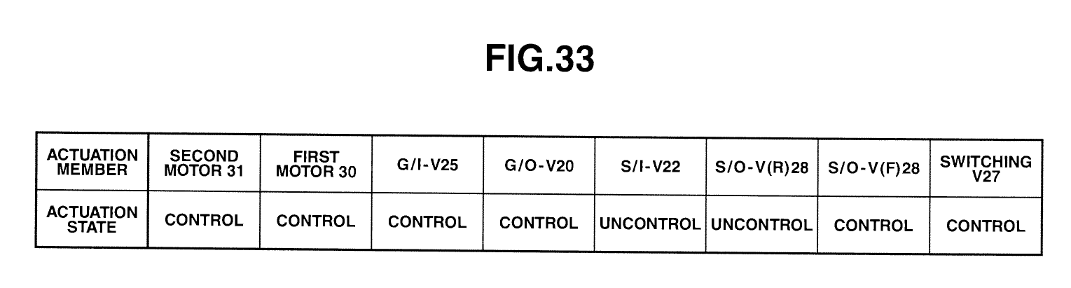

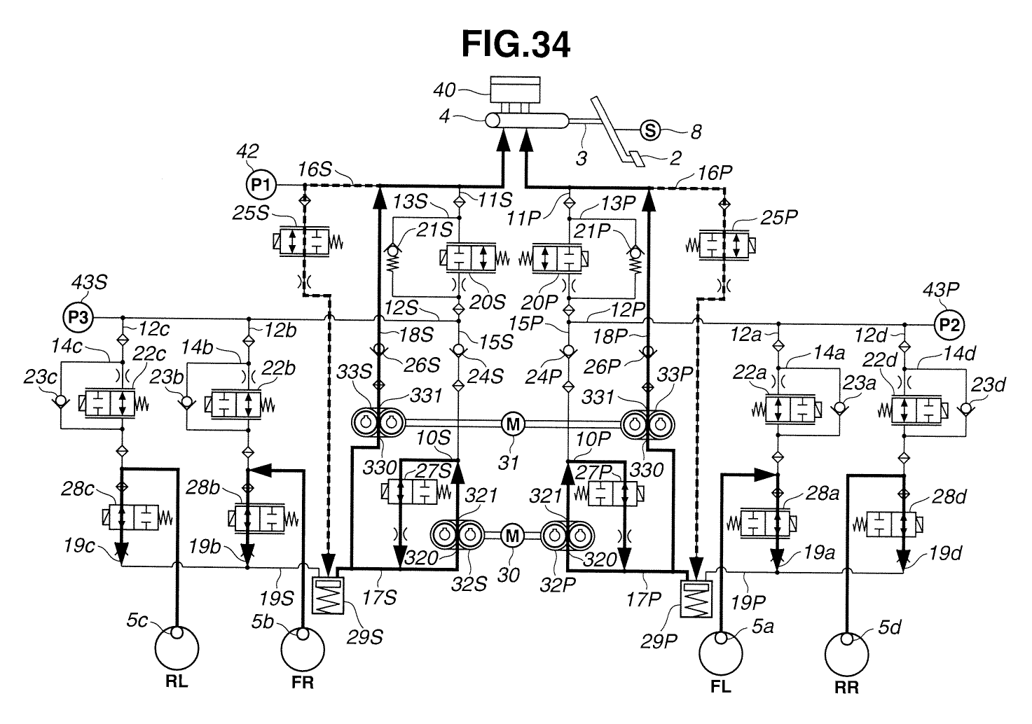

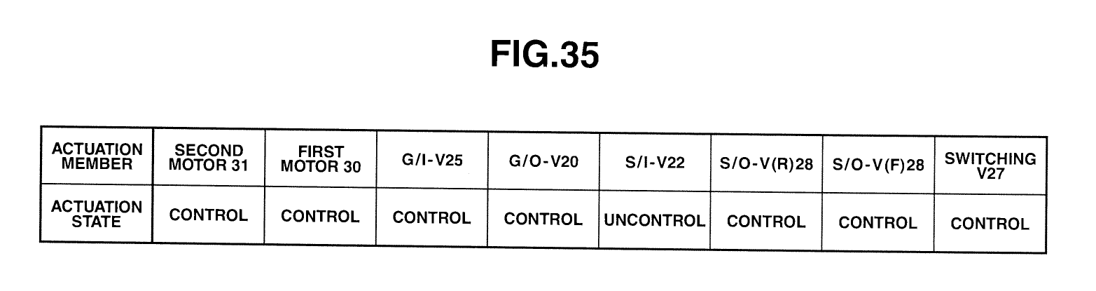

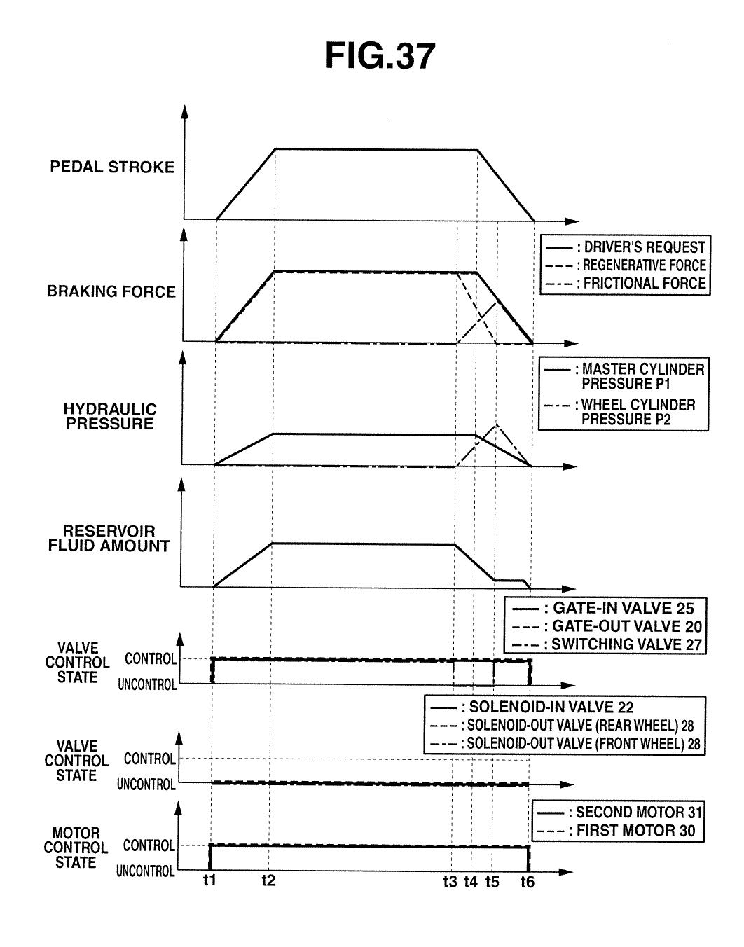

As described above, in the normal brake, the booster (first pump 32) pressurizes the brake fluid flowing from master cylinder 4 into hydraulic pressure control unit 6, in accordance with the operation of brake pedal 2, of the driver, and supplies this pressurized brake fluid to wheel cylinder 5. With this, the pressure difference between master cylinder pressure P1 and wheel cylinder pressure P2 is generated (P1<P2), so that the boosting function is attained. Moreover, it is possible to perform the pedal stroke by flowing the brake fluid from master cylinder 4 to reservoir 29, and thereby to attain the operation of the generation of the brake pedal depression force (the pedal reaction force) by recirculating (returning) the brake fluid within reservoir 29 to the master cylinder 4's side by the recirculating device (second pump 33).

[Regenerative Coordinated Control] FIG. 12, FIG. 14, FIG. 16, FIG. 18, FIG. 20, FIG. 22, FIG. 24, FIG. 26, FIG. 28, FIG. 30, FIG. 32, and FIG. 34 are hydraulic pressure circuit diagrams showing flows of the brake fluid at the regenerative coordinated control. FIG. 13, FIG. 15, FIG. 17, FIG. 19, FIG. 21, FIG. 23, FIG. 25, FIG. 27, FIG. 29, FIG. 31, FIG. 33, and FIG. 35 are tables showing the actuation states of the actuators at the regenerative coordinated control. FIG. 37-FIG. 43 are time charts at the regenerative coordinated control, in a state where pedal stroke S is held after the depression of brake pedal 2, and then the depression of brake pedal 2 is returned. In the first embodiment, in the regenerative coordinated control, solenoid-in valve 22 is not controlled (uncontrolled).

[Pedal Depression at Regenerative Coordinated Control] FIG. 12, FIG. 14, FIG. 16, and FIG. 18 show flows of the brake fluid at the pedal depression (at the increase of the driver's requested braking force) at the regenerative coordinated control.

### (Wheel Cylinder Pressure Increase)

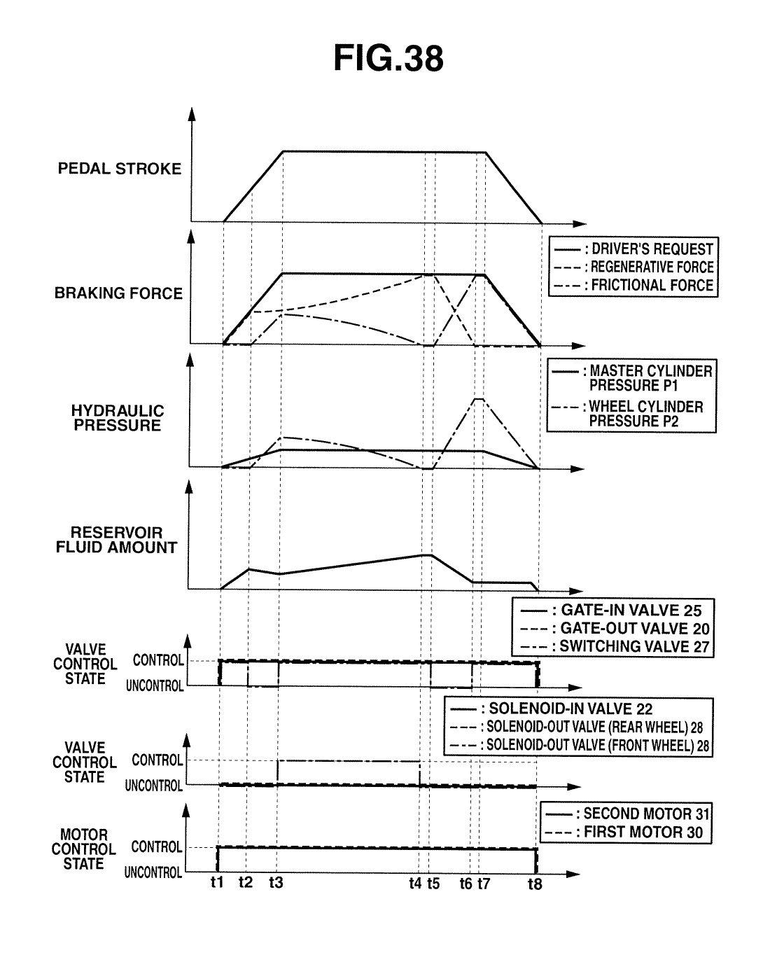

FIG. 12 shows a flow of the brake fluid at the increase of wheel cylinder pressure P2. FIG. 13 shows actuation states of the actuator in the state of FIG. 12. When the difference between the driver's requested braking force and the regenerative braking force is increased in a case where the regenerative braking force is increased, held, or decreased, wheel cylinder pressure P2 is increased so as to generate the frictional braking force to compensate for this difference between the driver's requested braking force and the regenerative braking force. For example, an interval from time t2 to time t3 in FIG. 38 shows a time chart when the amount of the increase (the increase gradient) of the driver's requested braking force is greater than the amount of the increase (the increase gradient) of the regenerative braking force. In this case, the controls of the actuators and the flows of the brake fluid are identical to those in FIG. 4 (at the pedal depression at the normal braking).

(Wheel Cylinder Pressure Holding) FIG. 14 shows a flow of the brake fluid at the holding of wheel cylinder pressure P2. FIG. 15 shows actuation states of the actuators in the state of FIG. 14. When the difference between the driver's requested braking force and the regenerative braking force is not varied, the frictional braking force to compensate for the difference between the driver's requested braking force and the regenerative braking force is not varied. Wheel cylinder pressure P2 is held. For example, an interval from time t1 to time t2 in FIG. 38 shows a time chart in which wheel cylinder pressure P2 is held to zero since the frictional braking force to compensate for the difference between the driver's requested braking force and the regenerative braking force is substantially zero since the regenerative braking force is increased by an value substantially identical to the driver's requested force. In this case, the controls of the actuators and the flows of the brake fluid are identical to those in FIG. 6 (at the holding of the pedal stroke in the normal brake). The brake fluid flows from master cylinder 4 into reservoir 29 in accordance with the increase of pedal stroke S since FIG. 14 shows the state at the pedal depression, only unlike the state in FIG. 6.

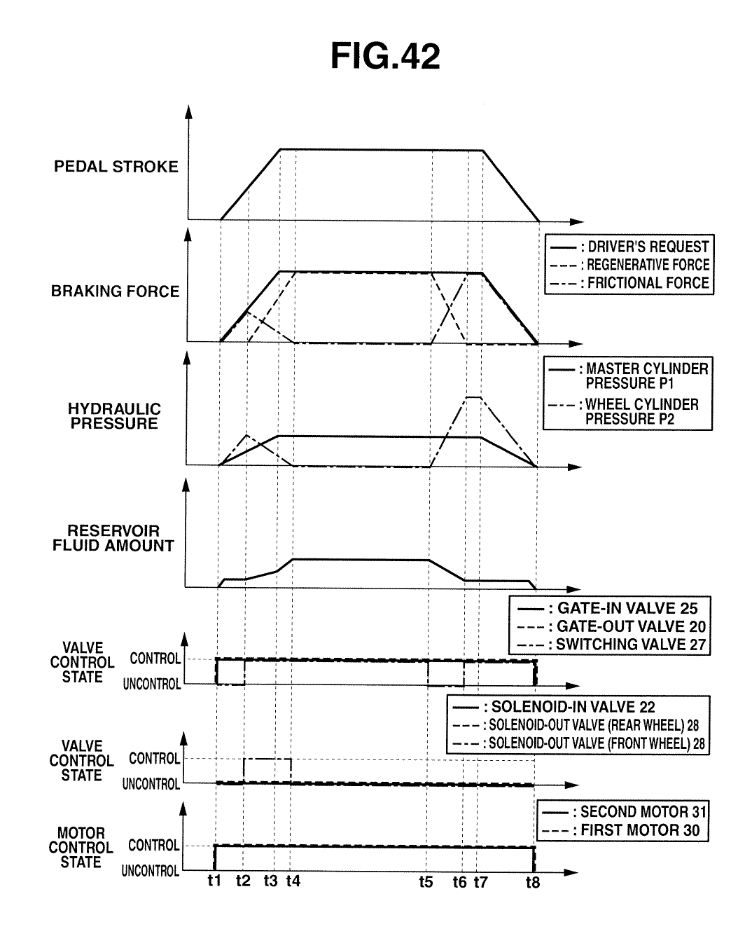

(Wheel Cylinder Pressure Decrease) FIG. 16 and FIG. 18 show flows of the brake fluid at the decrease of wheel cylinder pressure P2. When the amount of the increase (the increase gradient) of the regenerative braking force is greater than the amount of the increase (the increase gradient) of the driver's requested braking force, the frictional braking force to compensate for the difference between the driver's requested braking force and the regenerative braking force is decreased. Accordingly, wheel cylinder pressure P2 is decreased. FIG. 16 shows the flow of the brake fluid in a case where the pressure decrease gradient of wheel cylinder pressure P2 is small. FIG. 17 shows actuation states of the actuators in the state of FIG. 16. For example, an interval from time t2 to time t3 in FIG. 42 shows a time chart in the state of FIG. 16. Unlike the state in FIG. 14, solenoid-out valves 28a and 28b of front wheels FL and FR are controlled to be opened so that wheel cylinders 5a and 5b of front wheels FL and FR and reservoir 29 are connected to each other. The brake fluid from wheel cylinders 5a and 5b of front wheels FL and FR is discharged through the fourth brake circuit (pipes 19a and 19b) and solenoid-out valve 28 to reservoir 29. With this, wheel cylinder pressures P2 of front wheels FL and FR are decreased. Solenoid-out valves 28a and 28b can finely control the amount of the pressure decrease since solenoid-out valves 28a and 28b are proportional solenoid valves. The brake fluid from wheel cylinders 5c and 5d of rear wheels RL and RR is discharged through the first brake circuit (pipe 12) and the fourth brake circuit (pipes 19a and 19b) of front wheels FL and FR to reservoir 29. With this, the pressures of wheel cylinders P2 of rear wheels RL and RR are decreased. The other operations are identical to those in FIG. 14 (at the holding of the wheel cylinder pressure P2).

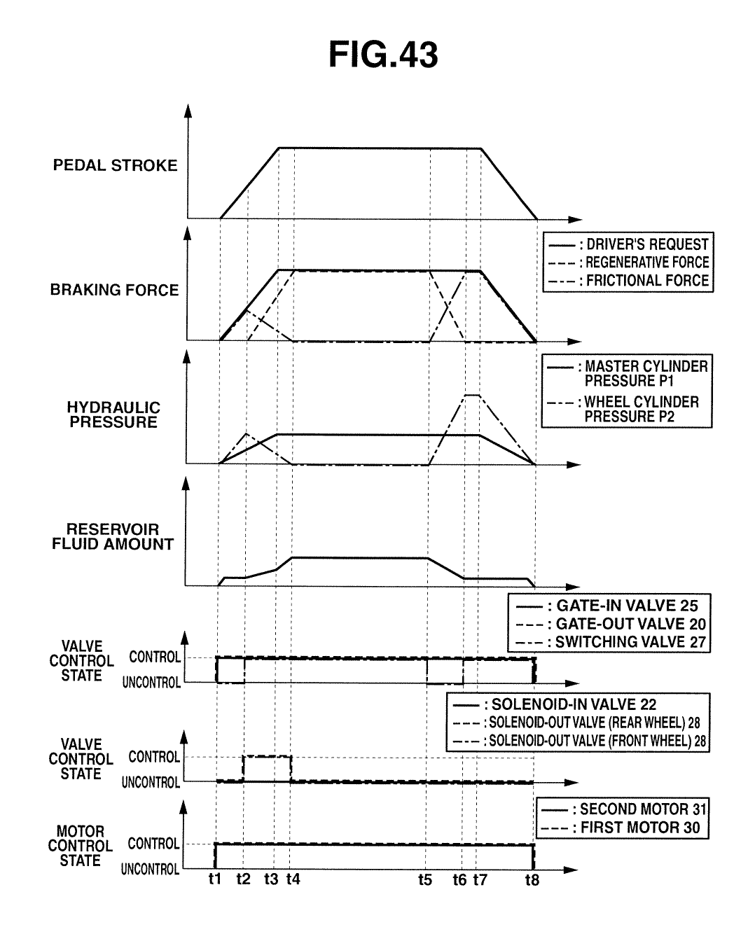

FIG. 18 shows a flow of the brake fluid when the pressure decrease gradient of wheel cylinder pressure P2 is large. FIG. 19 shows actuation states of the actuators in the state of FIG. 18. For example, an interval from time t2 to time t3 in FIG. 43 shows a time chart in the state of FIG. 18. Unlike the state in FIG. 16, solenoid-out valves 28c and 28d of rear wheels RL and RR are controlled to be opened in addition to solenoid-out valves 28a and 28b of front wheel FL and FR, so that wheel cylinders 5 of the front and rear wheels and reservoir 29 are connected to each other. The brake fluid from front wheel cylinders 5 of the front and rear wheels is discharged through the fourth brake circuit (pipe 19) and solenoid-out valve 28 to reservoir 29. With this, wheel cylinder pressures P2 of the front and rear wheels are decreased by the larger gradients. Other operations are identical to those in FIG. 16 (when the pressure decrease gradient of wheel cylinder pressure P2 is small).

[Pedal Stroke Holding at Regenerative Coordinated Control] FIG. 20, FIG. 22, FIG. 24, and FIG. 26 show flows of the brake fluid at the holding of the brake pedal stroke (at the holding of the driver's requested braking force) at the regenerative coordinated control.

### (Wheel Cylinder Pressure Increase)

FIG. 20 shows a flow of the brake fluid at the pressure increase of wheel cylinder P2. FIG. 21 shows actuation states of the actuators in the state of FIG. 20. In a case where the driver's requested braking force is held and the regenerative braking force is decreased, wheel cylinder pressure P2 is increased so as to generate the frictional braking force to compensate for the difference between the driver's requested braking force and the regenerative braking force. For example, an interval from time t5 to time t6 in FIG. 38 shows a time chart in the state of FIG. 20. The controls of the actuators and the flows of the brake fluid in this case are identical to those in FIG. 4 (at the depression of the pedal at the normal brake). The brake fluid is not transferred from master cylinder 4 to reservoir 29 due to the holding of the pedal stroke, only unlike the state in FIG. 4.

(Wheel Cylinder Pressure Holding) FIG. 22 shows a flow of the brake fluid at the holding of wheel cylinder pressure P2. FIG. 23 shows actuation states of the actuators in the state of FIG. 22. When the driver's requested braking force is held and the regenerative braking force is held, the frictional braking force to compensate for the difference between the driver's requested braking force and the regenerative braking force is not varied. Accordingly, wheel cylinder pressure P2 is held. For example, an interval from time t4 to time t5 in FIG. 38 shows a time chart in which wheel cylinder pressure P2 is held to zero since the frictional braking force to compensate for the difference between the driver's requested braking force and the regenerative braking force is zero since the regenerative braking force is held to the value identical to the driver's requested braking force. In this case, the controls of the actuators and the flows of the brake fluid are identical to those in FIG. 6 (at the holding of the pedal stroke at the normal brake).

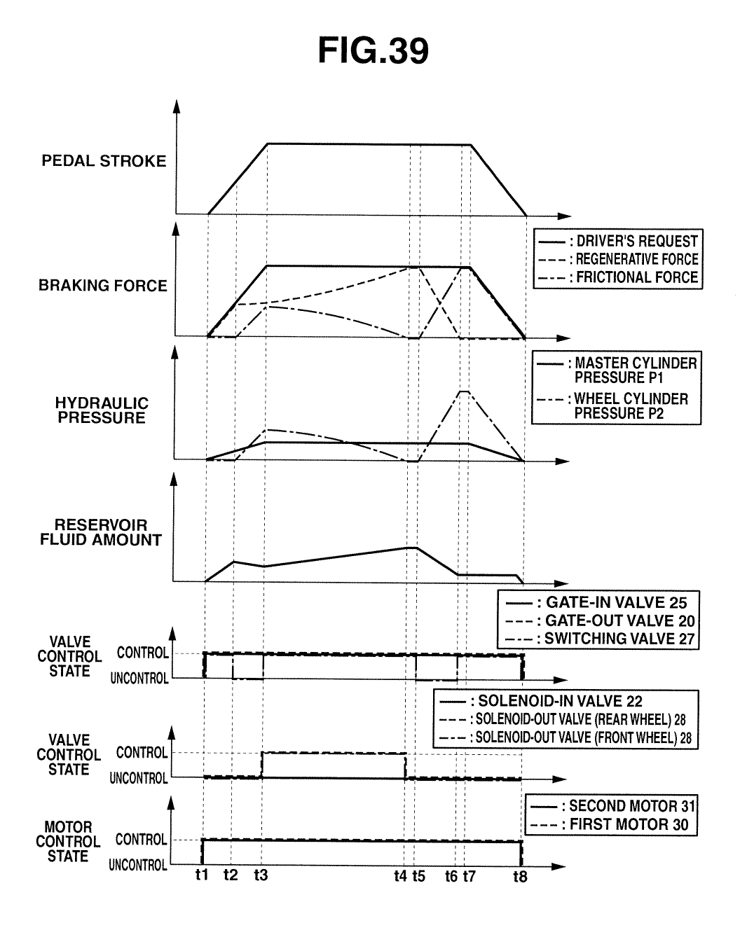

(Wheel Cylinder Pressure Decrease) FIG. 24 and FIG. 26 show flows of the brake fluid at the decrease of wheel cylinder pressure P2. When the driver's requested braking force is held and the regenerative braking force is increased, the frictional braking force to compensate for the difference between the driver's requested braking force and the regenerative braking force is decreased. Accordingly, wheel cylinder pressure P2 is decreased. FIG. 24 shows the flow of the brake fluid when the gradient of the pressure decrease of wheel cylinder pressure P2 is small. FIG. 25 shows actuation states of the actuators in the state of FIG. 24. An interval from time t3 to time t4 in FIG. 38 shows a time chart in the state of FIG. 24. The controls of the actuators are identical to those in FIG. 16 (when the gradient of the pressure decrease of the wheel cylinder pressure is small at the pedal depression). The brake fluid is not transferred from master cylinder 4 through the third brake circuit (pipe 16) to reservoir 29 due to the pedal stroke holding, only unlike the state in FIG. 16. FIG. 26 shows a flow of the brake fluid when the gradient of the pressure decrease of wheel cylinder pressure P2 is large. FIG. 27 shows actuation states of the actuators in the state of FIG. 26. For example, an interval from time t3 to time t4 in FIG. 39 shows a time chart in the state of FIG. 26. The controls of the actuators are identical to those in FIG. 18 (when the gradient of the pressure decrease of the wheel cylinder pressure is large at the pedal depression). The brake fluid is not transferred from master cylinder 4 through the third brake circuit (pipe 16) to reservoir 29 due to the pedal stroke holding, only unlike the state in FIG. 18.

[Pedal Depression Return at the Regenerative Coordinated Control] FIG. 28, FIG. 30, FIG. 32, and FIG. 34 show flows of the brake fluid at the pedal depression return (at the decrease of the driver's requested braking force) at the regenerative coordinated control. In these cases, the controls of the actuators are identical to those in FIG. 12, FIG. 14, FIG. 16, and FIG. 18 (at the pedal depression at the regenerative coordinated control). The flows of the brake fluid are different from the following points. That is, the brake fluid is not transmitted (supplied) from master cylinder 4 through the third brake circuit (pipe 16) to reservoir 29 due to the pedal depression return. Second pump 33 sucks the brake fluid stored in reservoir 29, discharge the sucked brake fluid to the recirculating circuit (pipe 18), and returns this brake fluid to master cylinder 4's side. Master cylinder pressure P1 is decreased in accordance with the decrease of pedal stroke S by controlling the valve opening degree of gate-in valve 25, and by controlling the rotational speed of second motor 31 (the discharge amount of second pump 33).

### (Wheel Cylinder Pressure Increase)

FIG. 28 shows a flow of the brake fluid at the pressure increase of wheel cylinder pressure P2. FIG. 29 shows actuation states of the actuators in the state of FIG. 28. When the amount of the decrease (the decrease gradient) of the regenerative braking force is larger than the amount of the decrease (the decrease gradient) of the driver's requested braking force, the frictional braking force to compensate for the difference between the driver's requested braking force and the regenerative braking force is increased. Accordingly, wheel cylinder pressure P2 is increased. For example, an interval time t4 to time t5 in FIG. 37 shows a time chart in the state of FIG. 28. In this case, the controls of the actuators are identical to those in FIG. 12 (at the pedal depression at the regenerative coordinated control).

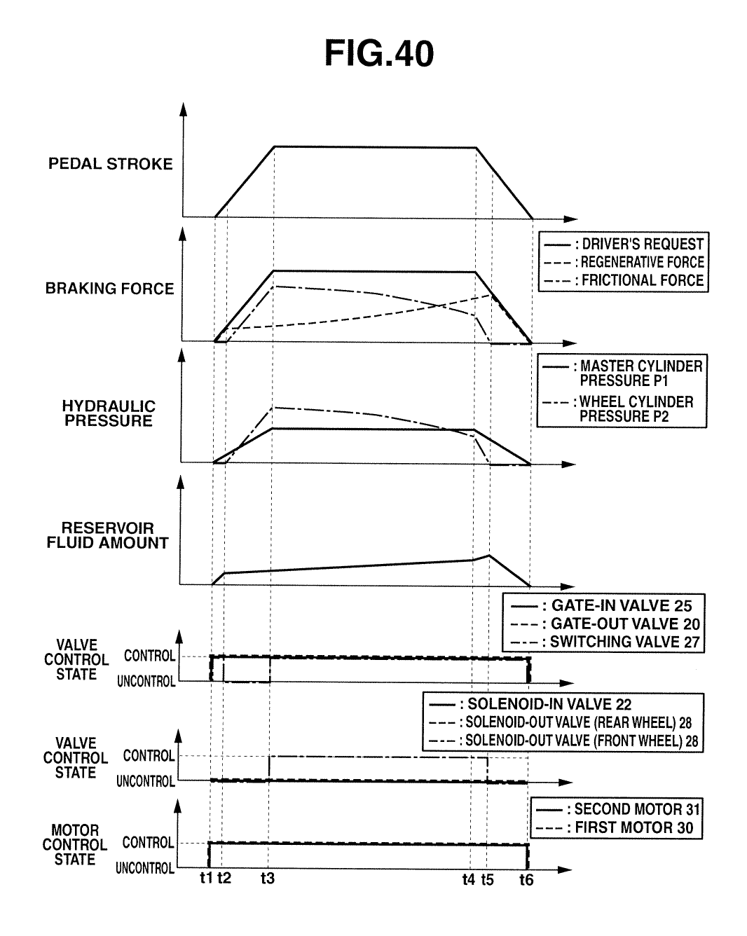

(Wheel Cylinder Pressure Holding) FIG. 30 shows a flow of the brake fluid at the holding of wheel cylinder pressure P2. FIG. 31 shows actuation states of the actuators in the state of FIG. 30. When the difference between the driver's requested braking force and the regenerative braking force is not varied, the frictional braking force to compensate for the difference between the driver's requested braking force and the regenerative braking force is not varied. Wheel cylinder pressure P2 is held. For example, an interval from time t5 to time t6 in FIG. 40 shows a time chart in which wheel cylinder pressure P2 is held to zero since the frictional braking force to compensate for the difference between the driver's requested braking force and the regenerative braking force is zero since the regenerative braking force is decreased by a value identical to the driver's requested braking force. In this case, the controls of the actuators are identical to those in FIG. 14 (at the depression of the pedal at the regenerative coordinated control).

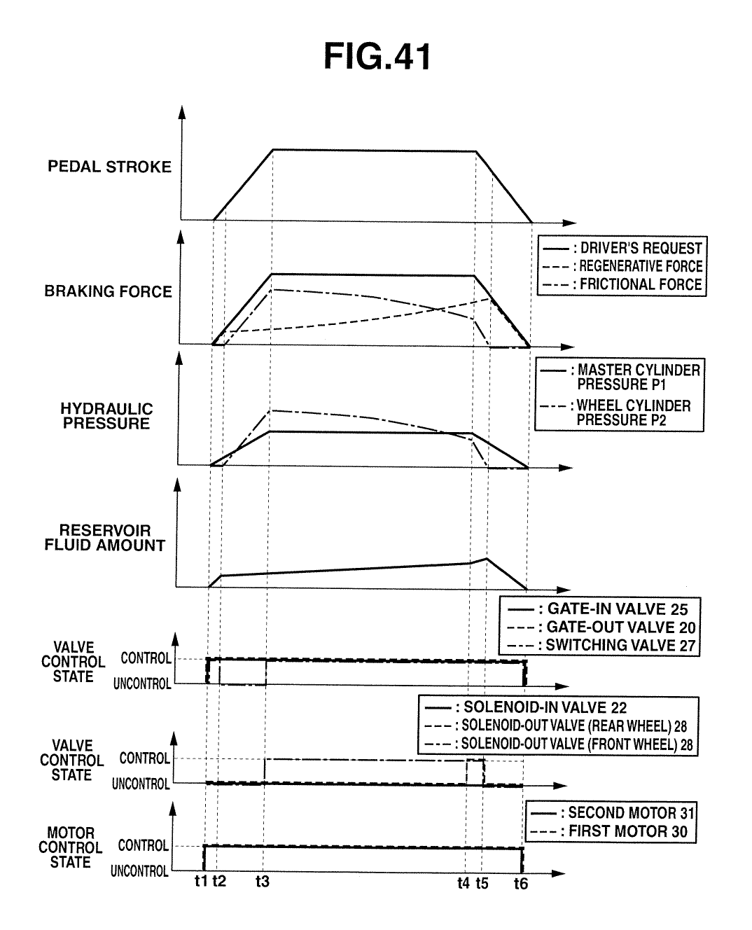

(Wheel Cylinder Pressure Decrease) FIG. 32 and FIG. 34 show flows of the brake fluid at the decrease of wheel cylinder pressure P2. When the difference between the regenerative braking force and the driver's requested braking force is decreased in a case where the driver's requested braking force is decreased and the regenerative braking force is increased, held, or decreased, the frictional braking force to compensate for the difference between the regenerative braking force and the driver's requested braking force is decreased. Accordingly, wheel cylinder pressure P2 is decreased. FIG. 32 shows a flow of the brake fluid when the gradient of the pressure decrease of wheel cylinder pressure P2 is small. FIG. 33 shows actuation states of the actuators in the state of FIG. 32. For example, an interval from time t4 to time t5 in FIG. 40 shows a time chart in the state of FIG. 32. In this case, the controls of the actuators are identical to those in FIG. 16 (at the pedal depression at the regenerative coordinated control). FIG. 34 shows a flow of the brake fluid when the gradient of the pressure decrease of wheel cylinder pressure P2 is large. FIG. 35 shows actuation states of the actuators in the state of FIG. 34. An interval from time t4 to time t5 in FIG. 41 shows a time chart in the state of FIG. 35. In this case, the controls of the actuators are identical to those in FIG. 18 (at the pedal depression at the regenerative coordinated control).

As described above, in the regenerative coordinated control, the booster (first pump 32) pressurizes the brake fluid, and supplies the pressurized brake fluid to wheel cylinder 5 to generate desired frictional braking force. Moreover, the brake fluid from master cylinder 4 flows into reservoir 29, and the brake fluid within reservoir 29 is recirculated by recirculating device (second pump 33) to the master cylinder 4's side. With this, the generation of brake pedal depression (pedal reaction force) is attained.

Next, a time chart at the regenerative coordinative control is illustrated.

### (Initial Full Regeneration)

FIG. 37 is a time chart in a case where the regenerative braking force is generated from an initial braking stage at which the driver depresses brake pedal 2, at the braking in a state where the vehicle speed is low. At the braking from the low speed, the regenerative braking force becomes a value substantially identical to the driver's requested braking force, from the initial stage of the pedal depression. The entire driver's requested braking force is compensated by the regenerative braking force (initial full regeneration).

In FIG. 37, in a time period from time t1 to time t2, the driver's requested braking force is increased by the depression of the brake pedal 2, and the regenerative braking force is increased by a value substantially identical to the driver's requested braking force, so that the frictional braking force is held to substantially zero. Accordingly, the actuators are controlled as shown in FIGS. 14 and 15. Gate-out valve 20 is controlled to be closed, and gate-in valve 25 is controlled to be opened, so that the brake fluid flowing from master cylinder 4 into wheel cylinder 5 is suppressed, and so that the brake fluid from master cylinder 4 flows into reservoir 29 so as to generate pedal stroke S. With this, the amount of the brake fluid within reservoir 29 is increased. First motor 30 is driven by the low rotational speed in preparation for the pressure increase of wheel cylinder pressure P2. Switching valve 27 is controlled to be opened so that the pressure increase of wheel cylinder pressure P2 by first pump 32 is suppressed. Wheel cylinder pressure P2 is held to substantially zero. The rotational speed of second motor 31 and the valve opening degree of gate-in valve 25 are controlled, so that master cylinder pressure P1 to keep a predetermined relationship (a predetermined brake pedal characteristic) with pedal stroke S, that is, the brake pedal depression force (the pedal reaction force) is generated. In particular, it is controlled so as to increase master cylinder pressure P1 in accordance with the increase of pedal stroke S.

In a time period from time t2 to time t3, pedal stroke S is held, and the driver's requested braking force is held. On the other hand, the regenerative braking force is held by a value identical to the driver's requested braking force. Accordingly, the frictional braking force is held to substantially zero. Consequently, the actuators are controlled as shown in FIGS. 22 and 23. Gate-in valve 20 is controlled to be closed, so that the brake fluid flowing from master cylinder 4 into wheel cylinder 5 is suppressed. First motor 30 is driven by the low rotational speed in preparation for the pressure increase. Switching valve 27 is controlled to be opened, so that the pressure increase of wheel cylinder pressure P2 by first pump 32 is suppressed. Wheel cylinder pressure P2 is held to substantially zero. Second motor 31 is driven and gate-in valve 25 is controlled to be opened, so that the brake fluid is recirculated through the recirculating circuit and the third brake circuit (pipe 16). With this, master cylinder pressure P1, that is, the brake pedal depression force (the pedal reaction force) is held to the substantially constant value. Accordingly, the amount of the brake fluid within reservoir 29 becomes the substantially constant amount.

In a time period from time t3 to time t4, pedal stroke S is held, and the driver's requested braking force is held. On the other hand, the regenerative braking force is decreased. Accordingly, the frictional braking force is increased. The actuators are controlled as shown in FIGS. 20 and 21. Gate-out valve 20 is controlled to be closed, so that the brake fluid flowing from master cylinder 4 into wheel cylinder 5 is suppressed. Switching valve 27 is not controlled (uncontrolled) to be closed and first motor 30 is driven, so that wheel cylinder pressure P2 is increased by first pump 32 by using the brake fluid within reservoir 29. With this, the amount of the brake fluid within reservoir 29 is decreased. Second motor 31 is driven and gate-in valve 25 is controlled to be opened, so that the brake fluid is recirculated through the recirculating circuit and the third brake circuit (pipe 16). With this, master cylinder pressure P1, that is, the brake pedal depression force (the pedal reaction force) is held to the substantially constant value.

In a time period from time t4 to time t5, pedal stroke S is decreased, and the driver's requested braking force is decreased. On the other hand, the decrease amount of the regenerative braking force is larger than the decrease amount of the driver's requested braking force. Accordingly, the frictional braking force is increased. The actuators are controlled as shown in FIGS. 28 and 29. Gate-out valve 20 is controlled to be closed so that the connection between master cylinder 4 and wheel cylinder 5 is shut off. Switching valve 27 is not controlled (uncontrolled) to be closed and first motor 30 is driven, so that wheel cylinder pressure P2 is increased by first pump 32 by using the brake fluid within reservoir 29. Second motor 31 is driven so as to return the brake fluid within reservoir 29 to the master cylinder 4's side, so that the decrease of pedal stroke S becomes possible. With this, the amount of the brake fluid within reservoir 29 is decreased. The rotational speed of second motor 31 and the valve opening degree of gate-in valve 25 are controlled so that master cylinder pressure P1 to keep the predetermined relationship (the predetermined brake pedal characteristic) with pedal stroke S, that is, the brake pedal depression force (the pedal reaction force) is generated. In particular, it is controlled so as to decrease master cylinder pressure P1 in accordance with the decrease of pedal stroke S.

In a time period from time t5 to time t6, pedal stroke S is decreased, so that driver's requested braking force is decreased. On the other hand, the regenerative braking force is substantially zero. Accordingly, the frictional braking force is decreased in accordance with the decrease of the driver's requested braking force in a state where the frictional braking force corresponds substantially to the driver's requested braking force. The actuators are controlled as shown in FIGS. 8 and 9. The valve opening degree of gate-out valve 20 is controlled, so that the brake fluid of wheel cylinder 5 is returned through the first brake circuit (pipes 12 and 11) to the master cylinder 4's side. With this, wheel cylinder pressure P2 is decreased. First motor 30 is driven by the low rotational speed in preparation for the pressure increase. Switching valve 27 is controlled to be opened, so that the supply of the discharge pressure of first pump 32 to the first brake circuit (pipes 11 and 12) is suppressed. Second motor 31 is driven and gate-in valve 25 is controlled to be opened, so that master cylinder pressure P1 to keep the predetermined relationship (the predetermined brake pedal characteristic) with pedal stroke S, that is, the brake pedal compression force (the pedal reaction force) is generated. In particular, it is controlled so as to decrease master cylinder pressure P1 in accordance with the decrease of pedal stroke S. The brake fluid is recirculated through the recirculating circuit and the third brake circuit (pipe 16). With this, the amount of the brake fluid becomes substantially constant amount. When pedal stroke S becomes zero at time t6, it is judged that the foot of the driver is fully removed from brake pedal 2. The actuations of the valves and motors 30 and 31 are stopped.

By the above-described operations, from the initial brake stage at which the driver starts to depress brake pedal 2, the driver's requested braking force is generated only by the regenerative braking force (time t1-t3). With this, it is possible to improve the energy recovery efficiency. Moreover, it is possible to perform the switching from the regenerative braking force to the frictional braking force at the pedal stroke holding and the pedal depression return (times t3-t5). Moreover, it is possible to generate the depression force (the pedal reaction force) according to the operation of brake pedal 2 by the driver at each time.

(Gradual Increase of Regeneration→Full Regeneration) FIGS. 38 and 39 are time charts in a case where the regenerative braking force is generated from the initial brake stage at the braking at the middle vehicle speed. At the braking from the middle vehicle speed, the regenerative braking force is increased by a value identical to the driver's requested braking force at the initial stage of the pedal depression, and then the regenerative braking force reaches the maximum regenerative braking force. Then, the (maximum) regenerative braking force is gradually increased by a value smaller than the driver's requested braking force, and the (maximum) regenerative braking force becomes the value identical to the driver's requested braking force again (the gradual increase of the regeneration→the full regeneration).

In FIGS. 38 and 39, the operations in a time period from time t1 to time t2 are identical to those in the time period from time t1 to time t2 in FIG. 37. In a time period from time t2 to time t3, the driver's requested braking force is increased by the depression of brake pedal 2, and the regenerative braking force is also gradually increased. On the other hand, the frictional braking force is increased due to the increase of the difference between the driver's requested braking force and the regenerative braking force. Accordingly, the actuators are controlled as shown in FIGS. 12 and 13. Gate-out valve 20 is controlled to be closed, and gate-in valve 25 is controlled to be opened, so that the brake fluid flowing from master cylinder 4 into wheel cylinder 5 is suppressed, and so that the brake fluid from master cylinder 4 flows into reservoir 29 so as to generate pedal stroke S. Switching valve 27 is not controlled (uncontrolled) to be closed and first motor 30 is driven, so that wheel cylinder pressure P2 is increased by first pump 32 by using the brake fluid within reservoir 29. With this, the amount of the brake fluid within reservoir 29 is slightly decreased. The rotational speed of second motor 31 and the valve opening degree of gate-in valve 25 are controlled so that master cylinder pressure P1 to keep a predetermined relationship (a predetermined brake pedal characteristic) with pedal stroke S, that is, the brake pedal depression force (the pedal reaction force) is generated. In particular, it is controlled so as to increase master cylinder pressure P1 in accordance with the increase of pedal stroke S.

In a time period from time t3 to time t4, pedal stroke S is held, and the driver's requested braking force is held. On the other hand, the regenerative braking force is gradually increased. Accordingly, the frictional braking force is gradually decreased. The actuators are controlled as shown in FIGS. 24 and 25. Gate-out valve 20 is controlled to be closed, so that the connection between master cylinder 4 and wheel cylinder 5 is shut off (closed). Solenoid-out valves 28 of the front wheels FL and FR are controlled to be opened, so that the brake fluid is discharged from wheel cylinders 5 of front wheels FL and FR to reservoir 29. With this, wheel cylinder pressures P2 of front wheels FL and FR are decreased. Wheel cylinder pressures P2 of rear wheels RL and RR are decreased by discharging the brake fluid from wheel cylinders 5 of rear wheels RL and RR through the fourth circuit (pipes 19a and 19b) to reservoir 29. With this, the amount of the brake fluid within reservoir 29 is increased. First motor 30 is driven by the low rotational speed in preparation for the pressure increase. Switching valve 27 is controlled to be opened, so that the pressure increase of wheel cylinder pressure P2 by first pump 32 is suppressed. Second motor 31 is driven and gate-in valve 25 is controlled to be opened, so that the brake fluid is recirculated through the recirculating circuit and the third brake circuit (pipe 16). With this, master cylinder pressure P1, that is, the brake pedal depression force (the pedal reaction force) is held to the substantially constant value.

In a time period from time t3 to time t4 in FIG. 39, the decrease gradient of the frictional braking force is larger than that in the time period from time t3 to time t4 in FIG. 38. Accordingly, the actuators are controlled as shown in FIGS. 26 and 27. Solenoid-out valves 28 of rear wheels RL and RR are controlled to be opened in addition to solenoid-out valves 28 of front wheels FL and FR, so that the cross section area of the discharge flow passages is increased. With this, wheel cylinder pressures P2 of the front and rear wheels are decreased by larger gradient.

In a time period from time t4 to time t5, the regenerative braking force is held to substantially correspond to the driver's requested braking force. Accordingly, the frictional braking force is held to substantially zero. These operations are identical to those in the time period from time t2 to time t3 in FIG. 37. In a time period from time t5 to time t6, the driver's requested braking force is held. On the other hand, the regenerative braking force is decreased. Accordingly, the frictional braking force is increased. These operations are identical to those in the time period from time t3 to time t4 in FIG. 37. In a time period from time t6 to time t7, the driver's requested braking force is held. On the other hand, the regenerative braking force becomes substantially zero. Accordingly, the frictional braking force is held to correspond to the driver's requested braking force. The actuators are controlled as shown in FIGS. 22 and 23. Gate-out valve 20 is controlled to be closed, so that the brake fluid flowing from wheel cylinder 5 to master cylinder 4 is suppressed. First motor 30 is driven by the low rotational speed in preparation for the pressure increase. In this case, switching valve 27 is controlled to be opened, so that the pressure increase of wheel cylinder pressure P2 by first pump 32 is suppressed. Wheel cylinder pressure P2 is held to the substantially constant value. Second motor 31 is driven and gate-in valve 25 is controlled to be opened, so that the brake fluid is recirculated through the recirculating circuit and the third brake circuit (pipe 16). With this, master cylinder pressure P1, that is, the brake pedal depression force (the pedal reaction force) is held to the constant value. Accordingly, the amount of the brake fluid within reservoir 29 becomes substantially constant value. The operations in a time period from time t7 to time t8 is identical to those in the time period from time t5 to time t6 in FIG. 37.

By the above-described operation, the regenerative braking force is generated from the initial stage of the braking. Moreover, the regenerative braking force is gradually increased from the middle of the pedal depression. Then, the regenerative braking force can be increased to the driver's requested braking force (time t1-time t5). Moreover, at the pedal stroke holding, it is possible to attain the switching from the frictional braking force to the regenerative braking force (time t3-time t4), and the switching from the frictional braking force to the regenerative braking force (time t5-time t6). Moreover, it is possible to generate the depression force (the pedal reaction force) according to the operation of brake pedal 2 of the driver at each time.

(Gradual Increase of Regeneration) FIGS. 40 and 41 are time charts in a case where the regenerative braking force is generated from the initial braking stage at the braking at the high vehicle speed. At the braking from (at) the high vehicle speed, the regenerative braking force is increased by the value identical to the driver's requested braking force at the initial stage of the pedal depression. Then, the regenerative braking force reaches the maximum regenerative braking force at a timing earlier than the braking at the middle vehicle speed (FIG. 38). Then, the (maximum) regenerative braking force is gradually increased by the value smaller than the driver's requested braking force (the gradual increase of the regeneration). In FIGS. 40 and 41, operations in a time period from time t1 to time t2 are identical to those in the time period from time t1 to time t2 in FIG. 38. Operations in a time period from time t2 to time t3 are identical to those in the time period from time t2 to time t3 in FIG. 38. Operations in a time period from time t3 to time t4 are identical to those in the time period from time t3 to time t4 in FIG. 38.

In a time period from time t4 to time t5, pedal stroke S is decreased, so that the driver's requested braking force is decreased. On the other hand, the regenerative braking force is gradually increased. A decrease amount (decrease gradient) of the driver's requested braking force is larger than the increase amount (increase gradient) of the regenerative braking force. That is, the difference between the driver's requested braking force and the regenerative braking force is decreased. Accordingly, the frictional braking force is decreased. The actuators are controlled as shown in FIGS. 32 and 33. Gate-out valve 20 is controlled to be closed, so that the brake fluid flowing from the master cylinder 4's side to wheel cylinder 5 is suppressed. Solenoid-out valves 28 of front wheels FL and FR are controlled to be opened, so that the brake fluid is discharged from wheel cylinders 5 of front wheels FL and FR to reservoir 29. With this, wheel cylinder pressures P2 of front wheels FL and FR are decreased. Wheel cylinder pressures P2 of rear wheels RL and RR are decreased by discharging the brake fluid from wheel cylinders 5 of rear wheels RL and RR through the fourth brake circuit (pipes 19a and 19b) of front wheels FL and FR to reservoir 29. With this, the amount of the brake fluid within reservoir 29 is increased. First motor 30 is driven by the low rotational speed in preparation for the pressure increase. Switching valve 27 is controlled to be opened, so that the pressure increase of wheel cylinder pressure P2 by first pump 32 is suppressed. Second motor 31 is driven so as to return the brake fluid within reservoir 29 to the master cylinder 4's side, so that the decrease of pedal stroke S becomes possible. The rotational speed of second motor 31 and the valve opening degree of gate-in valve 25 are controlled so that master cylinder pressure P1 to keep the predetermined relationship (the predetermined brake pedal characteristic) with pedal stroke S, that is, the brake pedal depression force (the pedal reaction force) is generated. In particular, it is controlled so as to decrease master cylinder pressure P1 in accordance with the decrease of pedal stroke S.

In a time period from time t4 to time t5 in FIG. 41, the decrease gradient of the frictional braking force is larger than that of the time period from time t4 to time t5 in FIG. 40. Accordingly, the actuators are controlled as shown in FIGS. 34 and 35. Solenoid-out valves 28 of rear wheels RL and RR are controlled to be opened in addition to solenoid-out valves 28 of front wheels FR and FR, so that wheel cylinder pressures P2 of the front and rear wheels are decreased by the larger gradient.

In a time period from time t5 to time t6, the driver's requested braking force is decreased by the decrease of pedal stroke S. On the other hand, the regenerative braking force is decreased to correspond to the driver's requested braking force. Accordingly, the frictional braking force is held to substantially zero. The actuators are controlled as shown in FIGS. 30 and 31. Gate-out valve 20 is controlled to be closed, so that the brake fluid flowing from the master cylinder 4's side to wheel cylinder 5 is suppressed. Moreover, second motor 31 is driven, so that the brake fluid flows from reservoir 29 into master cylinder 4. With this, (the decrease) of pedal stroke S is generated. With this, the amount of the brake fluid within reservoir 29 is decreased. First motor 30 is driven by the small rotational speed in preparation for the pressure increase. Switching valve 27 is controlled to be opened, so that the pressure increase of wheel cylinder pressure P2 by first pump 32 is suppressed. Wheel cylinder pressure P2 is held to substantially zero. Second motor 31 is driven so as to return the brake fluid within reservoir 29 to the master cylinder 4's side, so that the decrease of pedal stroke S becomes possible. The rotational speed of second motor 31 and the valve opening degree of gate-in valve 25 are controlled so that master cylinder pressure P1 to keep the predetermined relationship (the predetermined brake pedal characteristic) with pedal stroke S, that is, the brake pedal depression force (the pedal reaction force) is generated. In particular, it is controlled so as to decrease master cylinder pressure P1 in accordance with the decrease of pedal stroke S.

By the above-described operations, the regenerative braking force is generated from the initial stage of the braking. Moreover, it is possible to gradually increase the regenerative braking force from the middle of the depression of the pedal (time t1-time t5). Furthermore, it is possible to attain the switching from the frictional braking force to the regenerative braking force at the pedal stroke holding and at the pedal depression return (time t3-time t5). Moreover, it is possible to generate the depression force (the pedal reaction force) according to the operation of brake pedal 2 of the driver.

(Initial Full Charge→Regeneration) FIGS. 42 and 43 are time charts in a case where the frictional braking force is generated from the initial stage of the braking. The regenerative braking force is not generated due to, for example, the full charge at the initial stage of the pedal depression. The regenerative braking force is generated after pedal stroke S becomes the predetermined value. Then, the regenerative braking force is increased, and becomes a value identical to the driver's requested braking force (the initial full charge→the regeneration). In FIGS. 42 and 43, operations in a time period from time t1 to time t2 are identical to those in the time period from time t1 to time t2 in FIG. 36.

In a time period from time t2 to time t3, the driver's requested braking force is increased by the increase of the pedal stroke S. On the other hand, the regenerative braking force is increased. The increase amount (the increase gradient) of the regenerative braking force is larger than the increase amount (the increase gradient) of the driver's requested braking force. That is, the frictional braking force is decreased since the difference between the driver's requested braking force and the regenerative braking force is decreased. The actuators are controlled as shown in FIGS. 16 and 17. Gate-out valve 20 is controlled to be closed, so that the connection between master cylinder 4 and wheel cylinder 5 is shut off. Gate-in valve 25 is controlled to be opened, so that the brake fluid flows from master cylinder 4 into reservoir 29 in accordance with the increase of pedal stroke S. Solenoid-out valves 28 of front wheels FL and FR are controlled be opened, so that the brake fluid is discharged from wheel cylinders 5 of front wheels FL and FR to reservoir 29. With this, wheel cylinder pressures P2 of front wheels FL and FR are decreased. Wheel cylinder pressures P2 of rear wheels RL and RR are decreased by discharging the brake fluid from wheel cylinders 5 of rear wheels RL and RR through the fourth brake circuit (pipes 19a and 19b) of front wheels FL and FR to reservoir 29. With this, the amount of the brake fluid within reservoir 29 is increased. First motor 30 is driven by the low rotational speed in preparation for the pressure increase. Switching valve 27 is controlled to be opened, so that the pressure increase of wheel cylinders P2 by first pump 32 is suppressed. Second motor 31 is driven, so that the brake fluid within reservoir 29 is discharged to the master cylinder 4's side. The rotational speed of second motor 31 and the valve opening degree of gate-in valve 25 are controlled, so that master cylinder P1 to keep the predetermined relationship (the predetermined brake pedal characteristic) with pedal stroke S, that is, the brake pedal depression force (the pedal reaction force) is generated. In particular, it is controlled so as to increase master cylinder pressure P1 in accordance with the increase of pedal stroke S.

In a time period from time t2 to time t3 in FIG. 43, the decrease gradient of the frictional braking force is larger than that in the time period from time t2 to time t3 in FIG. 42. Accordingly, the actuators are controlled as shown in FIGS. 18 and 19. Solenoid-out valves 28 of rear wheels RL and RR are controlled to be opened, in addition to solenoid-out valves 28 of front wheels FL and FR, so that wheel cylinder pressures P2 of the front and rear wheels are decreased by the larger gradient.

In a time period from time t3 to time t4, pedal stroke S is held, so that the driver's requested braking force is held. On the other hand, the regenerative braking force is increased. Accordingly, the frictional braking force is decreased. The actuators are controlled by the manner identical to that in the time period from time t2 to time t3. Operations in a time period from time t4 to time t5 are identical to those in the time period from time t2 to time t3 in FIG. 37. Operations in a time period from time t5 to time t6 are identical to those in the time period from time t3 to time t4 in FIG. 37. Operations in a time period from time t6 to time t7 are identical to those in the time period from time t6 to time t7 in FIG. 38. Operations in a time period from time t7 to time t8 are identical to those in the time period from time t7 to time t8 in FIG. 38.

By the above-described operations, the regenerative braking force can be generated from zero from the middle of the pedal depression, and increased to the driver's requested braking force. With this, it is possible to improve the energy recovery efficiency (time t2-time t5). Moreover, it is possible to attain the switching from the frictional braking force to the regenerative braking force at the pedal depression and the pedal stroke holding (time t2-time t4), and to attain the switching from the regenerative braking force to the frictional braking force at the pedal stroke holding (time t5-time t6). Moreover, it is possible to generate the depression force (the pedal reaction force) in accordance with the operation of brake pedal 2 of the driver.

[Automatic Brake Control Intervention during Regenerative Coordinative Control] In the first embodiment, in a case where the braking forces of rear wheels RL and RR are held and wheel cylinder pressure P2 of front wheels FL and FR are increased in accordance with pedal stroke S, during the EBD control and before the ABS control intervention, wheel cylinder pressures P2 of rear wheels RL and RR are controlled by solenoid-in valves 22c and 22d while the brake fluid is discharged from reservoir 29 by first pump 32.

At the ABS control, the lock tendency of the wheel which is the controlled object of the ABS control is suppressed by the decrease of the regenerative braking force or the decrease of the frictional braking force. For example, wheel cylinder pressures P2 of wheels FL, RR, FL, and FR are controlled by solenoid-in valves 22a, 22d, 22c, and 22b, and solenoid-out valves 28a, 28d, 28c, and 28b while the brake fluid is discharged from reservoir 29 by first pump 32. The rotational speed of first motor 30 may be held to the high rotational speed for further improving the response at the pressure increase at the ABS control intervention.

At the brake assist control, the brake assist is achieved by the increase of the regenerative braking force and the increase of the frictional braking force. For example, wheel cylinder pressure P2 is controlled by solenoid-in valve 22 while the brake fluid is discharged from reservoir 29 by first pump 32. In consideration that wheel cylinder pressure P2 is increased until the wheel slippage at the brake assist intervention, the motor may continue to be driven by the high rotational speed. Gate-in valve 25 is arranged to actuate to supply the brake fluid to reservoir 29 when the sensed master cylinder pressure P1 is larger than the master cylinder which satisfies the predetermined relationship with pedal stroke S. However, gate-in valve 25 is controlled to supply the brake fluid in accordance with the amount of the hydraulic fluid necessary for the pressure increase in a case where the request braking force (BAS request braking force) of the brake assist control is larger than the driver's requested braking force.

[Relief Valve] In the above-described scenes, it is supposed that the pressure difference (P1−P2) between master cylinder pressure P1 and wheel cylinder pressure P2 is not greater than a setting pressure of relief valve 21 provided parallel to gate-out valve 20 ((P1−P2)<Pr). In the above-described scenes, when the pressure difference (P1−P2) becomes equal to or greater than the setting pressure of relief valve 21 ((P1−P2)≦Pr), the brake fluid is leaked from relief valve 21, and supplied to wheel cylinder 5. In case of P1>>P2, it is possible to consider (P1−P2) as P1. That is, when P1 is equal to or greater than Pr, the brake fluid having the pressure equal to or greater than the pressure Pr is supplied to wheel cylinder 5.

Next, the functions of the first embodiment are illustrated. Brake control apparatus 1 according to the first embodiment makes it possible to attain the booster function of the brake at the normal brake by diverting (utilizing) the conventional hydraulic pressure control unit provided to perform the automatic brake control by controlling the brake hydraulic pressures of wheels FL, FR, RL, and RR. That is, brake control apparatus 1 includes the first brake circuit connecting master cylinder 4 and wheel cylinder 5. Wheel cylinder 5 is arranged to receive master cylinder pressure P1 (in the open states of gate-out valve 20 and solenoid-in valve 22). Moreover, brake control apparatus 1 includes a booster arranged to increase the pressure of the brake fluid within master cylinder 4, and to supply (transmit) this pressurized fluid to wheel cylinder 5 through the second brake circuit connected to the first brake circuit. The booster includes first pump 32. The booster is arranged to increase wheel cylinder pressure P2 greater than master cylinder P1 by driving first pump 32, and thereby to attain the booster function of the brake. Accordingly, it is possible to omit a booster (for example, a negative pressure booster which uses the negative pressure generated by engine 100) which is arranged to amplify (boost) the depression force of brake pedal 2, and to transmit to master cylinder 4. The first pump 32 constituting the first and second brake circuits, and the booster is originally provided to the conventional hydraulic pressure control unit. Solenoid-in valve 22 is provided between the booster (first pump 32) and wheel cylinder 5 on the first brake circuit. Accordingly, it is possible to further accurately suppress wheel cylinder pressure P2 by controlling the actuation of solenoid-in valve 22. Furthermore, it is possible to hold wheel cylinder pressure P2 by closing solenoid-in valve 22.

Moreover, the brake control apparatus 1 diverts (utilizes) the conventional hydraulic pressure control unit, and performs the hydraulic pressure control. With this, it is possible to attain the regenerative coordinated control to compensate for the deficiency of the regenerative braking force with respect to the driver's requested braking force, with the frictional braking force. That is, the brake control apparatus 1 includes the third brake circuit which is bifurcated from the first brake circuit, and which is connected to the booster (first pump 32). Furthermore, the brake control apparatus 1 includes the fourth brake circuit connecting wheel cylinder 5 and reservoir 29. Brake control apparatus 1 supplies the brake fluid through the third brake circuit and the second brake circuit to wheel cylinder 5, and discharges the brake fluid from wheel cylinder 5 through the fourth brake circuit to reservoir 29. With this, it is possible to arbitrarily control to increase or decrease wheel cylinder pressure P2 independently of the brake pedal operation of the driver. With this, it is possible to generate the desired frictional braking force, and to attain the regenerative coordinated control. The third and fourth brake circuits and reservoir 29 are provided to the conventional hydraulic pressure control unit. Solenoid-out valve 28 is provided on the fourth brake circuit. Accordingly, it is possible to arbitrarily decrease wheel cylinder pressure P2 by controlling the actuation of solenoid-out valve 28. Moreover, it is possible to suppress the brake fluid from flowing from wheel cylinder 5 to reservoir 29 by closing solenoid-out valve 28, and thereby to hold wheel cylinder pressure 28.

Moreover, the brake control apparatus 1 includes reservoir 29 which is arranged to store the brake fluid, and which is provided on the third brake circuit. That is, reservoir 29 is connected to the third brake circuit, and the brake fluid can flows from the master cylinder through the third brake circuit to the reservoir 29. Accordingly, it is possible to improve the feeling of the brake operation. That is, for example, in the brake control apparatus in the patent document 1, it is not possible to flow the brake fluid from the master cylinder to the reservoir by the brake pedal operation of the driver. Accordingly, it is difficult to arbitrarily control the wheel cylinder pressure while providing the appropriate brake operation feeling. For example, when the regenerative coordinated control is performed while suppressing the increase of the wheel cylinder pressure of the amount of the regenerative braking force from the initial stage of the depression of the brake pedal, it is brought to a stiff brake pedal state in which the pedal stroke is not caused even when the brake pedal is depressed. The driver may feel the unnatural feeling. On the other hand, in the brake control apparatus according to the first embodiment, it is possible to flow the brake fluid from master cylinder 4 through the third brake circuit to reservoir 29 with respect to the brake pedal operation of the driver. Accordingly, it is possible to stroke brake pedal 2 in accordance with the brake pedal operation. Therefore, it is possible to improve the feeling of the brake operation. In this case, it is possible to avoid the brake fluid from flowing from master cylinder 4 into wheel cylinder 5. Moreover, it is possible to arbitrarily increase wheel cylinder pressure P2 by using the brake fluid flowing into reservoir 29. Therefore, it is possible to perform the regenerative coordinated control by suppressing the increase of the wheel cylinder pressure of the amount of the regenerative braking force, for example, from the initial stage of the depression of the brake pedal.

Moreover, gate-out valve 20 is provided on the first brake circuit. Gate-out valve 20 is arranged to switch the connection and the disconnection between the master cylinder 4's side and the wheel cylinder 5's side in the first brake circuit. The second brake circuit is connected to the first brake circuit on the wheel cylinder 5's side of gate-out valve 20 (the wheel cylinder line). The third brake circuit is connected to the first brake circuit on the master cylinder 4's side of gate-out valve 20 (the master cylinder line). Accordingly, it is possible to further readily perform the regenerative coordinated control while pedal stroke S is generated in accordance with the operation of the driver by shutting off the connection between the master cylinder line and the wheel cylinder line by closing gate-out valve 20. That is, at the depression of the pedal, the brake fluid flows from master cylinder 4 through the third brake circuit to reservoir 29 by the operation of the depression of brake pedal 2. With this, it is possible to ensure pedal stroke S. Moreover, the booster (first pump 32) can supply the brake fluid pressure only to wheel cylinder 5 (not to master cylinder 4) by using the brake fluid stored in reservoir 29. In this way, it is possible to separate the control of wheel cylinder pressure P2 (the frictional braking force) with respect to the brake operation of the driver by actuating gate-out valve 20, and thereby to facilitate to control wheel cylinder pressure P2 independently.

Gate-in valve 25 serving as the pressure difference generating section is provided on the third brake circuit connecting master cylinder 4 and reservoir 29. It is possible to generate the desired pressure difference between the master cylinder 4's side (the upstream side) and the reservoir 29's side (the downstream side) by controlling the leakage amount (throttling amount) to reservoir 29 by actuating gate-in valve 25 when the brake fluid flows from master cylinder 4 to reservoir 29. It is possible to attain the good pedal feeling with little unnatural feeling by controlling the pressure difference, that is, master cylinder pressure P1 (the pedal reaction force) by gate-in valve 25. In this way, in the brake control apparatus according to the first embodiment, reservoir 29 and gate-in valve 25 conventionally provided (to the conventional brake control apparatus) serve as the stroke simulator to generate the reaction force (the pedal reaction force) with respect to the brake pedal operation of the driver. With this, it is unnecessary to provide new (additional) stroke simulator. Moreover, it is optional to provide a throttling section (for example, a variable throttling valve, an orifice and so on) which partially decreases the cross sectional area of the third brake circuit, in place of gate-in valve 25.

In the regenerative coordinated control, it is necessary that pedal stroke S can decrease for generating the appropriate pedal feeling at the pedal depression return. Accordingly, it is necessary to control to return the brake fluid stored in reservoir 29 to master cylinder 4. For returning the brake fluid from reservoir 29 of the low pressure to master cylinder 4 of the relatively high pressure in which master cylinder pressure P1 is generated by the brake pedal operation, it is necessary that the brake fluid is positively recirculated against this gradient of the hydraulic pressure. In this case, it is important not to affect (vary) wheel cylinder pressure P2. For satisfying these requests, the brake control apparatus according to the first embodiment includes the recirculating apparatus arranged to recirculate the brake fluid stored in reservoir 29 to the first brake circuit's side (the master cylinder line). Accordingly, it is possible to attain the good pedal feeling while suppressing the variation of wheel cylinder pressure P2.

It is conceivable that, for example, the master cylinder 4's side (the master cylinder line) and the wheel cylinder 5's side (the wheel cylinder line) are connected (in particular, gate-out valve 20 is opened), and first pump 32 is actuated (operated) as the recirculating device, so as to return the brake fluid from reservoir 29 to master cylinder 4, in place of providing the recirculating device (second pump 33) in the first embodiment (cf. a third embodiment). However, in this case, it is necessary to control the connection state between the discharge side of first pump 32 and wheel cylinder 5 (that is, the amount of the brake fluid supplied to wheel cylinder 5) for suppressing the variation of wheel cylinder pressure P2. In particular, it is necessary to appropriately control the valve opening degree of the solenoid valve (solenoid-in valve 23 and so on) provided on the wheel cylinder line. Moreover, for generating the good pedal feeling (brake pedal depression force) while suppressing the variation of wheel cylinder pressure P2, that is, for generating master cylinder pressure P1 to keep the predetermined relationship (the predetermined brake pedal characteristic) with pedal stroke S at the pedal depression return, it is necessary to appropriately control the valve opening degree of the solenoid valve (solenoid-in valve 22 and so on) provided on the wheel cylinder line, the valve opening degree of gate-out valve 20 provided on the master cylinder line, and the discharge amount of first pump 32 (the rotational speed of first motor 30), so as to coordinate with each other. Accordingly, the hydraulic pressure control may be complicated due to the many number of the controlled objects (solenoid-in valve 22 and so on, gate-out valve 20, and first pump 32).

On the other hand, for recirculating the brake fluid stored in reservoir 29 to the first brake circuit side (the master cylinder line), the brake control apparatus 1 according to the first embodiment uses the newly provided recirculating device (second pump 33), in place of using first pump 32 and gate-out valve 20. That is, this recirculating device (second pump 33) returns the brake fluid stored in reservoir 29 to the master cylinder 4's side, without passing through the wheel cylinder line. Accordingly, it is possible to solve the above-described problems, and to further readily attain the good pedal feeling with little unnatural feeling. In particular, there is newly provided the recirculating circuit (pipe 18) connecting the master cylinder line of the first circuit, and reservoir 29. Moreover, the recirculating device (second pump 33) is newly provided in the recirculating circuit. The recirculating device can decrease pedal stroke S by returning the brake fluid from reservoir 29 through the recirculating circuit to the master cylinder 4's side. In this case, the recirculating circuit (pipe 18) is provided independently from the wheel cylinder line (pipe 12) of the first brake circuit and the second brake circuit (pipe 15). Accordingly, it is unnecessary to control first pump 32 for returning the brake fluid from reservoir 29 to the master cylinder 4's side. Moreover, it is unnecessary to control the connection state (the actuation of solenoid-in valve 22 and so on) between the discharge side of first pump 32 and wheel cylinder 5 for suppressing the variation of wheel cylinder pressure P2. Furthermore, it is unnecessary to control to coordinate the actuations of the solenoid-in valve 20 and so on, gate-out valve 20, and first pump 32 for generating the good pedal feeling (the brake pedal depression force) while suppressing the variation of wheel cylinder pressure P2. Accordingly, the number of the controlled objects for achieving the appropriate pedal feeling with little unnatural feeling while suppressing the variation of wheel cylinder pressure P2 is low. Moreover, it is possible to further readily perform the hydraulic pressure control.

Moreover, gate-in valve 25 is provided on the third brake circuit (pipe 16) between reservoir 29, and the connection point between the third brake circuit (pipe 16) and the recirculating circuit (pipe 18). Accordingly, it is possible to control the pressure difference between the reservoir 29's side and the return side of the brake fluid (the master cylinder 4's side) of the recirculating device (second pump 33) in the third brake circuit (pipe 16), that is, master cylinder pressure P1 (the pedal reaction force), to the desired value by controlling gate-in valve 25. Accordingly, it is possible to further surely attain the good pedal feeling with little unnatural feeling. Besides, in the brake control apparatus according to the first embodiment, the actuation of gate-in valve 25 is mainly controlled so as to generate master cylinder pressure P1 to keep the predetermined relationship (the predetermined brake pedal characteristic) with pedal stroke S at the pedal depression return during the regenerative coordinated control. The recirculating device (second pump 33) is arranged to supply the brake fluid to the master cylinder 4's side so as to assist the control of master cylinder pressure P1 by gate-in valve 25. However, it is optional to generate master cylinder pressure P1 to keep the predetermined brake pedal characteristic by not controlling the actuations of gate-in valve 25 finely (holding the constant valve opening degree), and by controlling the actuation of the recirculating device (the discharge amount of second pump 33).

Furthermore, the recirculating circuit (pipe 18) is provided independently of the third brake circuit (pipes 16 and 17). Accordingly, when the brake fluid stored in reservoir 29 is returned to the master cylinder 4's side (the master cylinder line), the recirculating circuit does not interfere with the actuation of gate-in valve 25 (the pressure difference generating function) in the third brake circuit. In particular, the end of the recirculating circuit (pipe 18) on the master cylinder 4's side is connected to pipe 16 on the master cylinder 4's side of gate-in valve 25. Besides, the end of the recirculating circuit (pipe 18) on the master cylinder 4's side may be connected to the first brake circuit (pipe 11) on the master cylinder 4's side of gate-out valve 20. Moreover, it is not limited that the end of the recirculating circuit (pipe 18) on the reservoir 29's side is connected to pipe 17 connecting first pump 32 and reservoir 29 in the third brake circuit. The end of the recirculating circuit (pipe 18) may be connected to pipe 16 connecting gate-in valve 25 and reservoir 29 in the third brake circuit, and may be connected to pipe 19 connecting solenoid-out valve 28 and reservoir 29 in the fourth brake circuit. Furthermore, the end of the recirculating circuit (pipe 18) on the reservoir 29's side may be connected directly to reservoir 29.

The recirculating device in the first embodiment includes second pump 33 arranged to be driven independently of first pump 32. Accordingly, it is possible to actuate the recirculating device (second pump 33) independently of the actuation of the booster (first pump 32). In particular, first motor 30 arranged to drive first pump 32, and second motor 31 arranged to drive second pump 33 are independently provided. Accordingly, it is possible to individually accurately control the discharge amount of first and second pumps 32 and 33 by controlling the rotational speeds of motors 30 and 31 respectively. That is, it is possible to improve the degree of freedom of the control of master cylinder pressure P1 and the control of wheel cylinder pressure P2. Moreover, required performances of first and second pumps 32 and 33 are different from each other in accordance with the intended purpose. In particular, first pump 32 needs a certain amount of the large discharge characteristic (performance) for satisfying the required performance to increase wheel cylinder pressure P2. Accordingly, it is necessary that the size of first motor 30 is increased to some extent. On the other hand, second pump 33 does not need the large discharge characteristic since it is sufficient to satisfy the required performances to control the variation of master cylinder pressure P1 with respect to the decrease of pedal stroke S. That is, it is possible to decrease the size of second motor 31 since the load of second motor 31 is small. Besides, in a case where hydraulic pressure control unit 6 includes the booster (first pump 32) and the conventional booster such as the negative pressure booster is omitted, like the first embodiment, master cylinder pressure P1 generated by the brake pedal operation of the driver becomes smaller than that of the conventional brake control apparatus with the booster. During the regenerative coordinated control, master cylinder pressure P1 is smaller than that of the conventional brake control apparatus with the booster. The variation of master cylinder pressure P1 at the pedal depression return is further decreased. Accordingly, in the brake control apparatus according to the first embodiment, it is possible to further decrease the size of second motor 31. In this way, by separately providing the motors of first and second pumps 32 and 33 which have the required performances, it is possible to increase efficiency of the energy necessary for driving first and second pumps 32 and 33 as a whole. Besides, the first and second pumps 32 and 33 may be driven by the common driving source.

The brake control apparatus 1 includes the brake operation state sensing section (brake pedal stroke sensor 8) arranged to sense the brake operation state of the driver, and the hydraulic pressure control device 70 arranged to control motors 30 and 31 (pumps 32 and 33), and the valves (gate-out valve 20 and so on) in accordance with the sensed brake operation state (the driver's requested braking force calculated based on the brake operation state), and the actuation state of the regenerative braking device (the magnitude of the regenerative braking force, and so on). In a case where the regenerative braking force is deficient with respect to the driver's requested braking force, hydraulic pressure control section 70 performs the hydraulic pressure control so as to generate the frictional braking force to compensate for this deficiency. With this, it is possible to perform the regenerative coordinated control, as described above. That is, it is possible to control the frictional braking force so that the sum of the regenerative braking force and the frictional braking force corresponds to the driver's requested braking force determined in accordance with the brake operation state. Accordingly, it is possible to attain the driver's requested braking force while improving the energy recovery efficiency. Besides, the control method of the actuators (for example, first motor 30) by hydraulic pressure control section 70 is not limited to the control method in the first embodiment. The actuations of the actuators may be controlled by other methods.

Hydraulic pressure control section 70 includes pedal depression force generating section 71 arranged to generate the brake pedal depression force by driving second pump 33 during the brake operation (the pedal depression return) of the driver. With this, it is possible to readily attain the good pedal feeling as described above. Besides, the control method of the actuators (for example, second motor 31) by the pedal depression force generating section 71 is not limited to the control method in the first embodiment. The actuations of the actuators may be controlled by other methods.

Hydraulic pressure control section 70 continues to drive first pump 32 and second pump 33 while the brake operation state sensing section senses the brake operation (the pedal depression, the pedal stroke holding, and the pedal depression return) by the driver, and performs the hydraulic pressure control by controlling the valves. Accordingly, it is possible to improve the response of the control. That is, it is essentially unnecessary to drive first pump 32 at the holding of wheel cylinder pressure P2 or at the decrease of wheel cylinder pressure P2. However, first pump 32 supplies the brake fluid to wheel cylinder 5, as described above. Accordingly, first pump 32 has the (certain) large size to some extent. First pump 32 needs the relatively large torque at the start of the driving of first pump 32. For example, when first pump 32 is driven from the stop state in a case where the switching from the regenerative braking force to the frictional braking force is needed during the holding or the decrease of wheel cylinder pressure P2, due to the decrease of the generable maximum regenerative braking force, the delay of the pressure increase of wheel cylinder pressure P2 is generated. The drop of the deceleration may be generated when the initial increasing (rising) speed of wheel cylinder pressure P2 is delayed with respect to the decrease speed of the regenerative braking force. On the other hand, in the brake control apparatus according to the first embodiment, first pump 32 continues to be constantly driven during the operation (depression) of brake pedal 2 by the driver, so as to hold the rotation of first pump 32. With this, it is possible to rapidly increase wheel cylinder pressure P2 by first pump 32 after the pressure increase command of wheel cylinder pressure P2. In this way, it is possible to improve the response of the switching from the regenerative braking force to the frictional braking force, by improving the response of the pressure increase of wheel cylinder pressure P2. Therefore, it is possible to suppress the drop of the deceleration. In particular, first motor 30 is driven by lowering the rotational speed in preparation for the pressure increase. It is possible to suppress the consumed power by setting the command rotational speed of first motor 30 to the lowest possible value (basic rotational speed) to keep the rotation.

However, in this case, the brake fluid may transmit from first pump 32 to wheel cylinder 5, irrespective of the holding or the decrease of wheel cylinder pressure P2. On the other hand, the brake control apparatus according to the first embodiment includes the connection passage (pipe 10) connecting the discharge side and the suction side of first pump 32, and switching valve 27 arranged to switch the connection and the disconnection of the connection passage. Accordingly, at the non-increase state of wheel cylinder pressure P2, the connection passage is connected by controlling switching valve 27 to be opened, and the brake fluid discharged by first pump 32 to the second brake circuit (pipe 15) is returned through the connection passage to the suction side of first pump 32. With this, it is possible to suppress the unintended pressure increase of wheel cylinder pressure P2 by the actuation of first pump 32. Switching valve 27 is a normally-closed solenoid valve arranged to connect the connection passage by the valve open actuation. Accordingly, switching valve 27 is actuated to be opened by the excitation only when the redundant brake fluid is generated at the driving of first pump 32. Therefore, it is possible to suppress the consumed power. Besides, it is not limited that the end of the connection passage (pipe 10) which is connected to the suction side of the first pump 32 is connected to pipe 17 connecting first pump 32 and reservoir 29 in the third brake circuit. The end of the connection passage (pipe 10) which is connected to the suction side of the first pump 32 may be connected to pipe 16 connecting gate-in valve 25 and reservoir 29 in the third brake circuit. The end of the connection passage (pipe 10) which is connected to the suction side of the first pump 32 may be connected to pipe 19 connecting solenoid-out valve 28 and reservoir 29 in the fourth brake circuit. Moreover, the end of the connection passage (pipe 10) which is connected to the suction side of the first pump 32 may be connected directly to reservoir 29.

Moreover, it is essentially unnecessary that second pump 33 is driven at the pedal depression or at the pedal stroke holding by the driver at the regenerative braking control, and at the normal braking (to return the brake fluid from wheel cylinder 5 through the first brake circuit to master cylinder 4 at the pedal depression return). However, in a case where second pump 33 is stopped in these cases, the return of the brake fluid is delayed when it becomes necessary to return the brake fluid to the master cylinder 4's side by second pump 33 at the depression return of brake pedal 2 (when the depression of brake pedal 2 is returned) at the regenerative coordinated control. In a case where the return speed of the brake fluid is delayed with respect to the speed of the depression return of brake pedal 2, the unnatural feeling of the pedal feeling may be caused. On the other hand, in the brake control apparatus according to the first embodiment, second pump 33 (second motor 31) continues to be constantly driven to keep the rotation of second pump 33 during the brake operation of the driver. Accordingly, it is possible to rapidly return the brake fluid to the master cylinder 4's side by second pump 33, after the pedal depression return at the regenerative coordinated control. Consequently, it is possible to further surely suppress the generation of the unnatural feeling of the pedal feeling, by improving the response of the control of pedal stroke S and master cylinder pressure P1 (the pedal reaction force). In particular, second motor 31 is driven by the constant rotational speed in preparation for the pedal depression return at the regenerative coordinated control even at the pedal depression or the pedal stroke holding by the driver at the normal braking or at the regenerative coordinated control. In the brake control apparatus according to the first embodiment, the above-described constant rotational speed (the basic rotational speed) is limitedly set, for example, to a rotational speed by which the brake fluid to decrease pedal stroke S at the depression return of brake pedal 2 at the predetermined speed by the driver at the regenerative coordinated control can be supplied to the master cylinder 4's side. With this, it is possible to further surely suppress the generation of the unnatural feeling of the pedal feeling, and to suppress the consumed power.

Furthermore, the brake control apparatus includes the connection passage (pipe 18 and the third brake circuit serving as the recirculating circuit) connecting the discharge side and the suction side (or reservoir 29) of second pump 29. Gate-in valve 25 is provided on this connection passage. Accordingly, the brake fluid discharged by second pump 33 to the recirculating circuit (pipe 18) is returned through the connection passage (pipe 16-18) to the suction side (or reservoir 29) of second pump 33 by controlling gate-in valve 25 to be opened, at the pedal depression or the pedal depression holding of the driver at the normal braking or at the regenerative coordinated control. With this, it is possible to suppress the unintended variation of master cylinder P1 (the brake depression force) by second pump 33. The problem of the response delay of second pump 33 is hardly generated in a case where the brake fluid is returned from wheel cylinder 5 to master cylinder 4 at the depression return of brake pedal 2 (for example, the time period from time t5 to time t6 in FIG. 37, and the time period from time t1 to time t2 in FIG. 42) due to the reason that the regenerative braking force is not generated. Accordingly, in this case, second pump 33 may not be driven so as to be brought to the stop state.

In the brake control apparatus according to the first embodiment, relief valve 21 arranged to allow the flow of the brake fluid from master cylinder 4 is provided parallel to gate-out valve 20. The valve opening pressure Pr of relief valve 21 is set to the brake hydraulic pressure corresponding to the maximum deceleration degree which can be generated by the regenerative braking device (the corresponding value of the hydraulic pressure of the maximum regenerative braking force limit value). Accordingly, when the first brake circuit is shut off by closing gate-out valve 20 in a case where the driver's requested braking force is satisfied by the regenerative braking force (smaller than the maximum regenerative braking force), it is possible to suppress the generation of the frictional braking force by flowing the brake hydraulic pressure generated in master cylinder 4, through relieve valve 21 to wheel cylinder 5. With this, it is possible to improve the energy recovery efficiency. On the other hand, when the driver's requested braking force is not satisfied by the maximum regenerative braking force, relief valve 21 is opened, so that the brake hydraulic pressure generated in master cylinder 4 bypasses gate-out valve 20, and flows into the wheel cylinder 5. Accordingly, it is possible to promptly increase the wheel cylinder pressure P2 by using the master cylinder pressure P1 of the high pressure. For example, when the driver's requested braking force becomes equal to or greater than the maximum regenerative braking force limit value in a case where the frictional braking force is not generated (wheel cylinder pressure P2 is substantially zero) so as to compensate for the driver's requested braking force only by the regenerative braking force, master cylinder pressure P1 generated in accordance with the driver's requested braking force becomes equal to or greater than valve opening pressure Pr. In this case, relief valve 21 is opened, the brake hydraulic pressure generated in master cylinder 4 is supplied to wheel cylinder 5, so that the frictional braking force of the amount of the difference between the driver's requested braking force and the maximum regenerative braking force limit value (by which the driver's requested braking force is greater than the maximum regenerative braking force limit value) is generated. In this way, even when the regenerative braking force reaches the limit value, relief valve 21 is opened so that the frictional braking force is automatically generated so as to compensate for the deficient of the driver's requested braking force. Accordingly, it is possible to rapidly generate the driver's requested braking force before the pressure increase control of wheel cylinder pressure P2 by first pump 32.

Pumps 32 and 33, the valves, and the brake circuits are provided, respectively, to the first system (P-system) constituted by a first predetermined wheel group (set) of the vehicle, and the second system (S-system) constituted by a second predetermined wheel group (set) of the vehicle. Accordingly, it is possible to suppress the simultaneous malfunction of the first system and the second system. Moreover, even when one of the systems becomes the malfunction, wheel cylinder pressures P2 of the two wheels can be controlled by using the other of the systems. On the other hand, first motor 30 and second motor 31 are commonly provided to be shared by the corresponding pumps (each first pump 32 and each second pump 33) provided to each of the systems. Accordingly, it is possible to decrease the number of the motor, and to decrease the size of the brake control apparatus, relative to a case in which the motors are individually provided for the P-system and the S-system.

Effects of First Embodiment

In the embodiment of the present invention, a brake control apparatus for a vehicle provided with a regenerative braking device, the brake control apparatus includes: a first brake circuit (11, 12) connecting a master cylinder (4) configured to generate a brake hydraulic pressure by a brake operation of a driver, and a wheel cylinder (5) to which the brake hydraulic pressure is applied; a booster (32) configured to increase a pressure of a brake fluid within the master cylinder (4), and to transmit the pressurized brake fluid to the wheel cylinder (5) through a second brake circuit (15) connected with the first brake circuit (11, 12); a third brake circuit (16, 17) bifurcated from the first brake circuit (11, 12), and connected with the booster (32); a reservoir (29) provided on the third brake circuit (16, 17); and a recirculating device (33) configured to recirculate the brake fluid stored in the reservoir (29), to the first brake circuit (11, 12)'s side.

Accordingly, in the regenerative coordinated control, it is possible to improve the pedal feeling at the pedal depression return.

The brake control apparatus further includes a recirculating circuit (18) bifurcated from a portion (17) of the third brake circuit between a suction side of the first pump (32) and the reservoir (29), and connected to a portion (16) of the third brake circuit (16, 17) between the reservoir (29) and a portion on a downstream side of the bifurcating point between the third brake circuit (16, 17) and the first brake circuit (11); and the recirculating device (33) is provided on the recirculating circuit (18).

Accordingly, it is possible to further readily attain the pedal feeling with little unnatural feeling while suppressing the variation of wheel cylinder pressure P2 at the pedal depression return at the regenerative coordinated control.

The brake control apparatus further includes a gate-in valve (25) provided on the third brake circuit (16) between reservoir (29) and a connection point between the third brake circuit (16) and the recirculating circuit (18).

Accordingly, it is possible to further surely attain the good pedal feeling with little unnatural feeling by actuating gate-in valve 25.

The brake control apparatus further includes a gate-out valve provided on the first brake circuit between the connection point between the first brake circuit and the second brake circuit, and the bifurcating point between the first brake circuit and the third brake circuit.

Accordingly, it is possible to further readily attain the regenerative coordinated control by actuating gate-out valve 20.

The booster includes a first pump (32); the recirculating device includes a second pump (33); and the first pump (32) and the second pump (33) are arranged to be independently driven.

Accordingly, it is possible to improve the degree of the freedom of the control, and the control performance.

The brake control apparatus further includes a relief valve (21) provided parallel to the gate-out valve (20), and arranged to allow the flow of the brake fluid from the master cylinder (4); and the relief valve (21) has a valve opening pressure corresponding to a brake hydraulic pressure corresponding to a maximum deceleration generated by the regenerative braking device.

Accordingly, it is possible to rapidly generate the driver's requested braking force by opening relief valve 21 even when the regenerative braking force reaches the limit value.

The brake control apparatus further includes a first motor (30) arranged to drive the first pump (32), and a second motor (31) arranged to drive the second pump (33).

Accordingly, it is possible to improve the efficiency of the energy necessary for driving first and second pumps 32 and 33 as a whole.

The brake control apparatus further includes an in valve (22) provided on the first brake circuit (11, 12) between the wheel cylinder (5) and the first pump (32), and an out valve (28) provided on a fourth brake circuit (19) connecting the wheel cylinder (5) and the reservoir (29).

Accordingly, it is possible to further accurately control wheel cylinder pressure P2.

The brake control apparatus further includes a connection passage (10) connecting a discharge side and a suction side of the first pump (32); and the brake control apparatus further includes a switching valve (27) provided on the connection passage (10).

Accordingly, it is possible to suppress the unintended pressure increase of wheel cylinder pressure P2 by the actuation of first pump 32, and to improve the degree of the freedom of the control.

The brake control apparatus further includes a brake operation state sensing section (8) configured to sense a brake operation state of the driver, and a hydraulic pressure control section (70) configured to control the motor(s) (30, 31) and the valves in accordance with the sensed brake operation state and the actuation state of the regenerative braking device.

Accordingly, it is possible to generate the frictional braking force so as to compensate for the deficiency of the regenerative braking force with respect to the driver's requested braking force, and thereby to improve the energy recovery efficiency while attaining (satisfying) the driver's requested braking force.

The hydraulic pressure control section (70) includes a pedal depression generating section (71) configured to drive the second pump (33) during the brake operation of the driver, and thereby to generate a depression force of the brake pedal.

Accordingly, it is possible to readily attain the good pedal feeling.

The hydraulic pressure control section (70) is configured to continue to drive the first and second pumps (32, 33) while the brake operation state sensing section (8) senses the brake operation of the driver, and to control the valves to perform the hydraulic pressure control.

Accordingly, it is possible to improve the response of the switching from the regenerative braking force to the frictional braking force, and to further surely suppress the generation of the unnatural feeling of the pedal.

### Second Embodiment

In a brake control apparatus according to a second embodiment of the present invention, gate-in valve 25, recirculating device (second pump 33), and the recirculating circuit (pipe 18) are provided only to one of the two systems (the P system and the S system) of the piping structures of hydraulic pressure control unit 6, for example, only to the S system, unlike the brake control apparatus according to the first embodiment.

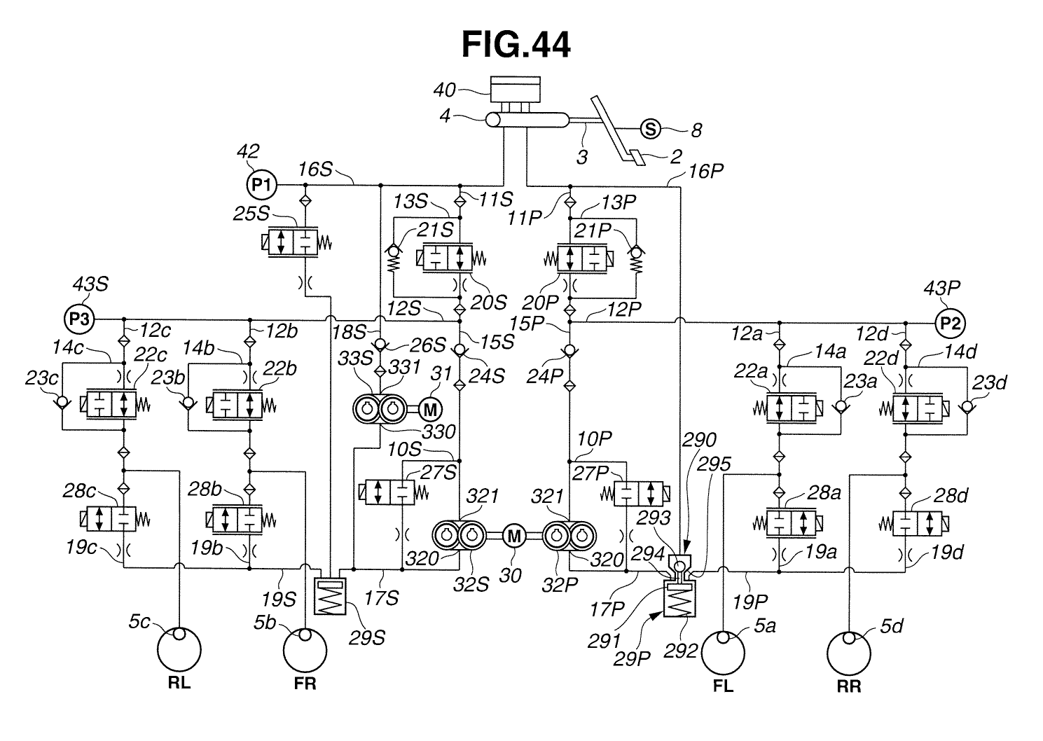

First, a structure of the brake control apparatus according to the second embodiment is illustrated. FIG. 44 is a circuit diagram showing a hydraulic pressure control apparatus according to the second embodiment. A structure of the S system is identical to that of the brake control apparatus according to the first embodiment. Pipe 18 and second pump 33 are not provided in the P-system. Second motor 31 drives only second pump 33S of the S-system. Gate-in valve 25 is not provided on the third brake circuit (pipe 16) of the P-system. Reservoir 29P of the P-system is provided integrally with a check valve 290 serving as a pressure regulating valve. That is, reservoir 29P has a pressure regulating function. Accordingly, check valve 290 is mechanically closed when a predetermined amount of the brake fluid is stored in reservoir 29P, so as to shut off the connection between the suction side (pipe 17) and the master cylinder 4's side (pipe 16) of first pump 32. When master cylinder pressure P1 is not supplied from pipe 16P, a piston 291 of reservoir 29P is urged by a spring 292, and raises (pushes up) a ball member 293 of check valve 290 through a rod 294 (against a force of a return spring of the check valve). Consequently, ball member 293 is separated (unseated) from a seat portion 295, so that check valve 290 is brought to a valve open state. In this case, master cylinder 4 (pipe 16P) is connected through reservoir 29P to the suction side of first pump 32, and connected to solenoid-out valve 28.

When master cylinder pressure P1 is supplied from pipe 16P, check valve 290 is brought from the valve open state to the valve closed state, so that the connection between master cylinder 4 and reservoir 29P is shut off. In particular, a symbol F represents an urging force of spring 292 (a value obtained by subtracting the urging force of the return spring of the check valve), and a symbol S1 represents a pressure receiving area of piston 291. When expression P1×S1>F is satisfied, piston 291 is moved in a direction to compress spring 292, so that ball member 293 is moved toward seat portion 295. When master cylinder pressure P1 is equal to or greater than a predetermined value, ball member 293 is seated on seat portion 295, so that the brake fluid does not flow between pipe 16P and reservoir 29P. When the brake fluid within wheel cylinders 5a and 5b flows through pipe 19P into reservoir 29P, piston 291 is moved in the direction to compress spring 292, so that a volume of reservoir 29P is increased, and that the brake fluid is stored in reservoir 29P.

When first pump 32P is actuated, the brake fluid stored in reservoir 29P is sucked through pipe 17P, and returned to the first brake circuit's side. In this case, even when check valve 290 is closed by master cylinder pressure P1 from pipe 16P, the pressure within reservoir 29 is decreased by the suction by first pump 32P, so that check valve 20 is opened. In particular, when first pump 32P is actuated in the valve open state of check valve 290, the pressure on the pipe 16P's side of ball member 293 is master cylinder pressure P1. The pressure on the reservoir 29's side of ball member 293 becomes Ps=F/S1. Accordingly, pressure Ps on the suction side of first pump 32P does not become equal to or greater than F/S1 in the valve closed state of check valve 290, so that the pressure acted to the suction side of first pump 32P is held to be equal to or smaller than a predetermined pressure. In this state, when first pump 32P sucks the brake fluid within reservoir 29P, pressure Ps is lowered, so that piston 291 is pressed toward the side of ball member 293 by urging force of spring 292. In this case, a symbol S2 represents a diameter of the hydraulic passage of check valve 290 (a valve seat diameter), that is, a cross sectional area of the hydraulic passage of check valve 290 through which the brake fluid flows. When an expression P1×S2<F is satisfied, ball member 293 is separated (unseated) from seat portion 295, so that check valve 290 is brought to the valve open state. The valve opening pressure F/S2 is set to a predetermined pressure. In this valve opening state, first pump 32P sucks the brake fluid from reservoir 29P, and first pump 32P is brought to a state in which first pump 32P can suck the brake fluid from master cylinder 4 (pipe 16). Then, when master cylinder pressure P1 is acted to piston 291 of reservoir 29P and thereby piston 291 is moved in the direction to compress spring 292, the valve closing operation is performed. As described above, check valve 290 automatically repeats the valve opening and the valve closing at the actuation of first pump 32P. With this, it is possible to increase the pressure of the wheel cylinder pressure by sucking the brake fluid from master cylinder 4 by first pump 32P. Moreover, it is possible to regulate the pressure acted to the suction side of first pump 32P, to a value equal to or smaller than a predetermined value, with respect to the master cylinder pressure P1 in an arbitrarily region.

The operations of the actuations of the S-system are identical to those in the first embodiment. That is, first pump 32S controls wheel cylinder pressure P2 while gate-in valve 25S and second pump 33s control the relationship between pedal stroke S and master cylinder pressure P1. The operations of the actuators of the P-system are identical to those of the S-system, except that gate-in valve 25 and second pump 33 are not controlled.

In the brake control apparatus according to the second embodiment, it is possible to decrease pedal stroke S and to generate the good pedal feeling (the brake pedal depression force) while the recirculating circuit (pipe 18) and the recirculating device (second pump 33) provided only in one of the two systems (the P-system and the S-system) suppresses the variation of the wheel cylinder pressure P2 at the depression return of the brake pedal at the regenerative coordinated control. Accordingly, it is possible to decrease the number of the actuators such as the pump, relative to the brake control apparatus according to the first embodiment. Besides, in the system (the P system) in which the recirculating circuit (pipe 18) and the recirculating device (second pump 33) are not provided, the normal reservoir (identical to reservoir 29S of the S system) may be used, in place of reservoir 29P with check valve 290. Moreover, in the third brake circuit (pipe 16), there may be provided the pressure difference generating section such as gate-in valve 25. The functions of the second embodiment are identical to those of the first embodiment.

### Third Embodiment

In a brake control apparatus 1 according to a third embodiment of the present invention, second pump 33 is not provided on the recirculating circuit (pipe 18), as the recirculating device in the hydraulic pressure control unit 6. Alternatively, first pump 32 is arranged to actuate as the recirculating device, unlike the brake control apparatus according to the first embodiment.

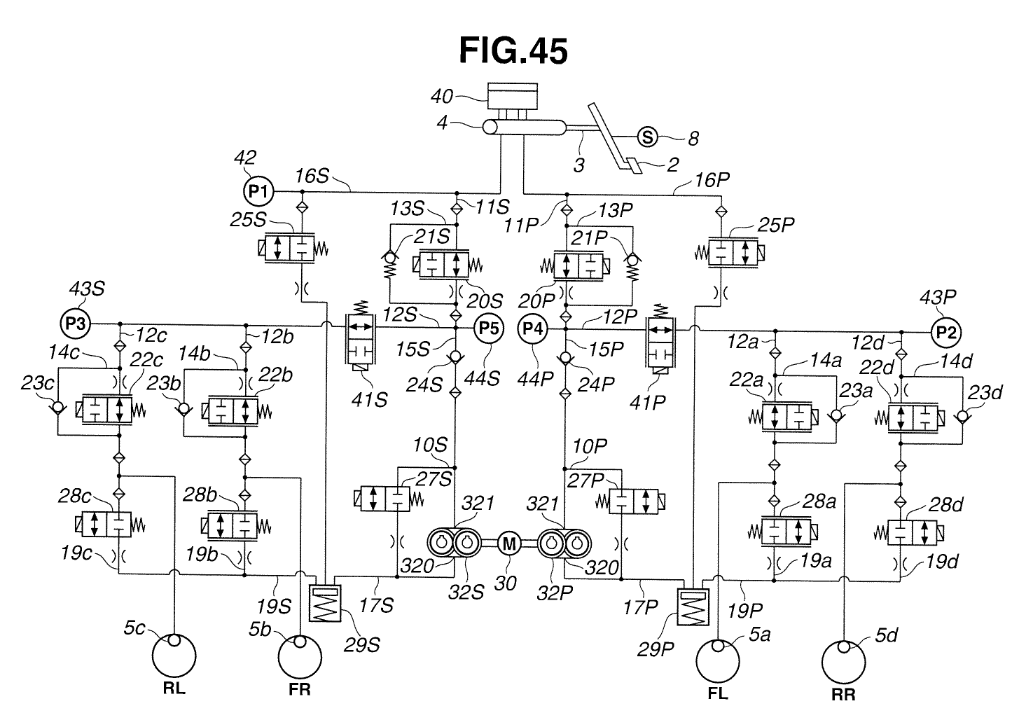

FIG. 45 is a circuit diagram of hydraulic pressure control unit 6 of brake control apparatus 1 according to the third embodiment. Pipe 18 and second pump 33 are not provided in the P system and the S system, unlike FIG. 2. Second switching valves 41P and 41S which are normally-open solenoid valves are provided on portions of pipes 12P and 12S which are forward (upstream) of bifurcating points at which pipes 12P and 12S are bifurcated into pipes 12a, 12d, 12b, and 12c of the respective wheels. A hydraulic pressure sensor 44 is provided on the connection point between pipe 11 and pipe 12, and arranged to sense the hydraulic pressure of the first brake circuit between gate-out valve 20 and second switching valve 41. The other structures according to the third embodiment are identical to those of the first embodiment (FIG. 2).

Hydraulic pressure control section 70 performs the PWM control of second switching valve 41. Hydraulic pressure control section 70 (the pedal depression force generating section 71) controls gate-in valve 25, gate-out valve 20, second switching valve 41, and first pump 32 to coordinate with each other. With this, hydraulic pressure control section 70 controls wheel cylinder pressure P2 while controlling the relationship between pedal stroke S and master cylinder pressure P1. In particular, hydraulic pressure control section 70 drives first pump 32 at the pedal depression or the pedal stroke by the driver at the normal brake and (or) at the regenerative coordinated control, and does not control (uncontrol) second switching valve 41 (the valve open state). Hydraulic pressure control section 70 controls the actuation of gate-in valve 25 so that master cylinder pressure P1 sensed by master cylinder pressure sensor 42 corresponds to the target master cylinder pressure. The other operations of the third embodiment are identical to those of the first embodiment.

At the pedal depression return by the driver at the regenerative coordinated control, first, the target master cylinder pressure and the target wheel cylinder pressure are compared. When the target master cylinder pressure is greater than the target wheel cylinder pressure, first pump 32 is driven, and switching valve 27 is not controlled (uncontrolled) (the valve closed state). With this, the brake fluid of reservoir 29 is supplied to the first brake circuit side. Gate-out valve 20 is not controlled (uncontrolled) (the valve open state). With this, the brake fluid of reservoir 29 is supplied through the first and second brake circuits to the master cylinder 4's side. Accordingly, it becomes possible to decrease pedal stroke S. Moreover, the actuation of the gate-in valve 25 is controlled so that master cylinder pressure P1 sensed by master cylinder pressure sensor 42 corresponds to the target master cylinder pressure. Moreover, the actuation of second switching valve 41 are controlled so that wheel cylinder pressure P2 corresponds to the target wheel cylinder pressure, based on the sensed values of wheel cylinder pressure sensor 43 and hydraulic pressure sensor 44. In this case, hydraulic pressure sensor 44 may be omitted, wheel cylinder pressure P2 may be controlled only based on the sensed value of wheel cylinder pressure sensor 43. Moreover, the discharge amount of first pump 32 (the rotational speed of first motor 30) may be appropriately controlled based on the sensed value of hydraulic pressure sensor 44 and so on for attaining more accurate and easier hydraulic pressure control.

When the target wheel cylinder pressure is greater than the target master cylinder pressure, first pump 32 is driven, and switching valve 27 is not controlled (uncontrolled) (the valve closed state), so as to supply the brake fluid of reservoir 29 to the first brake circuit side. Second switching valve 41 is not controlled (uncontrolled) (the valve open state). Moreover, gate-out valve 20 is controlled to be opened. With this, the brake fluid of reservoir 29 is supplied to the master cylinder 4's side. Accordingly, it becomes possible to decrease pedal stroke S. The actuation of gate-out valve 20 is controlled based on the sensed values of master cylinder pressure sensor 42 and hydraulic pressure sensor 44 so that master cylinder pressure P1 sensed by master cylinder pressure sensor 42 corresponds to the target master cylinder pressure, and so that wheel cylinder pressure P2 sensed by hydraulic pressure sensor 44 corresponds to the target wheel cylinder pressure. In this case, hydraulic pressure sensor 44 may be omitted, and wheel cylinder pressure P2 may be controlled based on the sensed value of wheel cylinder pressure sensor 43. Moreover, the discharge amount of first pump 32 (the rotational speed of first motor 30) may be appropriately controlled based on the sensed value of hydraulic pressure sensor 44 and so on for attaining more accurate and easier hydraulic pressure control. Moreover, the actuation of gate-in valve 25 may be controlled in parallel with the above-described control operation. The other operations of the third embodiment are identical to those of the first embodiment.

Brake control apparatus 1 uses first pump 32 as the recirculating device arranged to return (recirculate) the brake fluid stored in reservoir 29 to the first brake circuit side. First pump 32 returns (recirculates) the brake fluid discharged to the second brake circuit, through the first brake circuit (pipe 11) to the master cylinder 4's side. Accordingly, it is possible to decrease the pedal stroke S while suppressing the variation of wheel cylinder pressure P2 at the pedal depression return at the regenerative coordinated control, without providing the new (additional) recirculating circuit (pipe 18) and the new (additional) recirculating device (second pump 33), unlike the first and second embodiments, and to generate the good pedal feeling (brake pedal depression force). Besides, second switching valve 41 may be omitted, and solenoid-in valve 22 may be controlled as the above-described second switching valve 41. On the other hand, in a case where second switching valve 41 is provided like the third embodiment, it is possible to decrease the number of the valves which are the controlled objects. The above-described coordinated control of gate-in valve 25, gate-out valve 20, second switching valve 41, and first pump 32 is one example. These objects may be controlled by the other control methods. The other operations and functions of the third embodiment are identical to those of the first embodiment.

Although the invention has been described above by reference to certain embodiments of the invention, the invention is not limited to the embodiments described above. Modifications and variations of the embodiments described above will occur to those skilled in the art in light of the above teachings. For example, brake control apparatus 1 according to the embodiments of the present invention is applied to the hybrid vehicle. However, brake control apparatus 1 according to the embodiments of the present invention is applicable to arbitrary vehicles such as an electric vehicle with the regenerative braking device. It is possible to attain the same functions in the brake control apparatus according to the embodiments of the present invention. In the brake control apparatus according to the embodiments of the present invention, the brake piping structure employs the X-piping structure. However, the brake piping structure is not limited to the X-piping structure. For example, it is possible to employ a front and rear piping structure, that is, H-shaped piping structure in which the pipes are divided into two piping systems for front wheels FL and FR, and rear wheels RL and RR. In these embodiments, the booster arranged to boost (amplify) the depression force of brake pedal 2, and to transmit this boosted (amplified) force to master cylinder 4 is omitted. However, the booster may be provided (for example, an electromotive booster).

In the embodiments, the actuation of gate-in valve 25 is controlled by the feedback control by using the sensed value of hydraulic pressure sensor 42. However, it is optional to control the pressure difference between the upstream side and the downstream side of gate-in valve 25 (that is, master cylinder pressure P1), by applying the balancing current value to gate-in valve 25. That is, gate-in valve 25 includes, for example, a valve element (plunger), a valve seat portion arranged to close the pipe by being abutted by the abutment of the valve element, and to close the pipe by the separation of the valve element, a spring (urging member) arranged to urge the valve element in a direction apart from the valve seat portion, and a solenoid arranged to generate an electromagnetic force for moving the valve element in a direction toward the valve seat portion against the urging force of the spring. The valve element receives a force by a pressure difference between a pressure on the upstream side of gate-in valve 25 (corresponding to master cylinder pressure P1), and a pressure on the downstream side of gate-in valve 25 (the pressure on the reservoir 29's side, which can be considered as substantially zero). It is possible to control the pressure difference to the desired value by controlling the current applied to the solenoid. That is, the urging force of the spring is uniquely determined in accordance with the position of the valve element. Therefore, the valve element is moved by controlling the current value to the predetermined value, to regulate the flow rate flowing in gate-in valve 25 until the force by the pressure difference to finally balance the electromotive force according to this current value and the urging force of the spring is acted to the valve element. With this, the target pressure difference (master cylinder pressure P1) is attained. This is referred to as a balancing control of gate-in valve 25. The current value applied to the solenoid for controlling the pressure difference to the predetermined value is referred to as the balancing current. For example, in the first and second embodiments, in the valve closed state of gate-out valve 20, the supply amount of the brake fluid to master cylinder 4 is determined in accordance with the difference between the amount of the discharged hydraulic fluid of second pump 33, and the leakage amount from gate-in valve 25 to the reservoir 29's side. When the pressure of reservoir 29 is zero, the pressure difference between the upstream side and the downstream side of gate-in valve 25 corresponds to master cylinder pressure P1. Therefore, the opening degree (the leakage fluid amount) of gate-in valve 25 is automatically controlled by previously setting the current value applied to the solenoid of gate-in valve 25 to a value (balancing current value) by which the above-described pressure difference becomes the target master cylinder pressure so as to control this electromagnetic force. With this, it is possible to control master cylinder pressure P1 to the target master cylinder pressure. In gate-in valve 25 of the third embodiment, it is possible to perform the same operation. Moreover, it is optional to apply the balancing control to gate-out valve 20 and the second switching valve 41 in the third embodiment.

In the embodiments, the proportional solenoid valve is employed as gate-in valve 25 and so on. However, gate-in valve 25 is not limited to the proportional solenoid valve. For example, an ON/OFF valve may be employed as gate-in valve 25. In this case, it is possible to attain the middle opening degree by controlling effective current, for example, by the PWM control.

[A6] In the brake control apparatus according to the embodiments of the present invention, the brake control apparatus further includes a relief valve provided parallel to the gate-out valve, and arranged to allow the flow of the brake fluid from the master cylinder; and the relief valve has a valve opening pressure corresponding to a brake hydraulic pressure corresponding to a maximum deceleration generated by the regenerative braking device.

[A7] In the brake control apparatus according to the embodiments of the present invention, the brake control apparatus further includes a first motor arranged to drive the first pump, and a second motor arranged to drive the second pump.

[A8] In the brake control apparatus according to the embodiments of the present invention, the brake control apparatus further includes an in valve provided on the first brake circuit between the wheel cylinder and the first pump, and an out valve provided on a fourth brake circuit connecting the wheel cylinder and the reservoir.

[A9] In the brake control apparatus according to the embodiments of the present invention, the brake control apparatus further includes a connection passage connecting a discharge side and a suction side of the first pump; and the brake control apparatus further includes a switching valve provided on the connection passage.

[A10] In the brake control apparatus according to the embodiments of the present invention, the brake control apparatus further includes a brake operation state sensing section configured to sense a brake operation state of the driver, and a hydraulic pressure control section configured to control the motor(s) and the valves in accordance with the sensed brake operation state and the actuation state of the regenerative braking device.

[A11] In the brake control apparatus according to the embodiments of the present invention, the hydraulic pressure control section includes a pedal depression generating section configured to drive the second pump during the brake operation of the driver, and thereby to generate a depression force of the brake pedal.

[A12] In the brake control apparatus according to the embodiments of the present invention, the hydraulic pressure control section is configured to continue to drive the first and second pumps while the brake operation state sensing section senses the brake operation of the driver, and to control the valves to perform the hydraulic pressure control.

[B1] In the brake control apparatus according to the embodiments of the present invention, a brake control apparatus for a vehicle provided with a regenerative braking device, the brake control apparatus includes: a first brake circuit connecting a master cylinder configured to generate a brake hydraulic pressure by a brake operation of a driver, and a wheel cylinder to which the brake hydraulic pressure is applied; a first pump configured to suck a brake fluid within the master cylinder, to discharge the sucked brake fluid through a second brake circuit connected with the first brake circuit to the first brake circuit, and thereby to increase the hydraulic pressure within the wheel cylinder; a third brake circuit bifurcated from the first brake circuit, and connected with a suction side of the first pump; a reservoir provided on the third brake circuit; a recirculating circuit bifurcated from a portion of the third brake circuit between a suction side of the first pump and the reservoir, and connected to a portion of the third brake circuit between the reservoir and a portion on a downstream side of the bifurcating point between the third brake circuit and the first brake circuit; and a second pump provided on the recirculating circuit, and configured to suck a brake fluid stored in the reservoir, and to recirculate the sucked brake fluid to the first brake circuit's side.

[B2] In the brake control apparatus according to the embodiments of the present invention, the brake control apparatus further includes a gate-out valve provided on the first brake circuit between the connection point between the first brake circuit and the second brake circuit, and the bifurcating point between the first brake circuit and the third brake circuit, an in valve provided on the first brake circuit between the wheel cylinder and the first pump, and an out valve provided on a fourth brake circuit connecting the wheel cylinder and the reservoir.

[B3] In the brake control apparatus according to the embodiments of the present invention, the brake control apparatus further includes a brake operation state sensing section configured to sense a brake operation state of the driver, and a hydraulic pressure control section configured to control the pump(s) and the valves in accordance with the sensed brake operation state and the actuation state of the regenerative braking device.

[B4] In the brake control apparatus according to the embodiments of the present invention, the brake control apparatus further includes a first motor arranged to drive the first pump, and a second motor arranged to drive the second pump.

[B5] In the brake control apparatus according to the embodiments of the present invention, the hydraulic pressure control section is configured to continue to drive the first and second pumps while the brake operation state sensing section senses the brake operation of the driver, and to control the valves to perform the hydraulic pressure control.

[B6] In the brake control apparatus according to the embodiments of the present invention, the hydraulic pressure control section includes a pedal depression generating section configured to drive the second pump during the brake operation of the driver, and thereby to generate a depression force of the brake pedal.

[B7] In the brake control apparatus according to the embodiments of the present invention, the brake control apparatus further includes a connection passage connecting a discharge side and a suction side of the first pump; and the brake control apparatus further includes a switching valve provided on the connection passage.

[C1] In the brake control apparatus according to the embodiments of the present invention, a brake control apparatus for a vehicle provided with a regenerative braking device, the brake control apparatus includes: a brake operation state sensing section configured to sense a brake operation state of a driver; a first brake circuit connecting a master cylinder configured to generate a brake hydraulic pressure by a brake operation of a driver, and a wheel cylinder to which the brake hydraulic pressure is applied; a first pump configured to suck a brake fluid within the master cylinder, to discharge the sucked brake fluid through a second brake circuit connected with the first brake circuit to the first brake circuit, and thereby to increase the hydraulic pressure within the wheel cylinder; a third brake circuit bifurcated from the first brake circuit, and connected with a suction side of the first pump; a reservoir provided on the third brake circuit; a recirculating circuit bifurcated from a portion of the third brake circuit between a suction side of the first pump and the reservoir, and connected to a portion of the third brake circuit between the reservoir and a portion on a downstream side of the bifurcating point between the third brake circuit and the first brake circuit; and a second pump provided on the recirculating circuit, and configured to suck a brake fluid stored in the reservoir, and to recirculate the sucked brake fluid to the first brake circuit's side; a first motor arranged to drive the first pump; a second motor arranged to drive the second pump; a gate-out valve provided on the first brake circuit between the connection point between the first brake circuit and the second brake circuit, and the bifurcating point between the first brake circuit and the third brake circuit; an in valve provided on the first brake circuit between the wheel cylinder and the first pump; an out valve provided on a fourth brake circuit connecting the wheel cylinder and the reservoir; and a hydraulic pressure control section configured to control the pump(s) and the valves in accordance with the sensed brake operation state and the actuation state of the regenerative braking device, the pumps, the valves and the brake circuits being provided in a first system constituted by a first predetermined wheel set, and a second system constituted by a second predetermined wheel set, the first motor and the second motor being shared by the corresponding pumps provided in the first system and the second system.

In the brake control apparatus according to the present invention, the reservoir is provided in the third brake circuit.

Accordingly, it is possible to improve the operation feeling of the brake, by flowing the brake fluid from the master cylinder to the reservoir with respect to the brake operation of the driver.

The entire contents of Japanese Patent Application No. 2011-197854 filed Sep. 12, 2011 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus for a vehicle provided with a regenerative braking device, the brake control apparatus comprising:
a first brake circuit connecting a master cylinder configured to generate a brake hydraulic pressure by a brake operation of a driver, and a wheel cylinder to which the brake hydraulic pressure is applied;
a booster configured to increase a pressure of a brake fluid within the master cylinder, and to transmit the pressurized brake fluid to the wheel cylinder through a second brake circuit connected with the first brake circuit;
a third brake circuit bifurcated from the first brake circuit, and connected with the booster;
a reservoir provided on the third brake circuit; and
a recirculating device configured to recirculate the brake fluid stored in the reservoir, to the first brake circuit's side.

2. The brake control apparatus as claimed in claim 1, wherein the brake control apparatus further comprises a recirculating circuit bifurcated from a portion of the third brake circuit between a suction side of the first pump and the reservoir, and connected to a portion of the third brake circuit between the reservoir and a portion on a downstream side of the bifurcating point between the third brake circuit and the first brake circuit; and the recirculating device is provided on the recirculating circuit.

3. The brake control apparatus as claimed in claim 2, wherein the brake control apparatus further comprises a gate-in valve provided on the third brake circuit between reservoir and a connection point between the third brake circuit and the recirculating circuit.

4. The brake control apparatus as claimed in claim 2, wherein the brake control apparatus further comprises a gate-out valve provided on the first brake circuit between the connection point between the first brake circuit and the second brake circuit, and the bifurcating point between the first brake circuit and the third brake circuit.

5. The brake control apparatus as claimed in claim 4, wherein the booster includes a first pump; the recirculating device includes a second pump; and the first pump and the second pump are arranged to be independently driven.

6. The brake control apparatus as claimed in claim 5, wherein the brake control apparatus further includes a relief valve provided parallel to the gate-out valve, and arranged to allow the flow of the brake fluid from the master cylinder; and the relief valve has a valve opening pressure corresponding to a brake hydraulic pressure corresponding to a maximum deceleration generated by the regenerative braking device.

7. The brake control apparatus as claimed in claim 6, wherein the brake control apparatus further comprises a first motor arranged to drive the first pump, and a second motor arranged to drive the second pump.

8. The brake control apparatus as claimed in claim 7, wherein the brake control apparatus further comprises an in valve provided on the first brake circuit between the wheel cylinder and the first pump, and an out valve provided on a fourth brake circuit connecting the wheel cylinder and the reservoir.

9. The brake control apparatus as claimed in claim 8, wherein the brake control apparatus further comprises a connection passage connecting a discharge side and a suction side of the first pump; and the brake control apparatus further comprises a switching valve provided on the connection passage.

10. The brake control apparatus as claimed in claim 8, wherein the brake control apparatus further comprises a brake operation state sensing section configured to sense a brake operation state of the driver, and a hydraulic pressure control section configured to control the motor(s) and the valves in accordance with the sensed brake operation state and the actuation state of the regenerative braking device.

11. The brake control apparatus as claimed in claim 10, wherein the hydraulic pressure control section includes a pedal depression generating section configured to drive the second pump during the brake operation of the driver, and thereby to generate a depression force of the brake pedal.

12. The brake control apparatus as claimed in claim 10, wherein the hydraulic pressure control section is configured to continue to drive the first and second pumps while the brake operation state sensing section senses the brake operation of the driver, and to control the valves to perform the hydraulic pressure control.

13. A brake control apparatus for a vehicle provided with a regenerative braking device, the brake control apparatus comprising:
a first brake circuit connecting a master cylinder configured to generate a brake hydraulic pressure by a brake operation of a driver, and a wheel cylinder to which the brake hydraulic pressure is applied;
a first pump configured to suck a brake fluid within the master cylinder, to discharge the sucked brake fluid through a second brake circuit connected with the first brake circuit to the first brake circuit, and thereby to increase the hydraulic pressure within the wheel cylinder;
a third brake circuit bifurcated from the first brake circuit, and connected with a suction side of the first pump;
a reservoir provided on the third brake circuit;
a recirculating circuit bifurcated from a portion of the third brake circuit between a suction side of the first pump and the reservoir, and connected to a portion of the third brake circuit between the reservoir and a portion on a downstream side of the bifurcating point between the third brake circuit and the first brake circuit; and
a second pump provided on the recirculating circuit, and configured to suck a brake fluid stored in the reservoir, and to recirculate the sucked brake fluid to the first brake circuit's side.

14. The brake control apparatus as claimed in claim 13, wherein the brake control apparatus further comprises a gate-out valve provided on the first brake circuit between the connection point between the first brake circuit and the second brake circuit, and the bifurcating point between the first brake circuit and the third brake circuit, an in valve provided on the first brake circuit between the wheel cylinder and the first pump, and an out valve provided on a fourth brake circuit connecting the wheel cylinder and the reservoir.

15. The brake control apparatus as claimed in claim 13, wherein the brake control apparatus further comprises a brake operation state sensing section configured to sense a brake operation state of the driver, and a hydraulic pressure control section configured to control the pump(s) and the valves in accordance with the sensed brake operation state and the actuation state of the regenerative braking device.

16. The brake control apparatus as claimed in claim 15, wherein the brake control apparatus further comprises a first motor arranged to drive the first pump, and a second motor arranged to drive the second pump.

17. The brake control apparatus as claimed in claim 16, wherein the hydraulic pressure control section is configured to continue to drive the first and second pumps while the brake operation state sensing section senses the brake operation of the driver, and to control the valves to perform the hydraulic pressure control.

18. The brake control apparatus as claimed in claim 15, wherein the hydraulic pressure control section includes a pedal depression generating section configured to drive the second pump during the brake operation of the driver, and thereby to generate a depression force of the brake pedal.

19. The brake control apparatus as claimed in claim 15, wherein the brake control apparatus further comprises a connection passage connecting a discharge side and a suction side of the first pump; and the brake control apparatus further comprises a switching valve provided on the connection passage.

20. A brake control apparatus for a vehicle provided with a regenerative braking device, the brake control apparatus comprising:
a brake operation state sensing section configured to sense a brake operation state of a driver;
a first brake circuit connecting a master cylinder configured to generate a brake hydraulic pressure by a brake operation of a driver, and a wheel cylinder to which the brake hydraulic pressure is applied;
a first pump configured to suck a brake fluid within the master cylinder, to discharge the sucked brake fluid through a second brake circuit connected with the first brake circuit to the first brake circuit, and thereby to increase the hydraulic pressure within the wheel cylinder;
a third brake circuit bifurcated from the first brake circuit, and connected with a suction side of the first pump;
a reservoir provided on the third brake circuit;
a recirculating circuit bifurcated from a portion of the third brake circuit between a suction side of the first pump and the reservoir, and connected to a portion of the third brake circuit between the reservoir and a portion on a downstream side of the bifurcating point between the third brake circuit and the first brake circuit; and
a second pump provided on the recirculating circuit, and configured to suck a brake fluid stored in the reservoir, and to recirculate the sucked brake fluid to the first brake circuit's side;
a first motor arranged to drive the first pump;
a second motor arranged to drive the second pump;
a gate-out valve provided on the first brake circuit between the connection point between the first brake circuit and the second brake circuit, and the bifurcating point between the first brake circuit and the third brake circuit;
an in valve provided on the first brake circuit between the wheel cylinder and the first pump;
an out valve provided on a fourth brake circuit connecting the wheel cylinder and the reservoir; and
a hydraulic pressure control section configured to control the pumps and the valves in accordance with the sensed brake operation state and the actuation state of the regenerative braking device,
the pumps, the valves and the brake circuits being provided in a first system constituted by a first predetermined wheel set, and a second system constituted by a second predetermined wheel set,
the first motor and the second motor being shared by the corresponding pumps provided in the first system and the second system.
